(19) United States
(12) Patent Application Publication
(10) Pub. No.: US 2023/0002558 A1
(43) Pub. Date: Jan. 5, 2023

(54) REACTIVE POLYAMIDEIMIDE OLIGOMERS, METHODS, AND ARTICLES

(71) Applicant: THE UNIVERSITY OF NORTH CAROLINA AT CHAPEL HILL, CHAPEL HILL, NC (US)

(72) Inventors: Maruti HEDGE, Chapel Hill, NC (US); Theo DINGEMANS, Chapel Hill, NC (US)

(21) Appl. No.: 17/775,222

(22) PCT Filed: Nov. 6, 2020
(86) PCT No.: PCT/US2020/059456

§ 371 Date: May 6, 2022

Related U.S. Application Data
(60) Provisional application No. 62/932,892, filed on Nov. 8, 2019.
(60) Provisional application No. 63/075,610, filed on Sep. 8, 2020.

(51) Int. Cl. C08G 73/14; C09D 179/08; C09J 179/08; C08K 7/06; C08K 3/04

(52) U.S. Cl. CPC C08G 73/14; C09D 179/08; C09J 179/08; C08K 7/06; C08K 3/04

(57) ABSTRACT

Reactive ammonium carboxyl ate salts, polyamide amic acid oligomers, and polyamideimide oligomers are made from at least one aromatic diamine, at least one aromatic di-, tri-, or tetra-functional carboxylic acid or functional equivalent thereof, and at least one crosslinkable monomer or crosslinkable end-capper. The crosslinkable monomer or crosslinkable end-capper is reactive with the at least one aromatic diamine or at least one di-, tri- or tetra-functional aromatic carboxylic acid or functional equivalent thereof and has at least one unreacted functional group capable of chain extension and crosslinking after formation of the reactive polyamideimide oligomer. The reactive polyamide amic acid and polyamideimide oligomers have a number average molecular weight (Mₙ) of about 1,000 to about 10,000 g/mol, calculated using the Carothers equation. The reactive ammonium carboxyl ate salts, polyamide amic acid oligomers, and polyamideimide oligomers are useful in a wide variety of functional materials, manufacturing methods, and articles.

### CROSS REFERENCE TO RELATED APPLICATION

This application claims the benefit of U.S. Provisional Application Nos. 62/932,892 filed Nov. 8, 2019 and 63/075,610 filed Sep. 8, 2020, both of which are incorporated by reference in their entirety herein.

### BACKGROUND

All-aromatic polyamideimides (PAIs) are high performance polymers having alternating cyclic imide and amide linkages in the polymer backbone, and were first commercialized in the early 1970s. High molecular weight PAIs have excellent high temperature strength, low temperature toughness and impact strength, and exceptional chemical resistance and dimensional stability. High molecular weight PAIs can have amic acid groups in the polymer backbone that are not imidized. The amic acid groups lend some flexibility to the polymer backbone, which makes the PAIs somewhat melt processable, although not easily. However, there are still several challenges associated with melt processing of high molecular weight PAL. The melt viscosity is highly sensitive to temperature and shear rate, and the PAI has a narrow processing window with processing temperatures greater than 600° F. (316° C.) required. Amic acids convert thermally to imides by cyclodehydration, and conversion of amic acid groups to cyclic imide groups results in rapid increase in rigidity of the polymer backbone, and therefore a rapid increase in melt viscosity. If this happens during extrusion, there is a risk that the polymer melt might solidify in the extruder. Due to the presence of non-imidized amic acid groups, PAI is highly moisture sensitive and must be thoroughly dried before, and maintained dry during, melt processing to prevent molecular weight and thermal-mechanical property degradation. Moreover, imidization and removing water of imidization for 20 or more days at 500° F. (260° C.) may be required to obtain optimal properties. These difficulties have limited the use of high molecular weight PAI to the manufacture of simple stock shapes such as rods, plates, tubes, and other profiles. These stock shapes can then be machined into parts not accessible by injection molding by, for example, turning, drilling, and milling steps.

In view of the processing limitations of high molecular weight PAIs, less viscous injection molding grades have been developed. These grades can be used to produce injection-molded, filled and unfilled parts and stock-shapes, but with difficulty. Injection molding grades are believed to be mixtures of amine-terminated low molecular weight (oligomeric) polyamides with dianhydride chain-extenders, such as pyromellitic anhydride (PMDA), to build molecular weight in situ. The oligomeric nature of the polyamides lowers melt viscosity, which aids in melt processing steps, and the amine-terminated polyamide oligomer is reacted with a dianhydride to form a high molecular weight polyamide amic acid intermediate through chain-extension. After processing, the produced parts and stock shapes need to be post cured. In post curing, the amic acid groups cyclodehydrate to form the PAI. A major disadvantage of this route to PAI is that large amounts of water need to be removed from the final part. There are two sources of such water: i) physisorbed water associated with the hygroscopic residual amic acid moieties in the chain-extended PAI; and ii) water generated in the cyclodehydration step. Removing water from parts and stock shapes is a time-consuming process requiring multiples days to weeks under a programmed heating protocol that is dependent on the thickness of the part and its final application. There is a need in the art for all-aromatic PAIs that do not require extended thermal post-cure and time-consuming water removal steps.

Although injection molding grade of PAI was an improvement over high molecular weight PAI, there are still many difficulties in melt processing. As discussed above, amic acid groups are still present in the chain-extended PAI, so it must be thoroughly dried before use. It is also still necessary to perform thermal post-treatment steps to complete polymerization (chain-extension) and/or imidize amic acid groups. As discussed above, water is generated in these post-treatment steps, and must be removed to avoid foaming, formation of micro bubbles, and embrittlement of the part. There are other difficulties with injection molding grade PAI as well. Residence time must be optimized, because excessive residence time will result in loss of flow due to chain extension and increasing viscosity. Molds must be filled rapidly and pressure must be optimized for each mold size and shape. Injection molding with family mold designs does not work well. The viscosity of injection molding grade PAI is still highly shear sensitive. Therefore, injection speed, injection pressure, back pressure, screw speed, barrel temperature, cycle time, and mold heating must all be optimized for each specific mold shape and size.

Post-heat treatment is still critical for injection molding grade PAL. Although as-molded parts might appear to be finished, they are actually weak, brittle, and have poor chemical resistance and wear resistance, and sub-optimal thermal resistance. To achieve optimal properties, molded parts must be heated in a forced-air oven on a cure schedule of a series of incremental temperature increases at time intervals, which must be optimized for each type and size of part. A general cure schedule recommended by a manufacturer is: 1 day at 375° F. (191° C.), 1 day at 425° F. (218° C.), 1 day at 475° F. (246° C.), and 5 days at 500° F. (260° C.), for a total of 8 days. Thicker parts can take longer to cure because the water of reaction must diffuse from the part for the reaction to proceed. Therefore, the reaction rate diminishes as the diffusion path lengthens. Moreover, certain parts, such as those with very thin walls and/or delicate features, may require fixturing during post-cure to meet tight dimensional tolerances.

In view of the above problems, there remains a need in the art for easily melt processable and curable PAIs that do not require extensive drying before processing and do not require extensive thermal post-treatment to remove water generated from cyclodehydration of amic acid functional groups. There also remains a need for a PAI that is suitable for a variety of article manufacturing processes, e.g. for direct injection molding into complex shapes, for manufacturing unidirectional tape and fiber-reinforced composites using continuous fiber, and for 3D printing applications, such as fused deposition molding (FDM) using filaments or rods, or powder bed printing such as selective laser sintering (SLS). The subject matter described herein addresses these shortcomings in the art and more.

### BRIEF DESCRIPTION

A reactive polyamideimide oligomer comprises units derived from at least one aromatic diamine, at least one aromatic di-, tri-, or tetra-functional carboxylic acid or functional equivalent thereof, and at least one crosslinkable monomer or crosslinkable end-capper; wherein the crosslinkable monomer or crosslinkable end-capper is reactive with the at least one aromatic diamine or at least one di-, tri- or tetra-functional aromatic carboxylic acid or functional equivalent thereof and has at least one unreacted functional group capable of chain extension and crosslinking after formation of the reactive polyamideimide oligomer; and wherein the reactive polyamideimide oligomer has a number average molecular weight (Mₙ) of about 1,000 to about 10,000 g/mol, calculated using the Carothers equation. By “derived from” it is meant that the reactive polyamideimide oligomer is formed by step-growth polymerization of the at least one aromatic diamine, the at least one aromatic di-, tri-, or tetra-functional carboxylic acid or functional equivalent thereof, and the at least one crosslinkable monomer or crosslinkable end-capper, and by cyclodehydration of the resulting polyamide amic acid oligomer intermediate with formation of small molecules, e.g. water and hydrochloric acid, as by-products.

A method of manufacture of the reactive polyamideimide oligomer comprises: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form a reactive polyamide amic acid oligomer; and heating the reactive polyamide amic acid oligomer at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

Another method of manufacture of the reactive polyamideimide oligomer comprises: heating at least one aromatic diamine, at least one aromatic di-, tri-, or tetra-functional carboxylic acid or functional equivalent thereof, and at least one crosslinkable monomer or crosslinkable end-capper in the presence of a C₁₋₄ alcohol at a sufficient temperature and time to form at least one reactive ammonium carboxylate salt; optionally removing excess C₁₋₄ alcohol; and heating the reactive ammonium carboxylate salt at a sufficient temperature and time to form the reactive polyamideimide oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

A method of manufacture of an article comprises heating the reactive polyamideimide oligomer at a sufficient temperature and time to shape and crosslink the reactive polyamideimide oligomer. The method can be additive manufacturing, fiber reinforced composite manufacturing, pultrusion, fiber spinning, compression molding, injection molding, reaction injection molding, blow molding, rotational molding, transfer molding, foam molding, thermoforming, casting, solution casting, or forging. Articles manufactured by the method are also disclosed.

A reactive polyamide amic acid oligomer comprises units derived from at least one aromatic diamine, at least one aromatic di-, tri-, or tetra-functional carboxylic acid or functional equivalent thereof, and at least one crosslinkable monomer or crosslinkable end-capper, wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer; and wherein the reactive polyamide amic acid oligomer has a number average molecular weight (Mₙ) of about 1,000 to about 10,000 g/mol, calculated using the Carothers equation.

A method of manufacture of the reactive polyamide amic acid oligomer comprises: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form the reactive polyamide amic acid oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer.

A method of manufacture of an article comprises heating the reactive polyamide amic acid oligomer at a sufficient temperature and time to imidize, shape, and crosslink the reactive polyamide amic acid oligomer. The method can be additive manufacturing, fiber reinforced composite manufacturing, pultrusion, fiber spinning, compression molding, injection molding, reaction injection molding, blow molding, rotational molding, transfer molding, foam molding, thermoforming, casting, solution casting, or forging. Articles manufactured by the methods are also disclosed.

A reactive ammonium carboxylate salt is formed by a method comprising heating at least one aromatic diamine, at least one aromatic di-, tri-, or tetra-functional carboxylic acid or functional equivalent thereof, and at least one crosslinkable monomer or crosslinkable end-capper in the presence of at least one of water or C₁₋₄ alcohol at a sufficient temperature and time to form the reactive ammonium carboxylate salt; and removing excess water and C₁₋₄ alcohol; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive ammonium carboxylate salt.

A method of manufacture of a reactive ammonium carboxylate salt comprises: heating at least one aromatic diamine, at least one aromatic di-, tri-, or tetra-functional carboxylic acid or functional equivalent thereof, and at least one crosslinkable monomer or crosslinkable end-capper in the presence of at least one of water or C₁₋₄ alcohol at a sufficient temperature and time to form a reactive ammonium carboxylate salt; and removal of excess C₁₋₄ alcohol; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive ammonium carboxylate salt.

A method of manufacture of an article comprises heating the reactive ammonium carboxylate salt at a sufficient temperature, pressure, and time to make, shape, and crosslink a reactive polyamideimide oligomer. The method can be fiber reinforced composite manufacturing, pultrusion, compression molding, injection molding, or solution casting. Articles manufactured by the methods are also disclosed.

### BRIEF DESCRIPTION OF THE DRAWINGS

Referring now to the drawings:

FIG. 1 depicts an exemplary composite panel prepared as described in Ex. 4. Four plies of carbon fiber fabric T650 were impregnated with reactive polyamideimide oligomer (Mₙ=5,000 g/mol, fully imidized, and molten), and consolidated using a heated parallel platen press to prepare the composite panel.

FIG. 2A to 2D illustrate the concepts of diffusion across interfaces, and chain entanglement and crosslinking across interfaces. FIGS. 2A and 2B depict diffusion and entanglement of a high molecular weight high performance thermoplastic. FIGS. 2C and 2D depict diffusion, entanglement, and chain extension and crosslinking of reactive oligomers.

FIG. 3 is a graph of axial force (N) vs. time (min) for melt polymerization of 1,3-phenylene diamine, 4,4′-oxydianiline, trimellitic anhydride, and 4-(phenylethynyl)phthalic anhydride in a twin-screw extruder.

### DETAILED DESCRIPTION

Disclosed herein are reactive polyamideimide oligomers and reactive polyamide amic acid oligomers (also collectively called “reactive oligomers” herein), reactive ammonium carboxylate salts, methods of manufacturing the reactive oligomers and reactive ammonium carboxylate salts, methods for processing the reactive oligomers and reactive ammonium carboxylate salts, and articles made from the reactive oligomers and reactive ammonium carboxylate salts. The routes to polyamideimide articles described herein remove the need for an extended thermal post cure and a time-consuming water removal step. This is accomplished by designing a fully imidized reactive polyamideimide oligomer that can be melt processed followed by a short (at most a few hours) thermal post-cure to yield high molecular weight polyamideimide via chain extension/crosslinking. The latter reactions take place by incorporating carefully selected functional groups into the reactive polyamideimide oligomer. These functional groups remain unreacted during oligomerization, and are then available for thermal post-cure. During thermal post-cure, these functional groups can polymerize (chain extend/crosslink) via addition reactions without generating small molecule by-products like water.

The reactive polyamideimide oligomers with unreacted functional groups described herein allow for the production of stock-shapes, injection molded complex parts, 3D-printed parts and fiber- or mineral-reinforced composites without any thickness limitations because a water-removal step from the final product is no longer necessary. These routes to polyamideimides not only provide processing advantages (e.g., low viscosity, no residual water, no generated water), but also allows for the design and fabrication of PAI articles that were previously impossible to manufacture.

Having a Mₙ in the range of about 1,000 to about 10,000 g/mol provides lower melt viscosities and lower processing temperatures, so that melt processing can be done using conventional melt processing equipment. However, low molecular weight polymers (oligomers) are known to have poor mechanical properties because they lack polymer chain entanglements. Using crosslinkable monomers and/or crosslinkable end-cappers in the preparation of the reactive oligomers, molecular weight can be increased either by in-situ thermal polymerization (e.g. during reaction injection molding) or during a thermal post-treatment step (e.g. when preparing fiber reinforced composites).

Several advantages accrue to the reactive polyamideimide oligomers, which have thermally curable groups. The reactive polyamideimide oligomers are easily melt processable, do not require extensive drying before processing, and do not require extensive thermal post-treatment. Complex parts can be made from the reactive polyamideimide oligomer in one step. Curing can be done at about 300 to about 450° C. and can be completed in as little as about 1 to about 60 minutes compared to several days for currently available grades of PAL. When the reactive polyamideimide oligomer is fully imidized prior to melt processing, there is no need for the difficult step of water removal from stock shapes or injection molded parts. Advantageously, the reactive polyamideimide oligomers can be used for one-step injection molding of complex parts under conditions in which the reactive oligomers are cured instantaneously. Alternatively, parts can be easily thermally cured for about 1 to about 60 minutes. Moreover T_{g}, elongation at break, strength at break, and toughness of the cured reactive polyamideimide oligomer can be far superior to that of currently available PAI.

The reactive polyamideimide oligomer comprises units derived from at least one aromatic diamine, at least one aromatic di-, tri-, or tetra-functional carboxylic acid or functional equivalent thereof, and at least one crosslinkable monomer or crosslinkable end-capper; wherein the crosslinkable monomer or crosslinkable end-capper is reactive with the at least one aromatic diamine or at least one di-, tri-, or tetra-functional aromatic carboxylic acid or functional equivalent thereof and has at least one unreacted functional group capable of chain extension and crosslinking after formation of the reactive polyamideimide oligomer; and the reactive polyamideimide oligomer has a number average molecular weight (Mₙ) of about 1,000 to about 10,000 g/mol, calculated using the Carothers equation.

The reactive polyamideimide oligomer comprises units derived from at least one aromatic diamine. The at least one aromatic diamine can have any of the chemical structures depicted below.

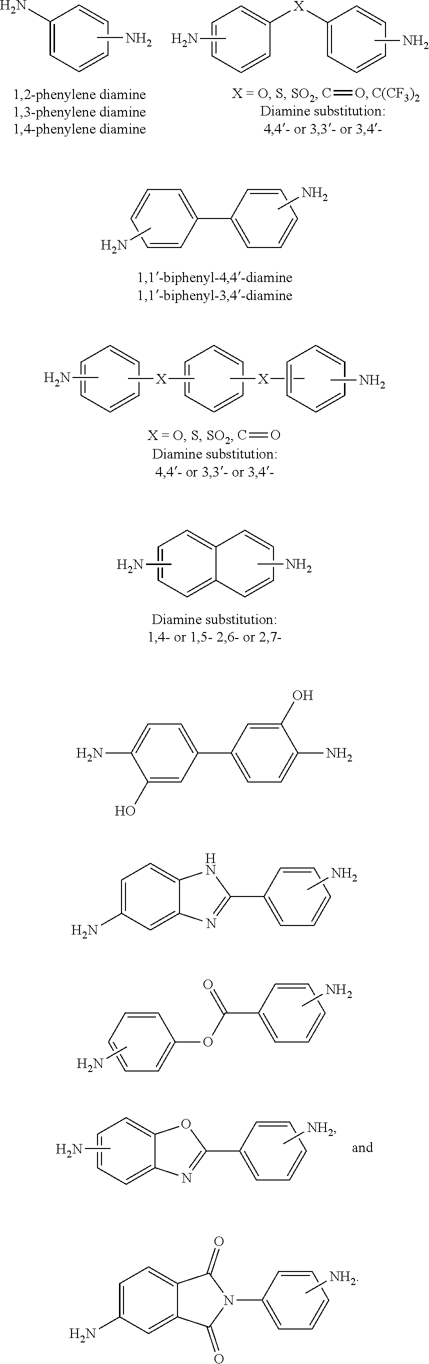

In some aspects, the at least one diamine is at least one of 1,3-phenylene diamine, 4,4′-oxydianiline, or 3,4′-oxydianiline.

The reactive polyamideimide oligomer also comprises at least one of aromatic di-, tri-, or tetra-functional carboxylic acid or functional equivalent thereof. Functional equivalents of a carboxylic acid are functional groups in which the carboxyl carbon atom is in the same oxidation state, e.g. carboxylic acid esters, carboxylic acid halides, and carboxylic acid anhydrides. For example, trimellitic anhydrides functional equivalents are compounds in which the substituent carbon atoms in the 1-, 2-, and 4-positions on the benzene ring are in the same oxidations state. A functional equivalent of trimellitic anhydride is 4-chloroformylphthalic anhydride. The at least one aromatic di-, tri-, or tetra-functional carboxylic acid or functional equivalent thereof includes at least one di-, tri-, or tetra-functional carboxylic acid or functional equivalent thereof having vicinal (ortho) carboxylic acid or functional equivalent groups, for example a phthalic anhydride group, so that 5-membered phthalimide rings can form in the reactive oligomer backbone. The at least one aromatic di-, tri-, or tetra-functional carboxylic acid or functional equivalent thereof can have any of the chemical structures depicted below.

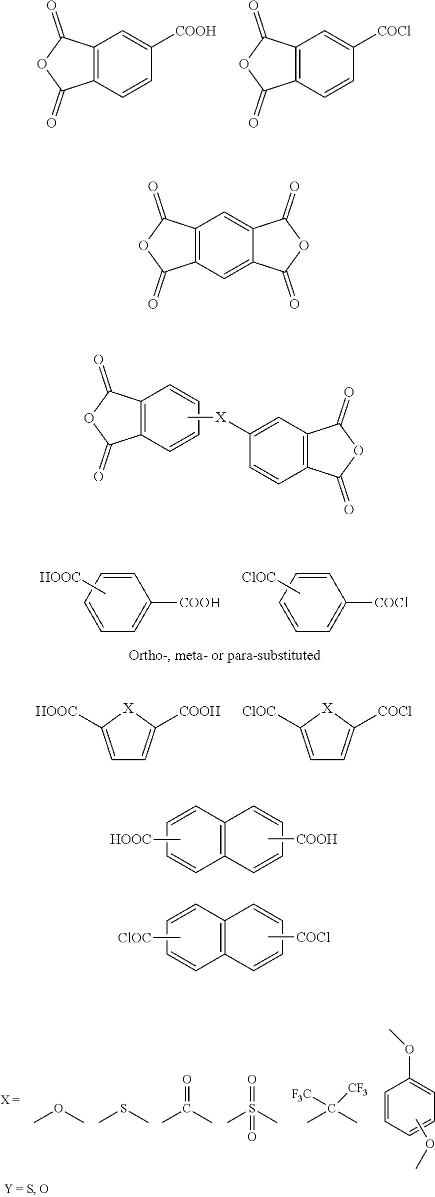

In some embodiments the at least one aromatic di-, tri- or tetrafunctional carboxylic acid or functional equivalent thereof is at least one of trimellitic anhydride, 4-chloroformylphthalic anhydride, isophthalic anhydride isophthaloyl chloride pyromellitic dianhydride, or biphenyl tetracarboxylic acid dianhydride.

The reactive polyamideimide oligomer also comprises at least one crosslinkable monomer or crosslinkable end-capper that is reactive with the at least one aromatic diamine or at least one di-, tri-, or tetra-functional aromatic carboxylic acid or functional equivalent thereof and has at least one unreacted functional group capable of chain extension and crosslinking after formation of the reactive polyamideimide oligomer. This functional group remains unreacted after formation of the reactive polyamideimide oligomer so that it is available to participate in subsequent chain extension, branching, and crosslinking reactions. The chain extension, branching, and crosslinking that occur after formation of the reactive polyamideimide oligomer are known collectively as “curing”. “Crosslinking” as used herein is also a shorthand for any combination of chain extension, branching, and crosslinking. The curing or crosslinking can be initiated by heat, actinic (electromagnetic) radiation, and electron beam radiation. In some embodiments, the curing is initiated thermally. The unreacted functional group that participates in subsequent chain extension, branching, and crosslinking reactions is at least one of ethyne, methylethyne, phenylethyne, ketoethyne, propargyl ether, norbornene, maleimide, cyanate ester, phthalonitrile, benzocyclobutene, biphenylene, or benzoxazine. These unreacted functional groups are depicted in Table 1 with chemical formulas, chemical names, and curing temperature ranges. The at least one crosslinkable monomer or crosslinkable end-capper can be two crosslinkable monomers or crosslinkable end-cappers that are reactive at different temperature ranges.

TABLE 1
Functional groups capable of thermal chain extension, branching,
and crosslinking and cure temperature ranges.

| | | | Cure Temperature |
|---|---|---|---|
| Entry | Structure | Name | (° C.) |
| 1 | 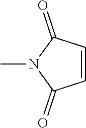 | Maleimide | 200-250 |
| 2 | 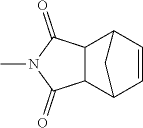 | Norbornene | 300-375 |
| 3 | 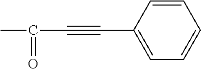 | Ketoethynyl | 190-230 (<190 when catalyzed) |
| 4 | 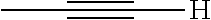 | Ethynyl | 230-280 |
| 5 | 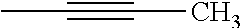 | Methylethynyl | 280-330 |
| 6 | 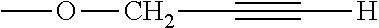 | Propargylether | 200-275 |
| 7 | 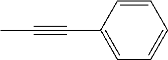 | Phenylethynyl | 330-400 |
| 8 | 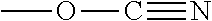 | Cyanate ester | 165-220 |
| 9 | 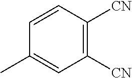 | Phthalonitrile | 300-350 |
| 10 | 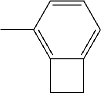 | Benzocyclcobutene | 205-285 |
| 11 | 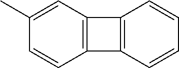 | Biphenylene | 280-330 |
| 12 | 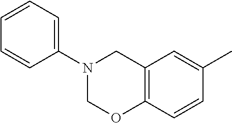 [SMILES: Cc1ccc2c(c1)CN(c1ccccc1)CO2] | Benzoxazine | 200-300 |

Examples of crosslinkable end-cappers and a crosslinkable monomer, with names for the unreacted functional groups, are provided below. 1,2-Diphenylethyne is a crosslinkable monomer. All other compounds are crosslinkable end-cappers. In some embodiments, the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

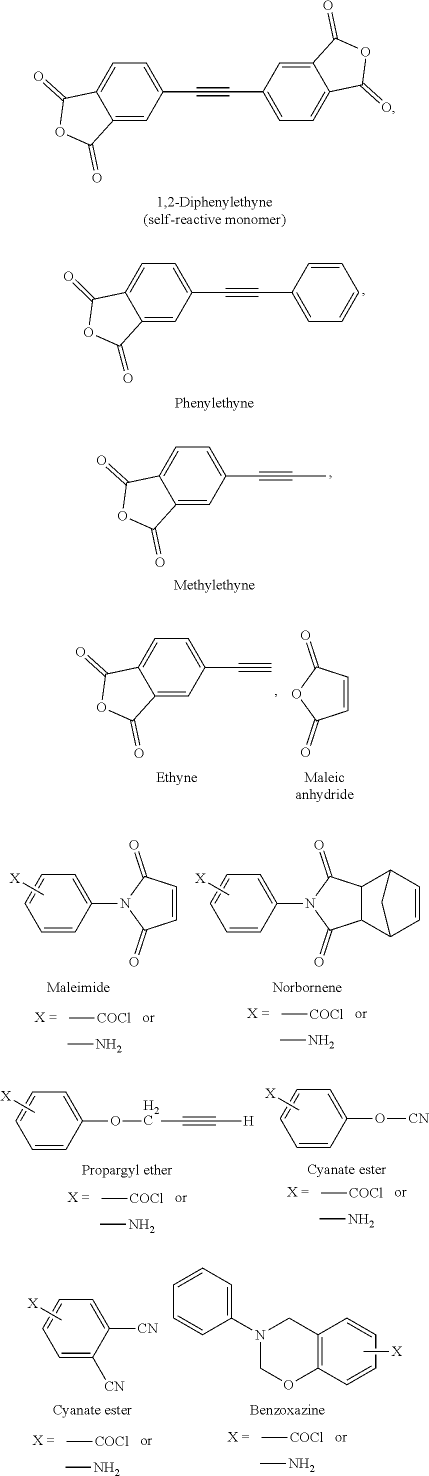

The reactive polyamideimide oligomer can further comprise units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof, but has no unreacted functional groups capable of chain extension and crosslinking after formation of the reactive polyamideimide oligomer. The non-crosslinkable end-capper can be at least one of benzoic acid, benzoyl chloride, phthalic anhydride, or aniline.

The reactive polyamideimide oligomer can be linear or branched. In some embodiments, the reactive polyamideimide oligomer is branched. Branching is obtained by using tri-functional monomers. Thus, in some embodiments, the reactive polyamideimide oligomer further comprises units derived from at least one of an aromatic triamine, an aromatic tricarboxylic acid, or an aromatic tricarboxylic acid chloride. An example of an aromatic triamine is 1,3,5-triaminobenzene, and example of an aromatic tricarboxylic acid is 1,3,5-benzenetricarboxylic acid, and an example of an aromatic tricarboxylic acid chloride is 1,3,5-benzenetricarboxylic acid chloride.

Number average molecular weight, Mₙ as used herein is a target value, not a measured value. The amounts of monomers and crosslinkable end-cappers used to prepare the reactive oligomers are calculated using the Carothers equation, Eq. (2). Eq. (1) is used to calculate the degree of polymerization [symbol] needed to achieve the target [symbol] .

$$\overline{{M}_{n}} = \overline{{M}_{0}} \cdot \overline{{x}_{n}} \qquad ( 1 )$$

$$\overline{{x}_{n}} = \frac{1 + r}{1 + r - 2 rp} \qquad ( 2 )$$

[symbol]

(also referred to as Mₙ herein) is the target number average molecular weight, selected from the range of about 1,000 to about 10,000 g/mol) and [symbol] is the average molecular weight of the oligomer repeat unit. With [symbol] and [symbol] known, the number average degree of polymerization ( [symbol] ) is calculated and substituted into Eq. 2. The reaction is assumed to go to completion so p=1, which simplifies Eq. 2 to an equation with one unknown, r, which is the reactant ratio and provides the stoichiometric off-set needed to prepare the desired reactive oligomer at the target [symbol] .

Polyamide amic acids are intermediates in the synthesis of polyamideimides. As depicted in Scheme 1 below, polyamideimides are produced by cyclodehydration of the intermediate polyamide amic acid (upper right structure).

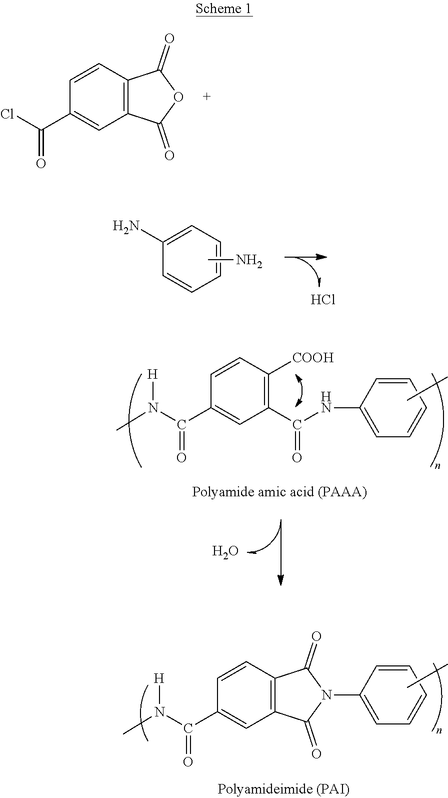

Since polyamide amic acids are intermediates in the preparation of polyamideimides, the reactive polyamideimide oligomer can have various degrees of imidization, i.e. conversion of the polyamide amic acid intermediate to the polyamideimide. Thus, in some embodiments, the reactive polyamideimide oligomer is derived from a reactive polyamide amic acid oligomer intermediate by cyclodehydration, and greater than about 80% and less than or equal to 100% of amic acid groups in the reactive polyamide amic acid intermediate are imidized. When the degree of imidization is in this range, the reactive polyamideimide oligomer is considered “fully imidized”. Within this range, greater than or equal to 85%, 90%, 95%, 96%, 97%, 98%, and 99%, and less than or equal to 100%, of the polyamide amic acid groups can be imidized.

It may be useful in some applications for the reactive polyamideimide oligomer to be less than 80% imidized. Thus, in some embodiments, the reactive polyamideimide oligomer is derived from a reactive polyamide amic acid oligomer intermediate by cyclodehydration, and greater than or equal to 20% and less than or equal to 80% of amic acid groups in the reactive polyamide amic acid intermediate are imidized. Within the range, greater than or equal to 30%, 40%, 50%, 60%, and 70% and less than or equal to 80%, of the amic acid groups can be imidized.

Advantageously, the reactive polyamide oligomer has a melt complex viscosity of about 1,000 to about 100,000 Pa·s at 360° C., measured by oscillatory shear rheology between parallel plates at a heating rate of 10° C./minute under N₂, a frequency of 2 radians/second, and a strain of 0.03% to 1.0%. Within this range, the melt complex viscosity is a function of Mₙ and the types and relative amounts of the at least one diamine, the at least one di-, tri-, or tetra-functional aromatic carboxylic acid or functional equivalent thereof, and crosslinkable or non-crosslinkable monomers and end-cappers used to make the reactive polyamide oligomer. Thus, the melt complex viscosity as a function of shear rate, time, temperature, and heating rate can be tuned by selection of monomers and reactive and non-reactive end-cappers, and relative amounts thereof. For example, the melt complex viscosity can be greater than or equal to 2,000, 3,000, 4,000, or 5,000 Pa·s and less than or equal to 90,000, 70,000, 50,000, or 30,000 Pa·s. In some embodiments, the melt complex viscosity is about 5,000 to about 30,000 Pa·s at 360° C. In contrast, currently available PAI is reported to have a melt complex viscosity of 100,000 Pa·s at 2 radians/second.

The reactive polyamideimide oligomer can be manufactured by a method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form a reactive polyamide amic acid; and heating the reactive polyamide amic acid oligomer at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer. Manufacture of exemplary reactive polyamideimide oligomers are provided in Scheme 2.

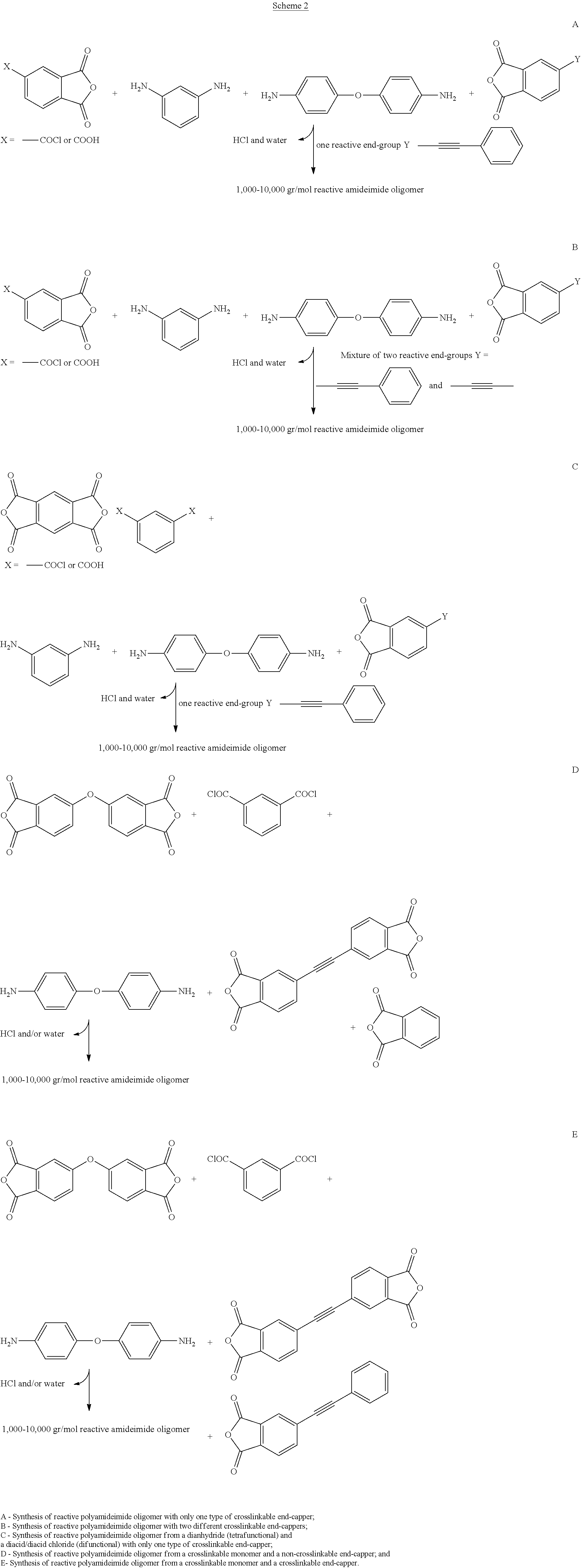

The sufficient temperature and time to make the reactive polyamideimide oligomer are about 140° C. to about 220° C. for about 1 minute to about 120 minutes. As discussed above, the reactive polyamideimide oligomer is manufactured via formation of a reactive polyamide amic acid oligomer intermediate. The temperature and time required to imidize the reactive polyamide amic acid oligomer intermediate in this method depends on whether polar solvent is present or not, the specific reactive polyamideimide oligomer being made, and the desired degree of imidization. When the imidization is done in the absence of solvent, i.e. with neat reactive polyamide amic acid oligomer in the solid state, the sufficient temperature and time to make the reactive polyamideimide oligomer are about 220° C. to about 300° C. for about 1 minute to about 120 minutes. When the imidization is done in the presence of a polar solvent, the sufficient temperature and time to make the reactive polyamideimide oligomer are about 140° C. to about 220° C. for about 1 minute to about 120 minutes.

The reactive polyamideimide oligomer is manufactured in the presence of a polar solvent, which lowers the temperature range sufficient to make the reactive oligomer. The polar solvent should have a boiling point of at least 150° C. at one atmosphere. The polar solvent can be at least one of N-methyl-2-pyrrolidone, N,N-dimethylacetamide, N,N-dimethylformamide, 1,2-dichlorobenzene, 1,2,4-trichlorobenzene, or sulfolane. In some embodiments, the polar solvent is N-methyl-2-pyrrolidone. The method of manufacture can further comprise removal of the polar solvent from the polyamide amic acid oligomer prior to heating the reactive polyamide amic acid oligomer at a sufficient temperature and time to make the reactive polyamideimide oligomer.

There are different methods for imidization of the reactive polyamide amic acid oligomer. The reactive polyamideimide oligomer can be made by adding toluene to the reactive polyamide amic acid oligomer and azeotropic distillation of toluene and water. The reactive polyamideimide oligomer can also be made by microwave irradiation of the reactive polyamide amic acid oligomer. The imidization agent can be acetic anhydride. Acidic by-products are generated by imidization, e.g. acetic acid when acetic anhydride is used. Therefore, bases, for example tertiary amines, can be used. The tertiary amine can be, for example, pyridine or triethylamine. Thus, in some embodiments, the reactive polyamideimide oligomer is made by heating the reactive polyamide amic acid oligomer in the presence of acetic anhydride and a catalytic amount of a tertiary amine.

Another method of manufacture of the reactive polyamideimide oligomer is copolymerization in the presence of a phosphorylation agent and a catalytic amount of a salt. In this method, the di-, tri-, or tetra-functional carboxylic acid or functional equivalent thereof, does not include an acid halide, such as an acid chloride. The advantage of this method is that costly acid chlorides are not necessary as starting materials. By way of example, copolymerization is conducted in the presence of triphenyl phosphite, a polar solvent such as NMP as solvent, and a catalytic amount of a salt such as LiCl or CaCl₂. Heating up to 120° C. for 1.5 to 2 h. under nitrogen results in formation of a reactive polyamide amic acid oligomer and partial imidization to the corresponding reactive polyamideimide oligomer. Further heating up to 150° C. with additional pyridine for up to 5 h under nitrogen provides full imidization.

The reactive polyamideimide oligomer can also be made by reactive extrusion. Thus, a method of manufacture of the reactive polyamideimide oligomer comprises reactive extrusion of at least one aromatic diamine or activated derivative thereof (e.g. diacetylated diamine), at least one aromatic di-, tri-, or tetra-functional carboxylic acid or functional equivalent thereof, and at least one crosslinkable monomer or crosslinkable end-capper at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

The reactive extrusion can be conducted in the presence of a polar solvent. The polar solvent can be at least one of N-methyl-2-pyrrolidone, N,N-dimethylacetamide, N,N-dimethylformamide, 1,2-dichlorobenzene, 1,2,4-trichlorobenzene, or sulfolane. In some embodiments, the polar solvent is N-methyl-2-pyrrolidone. The polar solvent can dissolve the monomers, or alternately, can partially dissolve the monomers and form a fluid suspension or slurry of monomers together with oligomers and intermediates formed during reactive extrusion.

The reactive extrusion can be conducted in the presence of an acid catalyst to facilitate imidization (cyclodehydration) of amic acid intermediates. When liquid under the reactive extrusion conditions, the acid catalyst can also partially dissolve the monomers and form a fluid suspension or slurry of monomers together with oligomers and intermediates formed during reactive extrusion. When the acid catalsyst is a liquid, it can be removed by distillation through vent ports during the reactive extrusion. In some embodiments, the acid catalyst is acetic acid, and it is removed by distillation during the reactive extrusion. The reactive extrusion can also be conducted in the presence of acetic anhydride, wherein the acetic anhydride is removed by distillation during the reactive extrusion. In order to facilitate removal of any water, HCl, polar solvent, acid catalyst, and acetic anhydride present or generated, reactive extrusion can be be conducted in a a melt extruder having a plurality of pre-set heating zones equipped with vent ports or other means for removal of these volatiles.

The reactive polyamideimide oligomer can also be manufactured by the “ammonium carboxylate salt” method. The ammonium carboxylate salt method comprises: heating at least one aromatic diamine, at least one aromatic di-, tri-, or tetra-functional carboxylic acid or functional equivalent thereof, and at least one crosslinkable monomer or crosslinkable end-capper in the presence of at least one of water or a C₁₋₄ alcohol at a sufficient temperature and time to form at least one reactive ammonium carboxylate salt; removing excess water and C₁₋₄ alcohol; and heating the reactive ammonium carboxylate salt at a sufficient temperature and time to form the reactive polyamideimide oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer. The C₁₋₄ alcohol can be, for example, at least one of methanol, ethanol, 1-propanol, isopropanol, 1-butanol, isobutanol, sec-butanol, or tert-butanol. In some embodiments, the C₁₋₄ alcohol is at least one of methanol or ethanol. Manufacture of an exemplary reactive polyamideimide oligomer by the ammonium carboxylate salt method is described in Scheme 3 below.

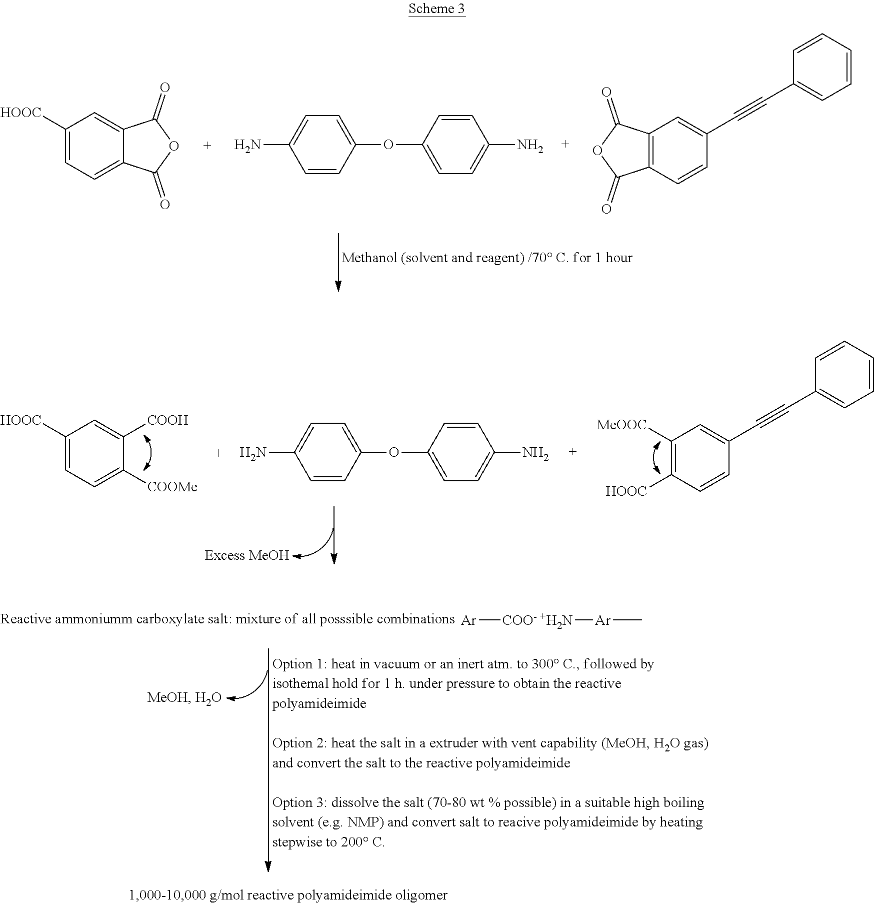

The anhydrides and diamines are heated in a C₁₋₄ alcohol, for example methanol or ethanol, at 70° C. for 1 h. This will ring-open the anhydrides and make the corresponding dicarboxylic acid alkyl half-esters, e.g. methyl or ethyl half-esters. The solvent is then removed by vacuum distillation. Thus, the reactive ammonium carboxylate salt is a mixture of all possible combinations of Ar—COO— and ⁺H₃N—Ar in which Ar represents the aryl groups, and in which Ar—COO— is a C₁₋₄ alkyl half-ester. The ammonium carboxylate salt (analogous to a Nylon salt) can be converted to the reactive polyamideimide oligomer by polymerization and imidization, which can be accomplished in various ways. Polymerization and imidization can be done by heating dry reactive ammonium carboxylate salt in an inert atmosphere, and preferably under pressure (0 to 300 MPa), up to 300° C. to obtain the reactive polyamideimide oligomer. (Option 1 in Scheme 3) The heating can be done in an sealed vessel (Option 1 in Scheme 3) and/or in an extruder with vent capability for removal of water and methanol or ethanol vapor. (Option 2 in Scheme 3) For example, the reactive ammonium carboxylate salt can be heated under an inert atmosphere stepwise at 60, 100, and 200° C. for 1 hr each in a sealed vessel, then cooled to 25° C., and then oligomerized in an extruder at 320 to 360° C. to obtain the reactive polyamideimide oligomer. Thus, in some embodiments, the method comprises reactive extrusion of the reactive ammonium carboxylate salt at a sufficient temperature and time to form the reactive polyamideimide oligomer. Polymerization and imidization can also be done by dissolving the reactive ammonium carboxylate salt in at least one polar solvent, such as water, N-methyl-2-pyrrolidone, N,N-dimethylacetamide, N,N-dimethylformamide, 1,2-dichlorobenzene, 1,2,4-trichlorobenzene, or sulfolane, followed by heating to 160° C. (Option 3 in Scheme 3) Thus, in some embodiments, the method comprises dissolving the reactive ammonium carboxylate salt in a polar solvent prior to heating at a sufficient temperature, pressure, and time to form the reactive polyamideimide oligomer.

Alternatively, the at least one aromatic diamine, at least one aromatic di-, tri-, or tetra-functional carboxylic acid or functional equivalent thereof, and at least one crosslinkable monomer or crosslinkable end-capper can be mixed with water, methanol, ethanol, mixture of methanol/water, or mixture of ethanol/water followed by heating in a pressure-resistant container (bomb calorimeter or autoclave) to 220° C. to polymerize and imidize the reactive ammonium carboxylate salt.

Advantageously, the reactive ammonium carboxylate salt has a melt complex viscosity that ranges between about 1 to about 100 Pa·s at a temperature range between about 80 to about 120° C., and solubility of in a polar solvent such as NMP is up to 70 to 80 wt % at 60° C. The low melt complex viscosity and high solubility of the reactive ammonium carboxylate salt allows for high throughput for manufacture of the reactive polyamideimide oligomer.

The reactive polyamideimide oligomer can be used to make a variety of functional materials with useful properties. Thus, a blend composition comprises the reactive polyamideimide oligomer and a thermoplastic polymer. For example, the reactive polyamideimide oligomers and reactive polyamide amic acid oligomers can be used as plasticizers or reactive diluents to improve the processability of high molecular weight PAI polymer and other high molecular weight polymers. The reactive oligomers added to PAI polymer can reduce compression molding cycle time by improved flow and improved consolidation (minimization of voids) relative to high molecular weight PAI.

Another example of a functional material is a powder coating composition comprising the reactive polyamideimide oligomer. The reactive polyamideimide oligomers in powder form can be used to prepare coatings on a variety of substrates, such as metal, ceramic, glass, and composite substrates. The powder coatings can be applied using thermal spray, (vacuum) plasma spray, and cold spray techniques.

Another example of a functional material is a reactive adhesive composition comprising the reactive polyamideimide oligomer. The reactive adhesive composition in powder form can be applied onto a variety of substrates (with or without pre-treatment), melted, and cured at a temperature of 350 to 400° C. under pressure. Substrates include glass, titanium, steel, and any material that can withstand the high cure temperature. The reactive powder can be mixed with an inert spherical filler to control the adhesive layer thickness (e.g. glass beads). The reactive adhesive can also be melted into a fabric to make a reactive adhesive tape, which can be placed between two substrates, heated, and cured under pressure.

Another example of a functional material is a high temperature elastomer composition made by heating the reactive polyamideimide oligomer at a temperature and time sufficient to crosslink the reactive polyamideimide oligomer. Parts made from crosslinked parts that are neat, filled, or fiber reinforced can be used as high temperature elastomers for sealant and gasket applications.

Another example of a functional material is high temperature foam comprising the reactive polyamideimide oligomer.

It can be desirable to compound the reactive polyamideimide oligomer with other materials in order to improve physical properties. Thus, a method of compounding the reactive polyamideimide oligomer comprises mixing the reactive polyamideimide oligomer with at least one other material at a sufficient temperature and time to melt, but not crosslink, the reactive polyamideimide oligomer. The material can be at least one polymer, filler, or additive. For example, the reactive polyamideimide oligomer can be compounded with other reactive polyamideimide oligomers and/or reactive polyamide amic acid oligomers, to improve thermomechanical properties. The reactive polyamideimide oligomer can also be used to make block copolymers with other reactive polyamideimide oligomers and/or reactive polyamide amic acid oligomers to improve thermomechanical properties.

The reactive polyamideimide oligomer can be used to manufacture a variety of articles or parts with useful properties. Thus, a method of manufacture of an article, comprises heating the reactive polyamideimide oligomer at a sufficient temperature and time to shape and crosslink the reactive polyamideimide oligomer. The sufficient temperature and time to shape and crosslink the reactive polyamideimide oligomer is about 300 to about 450° C. for about 1 to about 60 minutes. Exemplary cure conditions are about 350 to about 400° C. for about 30 to about 60 minutes, for example about 360° C. for about 45 minutes.

The method of manufacture can be, for example, additive manufacturing, fiber reinforced composite manufacturing, pultrusion, fiber spinning, compression molding, injection molding, reaction injection molding, blow molding, rotational molding, transfer molding, foam molding, thermoforming, casting, solution casting, or forging.

Also disclosed are articles manufactured by the method. A variety of manufacturing methods and articles made by the methods are described below.

The method of manufacture can be fiber reinforced composite manufacturing. The reactive polyamideimide oligomer can exist in powder of film. Thus, the fiber reinforced composite manufacturing can comprise heating at least one layer of fiber fabric and at least one layer of the reactive polyamideimide oligomer as a powder or film at a sufficient temperature, pressure, and time to melt the reactive polyamideimide oligomer, impregnate the fiber fabric, and crosslink the reactive polyamideimide oligomer to form a fiber reinforced composite.

The reactive polyamideimide oligomer can also be dissolved in a polar solvent. Thus, the fiber reinforced manufacturing method can comprise impregnating at least one layer of fiber fabric with a solution of the reactive polyamideimide oligomer dissolved in a polar solvent; removing the polar solvent under reduced pressure; and heating at a sufficient temperature, pressure, and time to crosslink the reactive polyamideimide oligomer and form a fiber reinforced composite. The fiber can be, for example, carbon fiber, glass fiber, cellulose (wood/paper fiber, straw), polyaramid (poly(p-phenylene terephthalamide)), polybenzoxazole (PBO), or polybenzimidazole (PBI).

A fiber reinforced composite manufactured by either of these methods is also disclosed. For example, the composite can be a multi-ply carbon reinforced composite. The multi-ply reinforced composite can have any number of layers, but in some embodiments, the number of layers is greater than or equal to 2 layers and less than or equal to 1,000 layers.

The method of manufacture can be pultrusion for making a unidirectional tape. As with fiber reinforced composite manufacturing, the pultrusion can be from a melt or a solution of the reactive polyamideimide oligomer in a polar solvent. A unidirectional tape prepared by pultrusion is also disclosed. The unidirectional (UD) tape can be a plain tape, slit tape, roving, or towpreg. UD tape can be used for automated tape lay-up techniques/TOW robots for making fiber reinforced composites.

The method of manufacture can be solution spinning or melt spinning of fibers. A fiber manufactured by solution spinning or melt spinning is also disclosed. Both reactive polyamide amic acid oligomers and reactive polyamideimide oligomers having an Mₙ of about to about 10,000 g/mol can be spun into fibers from either the solution state or melt state. In solution spinning, the reactive oligomers dissolved in a suitable polar solvent or polar solvent mixture, e.g. NMP, DMAc, DMF, or NMP/THF, can be spun into fibers using a standard solution spinning set-up including a plunger pump and spinneret operated at 25° C. to 80° C. Fibers are obtained after coagulation in a non-solvent (e.g. water/acetone at −10° C. to 60° C.). The resulting fibers are dried and heated to induce imidization and crosslinking. The as-spun fibers can also be dried using a stream of hot air followed by an additional heating step. During heat treatment the fibers can be exposed to a stretching step, which increases alignment of the polymer chains along the stretching direction and hence the fiber strength. In melt spinning, the reactive polyamideimide oligomers are melted and spun into fibers using a spinning set-up including a plunger pump, a heated resin chamber (250° C. to 300° C.) and a heated spinneret operated at 300° C. to 400° C. to induce crosslinking. The hot-drawn fibers can be (air/water) cooled and spooled, followed by a second heating step, with or without post stretching, in order to complete crosslinking and increase fiber strength.

The method of manufacture can be additive manufacturing. Articles manufactured by additive manufacturing are also disclosed. In some embodiments of additive manufacturing, the method is fused filament fabrication. Fused filament fabrication comprises extruding the reactive polyamideimide oligomer in adjacent horizontal layers such that there is an interface between each layer of polyamideimide oligomer, and exposing the layers to heat at a sufficient temperature and time to crosslink the reactive polyamideimide oligomer and form the article. Articles manufactured by fused filament fabrication are also disclosed.

Fused filament fabrication uses material extrusion to print items, where a feedstock material is pushed through an extruder. In most fused filament fabrication 3D printing machines, the feedstock material comes in the form of a filament wound onto a spool. The 3D printer liquefier is the component predominantly used in this type of printing. Extruders for these printers have a hot end and a cold end. The “cold” end is cooler than the hot end, but can still be in the temperature range of 100 to 250° C. The cold end pulls material from the spool, using gear- or roller-based torque to the material and controlling the feed rate by means of a stepper motor. The cold end pushes feedstock into the hot end. The hot end consists of a heating chamber and a nozzle. The heating chamber hosts the liquefier, which melts the feedstock to transform it into a molten state. It allows the molten material to exit from the small nozzle to form a thin, tacky bead of plastic that will adhere to the material it is laid on. The nozzle will usually have a diameter of between 0.3 mm and 1.0 mm. Different types of nozzles and heating methods are used depending upon the material to be print.

The filament can be in the form of a thin filament wound onto a spool. In a variation of this method, the feedstock is in the form of a rod instead of a filament. Since the rod is thicker than the filament, it can be pushed towards the hot end by means of a piston or rollers, applying a greater force and/or velocity compared to conventional fused filament fabrication.

Weld lines are defined as the planar interface between layers of extruded material. The reactive polyamideimide oligomers diffuse across the interfaces and react to rapidly increase polymer chain entanglements and network formation across the interfaces, thereby fusing adjacent layers together. The weld lines (interfaces) are further strengthened by chain extension and/or crosslinking of the reactive polyamideimide oligomers entangled across the interfaces, resulting in improved z-axis strength.

This process of chain entanglement, network formation, chain extension, and crosslinking in fused filament fabrication can be optimized by using reactive polyamideimide oligomers having two different reactive end groups. Oligomer chains having first unreacted functional groups with a first cure temperature can crosslink first to fix the printed structure in place. Oligomer chains having second unreacted functional groups with a second cure temperature that is higher than the first cure temperature can diffuse across the interfaces and cure at the second cure temperature, build molecular weight, crosslink density, and strength of the part.

In some embodiments of additive manufacturing, the method is selective laser sintering. Selective laser sintering comprises selectively sintering and crosslinking particles of the reactive polyamideimide oligomer with a laser to form the article. Articles manufactured by selective laser sintering are also disclosed. Selective laser sintering (SLS) involves the use of a high-power laser (e.g. a carbon dioxide laser) to fuse small particles of plastic, metal, ceramic, or glass powders into a mass that has a desired three-dimensional shape. The laser selectively fuses powdered material by scanning cross-sections generated from a 3D digital description of the part (e.g. from a CAD file or scan data) on the surface of a powder bed. After each cross-section is scanned, the powder bed is lowered by one-layer thickness, a new layer of material is applied on top, and the process is repeated until the part is completed. The SLS machine preheats the bulk powder material in the powder bed to a temperature below the flow point of the powder, to make it easier for the laser to raise the temperature of the selected regions to the point where the powder softens and fuses together.

In some embodiments of additive manufacturing, the method of manufacture is directed energy deposition (DED) or laser engineered net shaping (LENS). Articles manufactured by DED and LENS are also disclosed.

In contrast with some other additive manufacturing processes, such as stereolithography (SLA) and fused filament fabrication (FFF), which most often require special support structures to fabricate overhanging designs, SLS does not need a separate feeder for support material because the part being constructed is surrounded by unsintered powder at all times, this allows for the construction of previously impossible geometries. Also, since the machine's chamber is always filled with powder material the fabrication of multiple parts has a far lower impact on the overall difficulty and price of the design because through a technique known as “nesting”, multiple parts can be positioned to fit within the boundaries of the machine.

In additive manufacturing methods such as FFF and SLS using the reactive polyamideimide oligomers as the raw materials, the oligomers diffuse across particle or filament interfaces and interact to rapidly increase polymer chain entanglements across the particle or filament interfaces, thereby fusing adjacent particles or filaments together. The interfaces are further strengthened by chain extension and crosslinking of the reactive polyamideimide oligomers entangled across the interfaces.

The concepts of diffusion across interfaces, and chain entanglement and crosslinking across interfaces are further illustrated by FIG. 2A to 2D. In each of FIGS. 2A and 2D, the oligomer or polymer on the left is in the solid state and the oligomer or polymer on the right is in the molten state. FIG. 2A depicts high molecular weight high performance thermoplastic on either side of an interface. The high molecular weight polymer can diffuse across the interface in both directions and form chain entanglements depicted in FIG. 2B. However long thermal annealing times (hours) at temperatures above T_{g} but below Tₘ are required.

FIG. 2C depicts reactive oligomer on either side of an interface. The low molecular weight reactive oligomer diffuses much faster across the interface in both directions above T_{g} but below Tₘ and form chain entanglements depicted in FIG. 2D. This rapid diffusion results in reduced thermal annealing times. Chain extension and crosslinking can also occur through the unreacted functional groups. The net effect of faster diffusion, chain entanglement, and chain extension and crosslinking is improved inter-layer strength, i.e. improved z-axis strength in FFF and in SLS.

As with fused filament fabrication, this process of chain entanglement, network formation, chain extension, and crosslinking can be further enhanced in selective laser sintering by using reactive polyamideimide oligomers having two different reactive end groups. Oligomer chains having first unreacted functional groups with a first cure temperature can crosslink first to fix the printed structure in place. Oligomer chains having second unreacted functional groups with a second cure temperature that is higher than the first cure temperature can diffuse across the interfaces and cure at the second cure temperature, build molecular weight, crosslink density, and strength of the part.

The method of manufacture can be solution casting. Solution casting comprises: casting a solution of the reactive polyamideimide oligomer dissolved in a polar solvent onto a mold; removing the polar solvent to form a reactive polyamideimide oligomer film; and heating the polyamideimide oligomer film at a sufficient temperature and time to crosslink the polyamideimide oligomer and form a flexible film. Flexible films manufactured by solution casting of the reactive polyamideimide oligomer are also disclosed.

The method of manufacture can also be injection molding. Articles manufactured by injection molding of the reactive polyamideimide oligomer are also disclosed.

As mentioned above, reactive polyamide amic acid oligomers are intermediates in the manufacture of reactive polyamideimide oligomers. Thus, a reactive polyamide amic acid oligomer comprises units derived from at least one aromatic diamine, at least one aromatic di-, tri-, or tetra-functional carboxylic acid or functional equivalent thereof, and at least one crosslinkable monomer or crosslinkable end-capper, wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer; and wherein the reactive polyamide amic acid oligomer has a number average molecular weight (Mₙ) of about 1,000 to about 10,000 g/mol, calculated using the Carothers equation. Reactive polyamideimide oligomers and reactive polyamide amic acid oligomers are closely related in that reactive polyamide amic acid oligomer is an intermediate in the formation of the corresponding reactive polyamideimide oligomer. They only differ in the degree of imidization. While reactive polyamideimide oligomer as herein defined can have greater than 20% and less than or equal to 100% of amic acid groups in the reactive polyamide amic acid intermediate imidized, 0% to about 20% of amic acid groups are imidized in the reactive polyamide amic acid oligomer as herein defined.

Compositional descriptions that apply to the reactive polyamideimide oligomers disclosed herein likewise apply to the reactive polyamide amic acid oligomers. Thus, the aromatic diamine can be at least one of 1,3-phenylene diamine, 4,4′-oxydianiline, or 3,4′-oxydianiline and the di-, tri-, or tetra-functional aromatic carboxylic acid or functional equivalent thereof can be at least one of trimellitic anhydride, 4-chloroformylphthalic anhydride, isophthalic anhydride, isophthaloyl chloride, pyromellitic dianhydride, or biphenyl tetracarboxylic acid dianhydride. The unreacted functional group that participates in subsequent chain extension, branching, and crosslinking reactions can be at least one of ethyne, methylethyne, phenylethyne, ketoethyne, propargyl ether, norbornene, maleimide, cyanate ester, phthalonitrile, benzocyclobutene, biphenylene, or benzoxazine. These unreacted functional groups are depicted in Table 1 with chemical formulas, chemical names, and curing temperature ranges. The at least one crosslinkable monomer or crosslinkable end-capper can be two crosslinkable monomers or crosslinkable end-cappers that are reactive at different temperature ranges. In some embodiments, the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

The reactive polyamide amic acid oligomer can further comprise units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof, but has no unreacted functional groups capable of chain extension and crosslinking after formation of the reactive polyamideimide oligomer. The non-crosslinkable end-capper can be at least one of benzoic acid, benzoyl chloride, phthalic anhydride, or aniline.

The reactive polyamide amic acid oligomer can be manufactured by a method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form the reactive polyamide amic acid; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer.

The reactive polyamide amic acid oligomer is manufactured in the presence of a polar solvent, which lowers the temperature range sufficient to make the reactive oligomer. The polar solvent should have a boiling point of at least 150° C. at one atmosphere. The polar solvent can be at least one of N-methyl-2-pyrrolidone, N,N-dimethylacetamide, N,N-dimethylformamide, 1,2-dichlorobenzene, 1,2,4-trichlorobenzene, or sulfolane. In some embodiments, the polar solvent is N-methyl-2-pyrrolidone. In some embodiments, the method further comprises isolating the reactive polyamide amic acid oligomer from the polar solvent.

Like the related reactive polyamideimide oligomer, the reactive polyamide amic acid oligomer can be used to make a variety of functional materials with useful properties. Thus, a blend composition comprises the reactive polyamide amic acid oligomer and a thermoplastic polymer. For example, the reactive polyamide amic acid oligomers can be used as plasticizers or reactive diluents to improve the processability of high molecular weight PAI polymer and other high molecular weight polymers. The reactive oligomers added to PAI polymer can reduce compression molding cycle time by improved flow and improved consolidation (minimization of voids) relative to high molecular weight PAI.

Other examples of functional materials comprising the reactive polyamide amic acid oligomer include a powder coating composition, a reactive adhesive composition, and a high temperature foam.

It can be desirable to compound the reactive polyamide amic acid oligomer with other materials. A method of compounding the reactive polyamide amic acid oligomer comprises mixing the reactive polyamide amic acid oligomer with at least one other material at a sufficient temperature and time to melt, but not crosslink, the reactive polyamide amic acid oligomer. The material can be at least one polymer, filler, or additive.

Like the reactive polyamideimide oligomer, the reactive polyamide amic acid oligomer can be used to manufacture a variety of articles or parts with useful properties. Thus, a method of manufacture of an article comprises heating the reactive polyamide amic acid oligomer at a sufficient temperature and time to imidize, shape, and crosslink the reactive polyamide amic acid oligomer. The sufficient temperature and time to imidize, shape, and crosslink the reactive polyamide amic acid oligomer is about 300 to about 450° C. for about 1 to about 60 minutes. Exemplary cure conditions are about 350 to about 400° C. for about 30 to about 60 minutes, for example about 360° C. for about 45 minutes.

The method of manufacture can be, for example, additive manufacturing, fiber reinforced composite manufacturing, pultrusion, fiber spinning, compression molding, injection molding, reaction injection molding, blow molding, rotational molding, transfer molding, foam molding, thermoforming, casting, solution casting, or forging.

Also disclosed are articles manufactured by the method. A variety of manufacturing methods and articles made by the methods are described below.

The method of manufacture can be fiber reinforced composite manufacturing. The reactive polyamide amic acid oligomer can be in powder of film form. Thus, the fiber reinforced composite manufacturing can comprise heating at least one layer of fiber fabric and at least one layer of the reactive polyamide amic acid oligomer as a powder or film at a sufficient temperature, pressure, and time for the reactive polyamide amic acid oligomer to imidize, impregnate the fiber fabric, and crosslink to form a fiber reinforced composite.

The reactive polyamide amic acid oligomer can also be dissolved in a polar solvent. Thus, the fiber reinforced manufacturing method can comprise: impregnating at least one layer of fiber fabric with a solution of the reactive polyamide amic acid oligomer dissolved in a polar solvent; removing the polar solvent under reduced pressure, and heating at a sufficient temperature, pressure, and time to imidize and crosslink the reactive polyamide amic acid oligomer to form a fiber reinforced composite. The fiber can be, for example, carbon fiber, glass fiber, cellulose (wood/paper fiber, straw), polyaramid (poly(p-phenylene terephthalamide)), polybenzoxazole (PBO), or polybenzimidazole (PBI).

A fiber reinforced composite manufactured from a reactive polyamide amic acid oligomer by either of these methods is also disclosed. For example, the composite can be a multi-ply carbon reinforced composite. The multi-ply reinforced composite can have any number of layers, but in some embodiments, the number of layers is greater than or equal to 2 layers and less than or equal to 1,000 layers.

The method of manufacture can be pultrusion for making a unidirectional tape. As with fiber reinforced composite manufacturing, the pultrusion can be from a melt or a solution of the reactive polyamide amic acid oligomer in a polar solvent. A unidirectional tape prepared by pultrusion is also disclosed. The unidirectional (UD) tape can be a plain tape, slit tape, roving, or towpreg. UD tape can be used for automated tape lay-up techniques/TOW robots for making fiber reinforced composites.

The method of manufacture can be solution spinning or melt spinning of fibers from the reactive polyamide amic acid oligomer. A fiber manufactured by solution spinning or melt spinning of the reactive polyamide amic acid oligomer is also disclosed.

The method of manufacture can be additive manufacturing. Articles made by additive manufacturing are also disclosed. In some embodiments of additive manufacturing, the method is fused filament fabrication. Fused filament fabrication comprises extruding the reactive polyamide amic acid oligomer in adjacent horizontal layers such that there is an interface between each layer of reactive polyamide amic acid oligomer, and exposing the layers to heat at a sufficient temperature and time to imidize and crosslink the reactive polyamide amic acid oligomer and form the article. Articles manufactured by fused filament fabrication of the reactive polyamide amic acid oligomer are also disclosed.

In some embodiments of additive manufacturing, the method is selective laser sintering. Selective laser sintering comprises selectively sintering, imidizing, and crosslinking particles of the reactive polyamide amic acid oligomer with a laser to form the article. Articles manufactured by selective laser sintering of the reactive polyamide amic acid oligomer are also disclosed.

In some embodiments of additive manufacturing, the method of manufacture is directed energy deposition (DED) or laser engineered net shaping (LENS). Articles manufactured by DED and LENS of the reactive polyamide amic acid oligomer are also disclosed.

The method of manufacture can be solution casting. Solution casting comprises: casting a solution of the reactive polyamide amic acid oligomer dissolved in a polar solvent onto a mold; removing the solvent to form a reactive polyamide amic acid oligomer film; and heating the reactive polyamide amic acid oligomer film at a sufficient temperature and time to imidize and crosslink the reactive polyamide amic acid oligomer and form a flexible film. Flexible films manufactured by solution casting of the reactive polyamide amic acid oligomer are also disclosed.

The method of manufacture can also be injection molding. Articles manufactured by injection molding of the reactive polyamide amic acid oligomer are also disclosed.

The method of manufacture can also be blow molding. Articles manufactured by blow molding of the reactive polyamide amic acid oligomer are also disclosed.

The “ammonium carboxylate salt” method for manufacture of reactive polyamideimide oligomers is discussed above. The first step in this method is formation of a reactive ammonium carboxylate salt. As an intermediate in the manufacture of reactive polyamideimide oligomer, the reactive ammonium carboxylate salt is itself a useful composition. Therefore, disclosed herein is a reactive ammonium carboxylate salt formed by a method comprising: heating at least one aromatic diamine, at least one aromatic di-, tri-, or tetra-functional carboxylic acid or functional equivalent thereof, and at least one crosslinkable monomer or crosslinkable end-capper in the presence of a C₁₋₄ alcohol at a sufficient temperature and time, such as about 50° C. to about 150° C., for about 30 minutes to about 8 hours, to form the reactive ammonium carboxylate salt; and removing excess C₁₋₄ alcohol; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive ammonium carboxylate salt. The C₁₋₄ alcohol can be, for example, at least one of methanol, ethanol, 1-propanol, isopropanol, 1-butanol, isobutanol, sec-butanol, or tert-butanol. In some embodiments, the C₁₋₄ alcohol is at least one of methanol or ethanol.

Reactive ammonium carboxylate salts are related to the reactive polyamideimide oligomers and reactive polyamide amic acid oligomers disclosed herein in that they all can be made from the same at least one aromatic diamine, at least one aromatic di-, tri-, or tetra-functional carboxylic acid or functional equivalent thereof, and at least one self-reactive monomer or end-capper. Therefore, compositional descriptions that apply to the reactive polyamideimide oligomers and reactive polyamide amic acid oligomers disclosed herein likewise apply to the reactive ammonium carboxylate salts, except aromatic acid chlorides are not necessary. Thus, the aromatic diamine can be at least one of 1,3-phenylene diamine, 4,4′-oxydianiline, or 3,4′-oxydianiline and the di-, tri-, or tetra-functional aromatic carboxylic acid or functional equivalent thereof can be at least one of trimellitic anhydride, isophthalic anhydride, pyromellitic dianhydride, or biphenyl tetracarboxylic acid dianhydride. The unreacted functional group that participates in subsequent chain extension, branching, and crosslinking reactions can be at least one of ethyne, methylethyne, phenylethyne, ketoethyne, propargyl ether, norbornene, maleimide, cyanate ester, phthalonitrile, benzocyclobutene, biphenylene, or benzoxazine. These unreacted functional groups are depicted in Table 1 with chemical formulas, chemical names, and curing temperature ranges. The at least one crosslinkable monomer or crosslinkable end-capper can be two crosslinkable monomers or crosslinkable end-cappers that are reactive at different temperature ranges. In some embodiments, the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

The reactive ammonium carboxylate salt can further comprise units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof, but has no unreacted functional groups capable of chain extension and crosslinking after formation of the reactive polyamideimide oligomer. The non-crosslinkable end-capper can be at least one of benzoic acid, benzoyl chloride, phthalic anhydride, or aniline.

Advantageously, the reactive ammonium carboxylate salt can have a melt complex viscosity of about 1 to about 100 Pa·s between about 80° C. and about 120° C., measured by oscillatory shear rheology between parallel plates at a heating rate of 10° C./minute under N₂, a frequency of 2 radians/second, and a strain of 0.03%-1.0%. Within this range, the melt complex viscosity is a function of Mₙ and the types and relative amounts of the at least one diamine, the at least one di-, tri-, or tetra-functional aromatic carboxylic acid or functional equivalent thereof, and crosslinkable or non-crosslinkable monomers and end-cappers present. Depending upon the method of preparation, the reactive ammonium carboxylate salt can also melt at about 320° C.

The reactive ammonium carboxylate salt is manufactured by a method comprising: heating at least one aromatic diamine, at least one aromatic di-, tri-, or tetra-functional carboxylic acid or functional equivalent thereof, and at least one crosslinkable monomer or crosslinkable end-capper in the presence of at least one of water or a C₁₋₄ alcohol at a sufficient temperature and time to form a reactive ammonium carboxylate salt; and removal of excess C₁₋₄ alcohol; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive ammonium carboxylate salt.

As with the reactive polyamideimide oligomer and reactive polyamide amic acid oligomer, it can be desirable to compound the reactive ammonium carboxylate salt with other materials. A method of compounding the reactive polyamide amic acid oligomer comprises mixing the reactive polyamide amic acid oligomer with at least one other material at a sufficient temperature and time to melt, but not crosslink, the reactive polyamide amic acid oligomer. The material can be at least one polymer, filler, or additive.

Like the reactive polyamideimide oligomer and reactive polyamide amic acid oligomer, the reactive ammonium carboxylate salt can be used to manufacture a variety of articles or parts with useful properties. Thus, a method of manufacture of an article comprises heating the reactive ammonium carboxylate salt for a sufficient temperature, pressure, and time to make, shape, and crosslink a reactive polyamideimide oligomer. The sufficient temperature and time to make, shape, and crosslink the reactive polyamide amic acid oligomer is about 300° C. to about 400° C., 0 to about 300 MPa, and about 10 to about 60 minutes.

The method of manufacture can be, for example, fiber reinforced composite manufacturing, pultrusion, compression molding, injection molding, or solution casting. Also disclosed are articles manufactured by the method. These manufacturing methods and articles made by the methods are described below.

The method of manufacture can be fiber reinforced composite manufacturing. The reactive ammonium carboxylate salt can exist as a powder or film. Thus, the fiber reinforced composite manufacturing can comprise heating at least one layer of fiber fabric and at least one layer of the reactive ammonium carboxylate salt as a powder or film at a sufficient temperature, pressure, and time for the reactive ammonium carboxylate salt to impregnate the fiber fabric, and to make and crosslink a reactive polyamideimide oligomer to form a fiber reinforced composite.

The reactive ammonium carboxylate salt can also be dissolved in a polar solvent. Thus, the fiber reinforced manufacturing method can comprise impregnating the fiber fabric with a solution of the reactive ammonium carboxylate salt dissolved in a polar solvent; removing the polar solvent at reduced pressure; and heating at a sufficient temperature, pressure, and time to polymerize and crosslink a reactive polyamideimide oligomer to form a fiber reinforced composite. The fiber can be, for example, carbon fiber, glass fiber, cellulose (wood/paper fiber, straw), polyaramid (poly(p-phenylene terephthalamide)), polybenzoxazole (PBO), or polybenzimidazole (PBI).

A fiber reinforced composite manufactured from a reactive ammonium carboxylate salt by either of these methods is also disclosed. For example, the composite can be a multi-ply carbon reinforced composite. The multi-ply reinforced composite can have any number of layers, but in some embodiments, the number of layers is greater than or equal to 2 layers and less than or equal to 1,000 layers.

The method of manufacture can be solution casting. Solution casting comprises: casting a solution of the reactive ammonium carboxylate salt dissolved in a polar solvent onto a mold; removing the polar solvent to form a reactive ammonium carboxylate salt film; and heating the reactive ammonium carboxylate salt film at a sufficient temperature, pressure, and time to make and crosslink a reactive polyamideimide oligomer to form a flexible film. Flexible films manufactured by solution casting of the reactive ammonium carboxylate salt are also disclosed.

The method of manufacture can also be injection molding of the reactive ammonium carboxylate salt. Articles manufactured by injection molding of the reactive ammonium carboxylate salts are also disclosed. The method of manufacture can also be compression molding of the reactive ammonium carboxylate salt. Articles manufactured by compression molding of the reactive ammonium carboxylate salt are also disclosed.

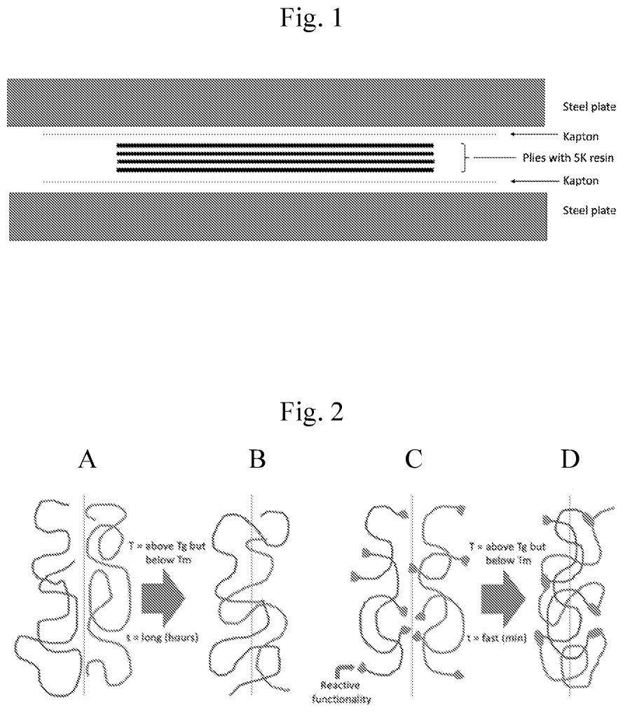

The reactive polyamideimide oligomers and reactive polyamide amic acid oligomer (“reactive oligomers”), methods of manufacture using the reactive oligomers, and articles made from the reactive oligomers have several advantageous properties. Currently available high molecular weight PAI can have relatively high levels of amic acid groups in order to have sufficiently low complex viscosity to be melt processable. The presence of amic acid groups can make PAI extremely hygroscopic. Therefore, pre-processing drying is also required. The manufacturing and processing of currently available PAI configured as illustrated in FIG. 1, would involve imidization of polyamide amic acid stock shapes or injection molded parts, long periods of thermal post-treatment to remove water generated from conversion of amic acid groups to imide groups are necessary. PAI parts that have been machined are also exposed to a multi-day thermal treatment protocol after machining. A general cure schedule recommended by a manufacturer is: 1 day at 375° F. (191° C.), 1 day at 425° F. (218° C.), 1 day at 475° F. (246° C.), and 5 days at 500° F. (260° C.), for a total of 8 days. In contrast, curing for the reactive polyamideimide oligomers at about 300 to about 450° C. can be completed in as little as about 1 to about 60 minutes. Advantageously, this reduction in the thermal post-treatment time results in greatly reduced manufacturing cycle time and cost.

The reactive polyamideimide oligomers having a Mₙ of about 1,000 to about 10,000 g/mol advantageously exhibit a melt complex viscosity of about 1,000 to about 100,000 Pa·s at 360° C., specifically about 5,000 to about 30,000 Pa·s at 360° C. In contrast, currently available PAI is reported to have a melt complex viscosity of about 1,000,000 Pa·s at 2 radians/second. The low melt complex viscosity of the fully imidized reactive polyamideimide oligomer relative to currently available PAI is unexpected. In contrast to the low melt complex viscosity obtained, the combination of backbone phthalimide units, which are rigid, alternating with aromatic amide units, which are expected to be strongly hydrogen bonded as in polyaramid, is expected to result in a high melting point and high melt complex viscosity even for the reactive polyamideimide oligomers. Advantageously, with melt complex viscosity in the range of from about 1,000 to about 100,000 Pa·s at 360° C., melt processing can be done using conventional melt processing equipment, and ready-to-use injection molded parts, films, fibers and melt processable high temperature adhesives can be made. Also, compared to polyamide amic acid polymers, fully imidized reactive polyamideimide oligomers are less hygroscopic than polyamide amic acid polymers, and can be insoluble in polar solvents such as DMF, NMP, and DMAc, depending on the monomer and reactive and non-reactive end-capper used.

Advantageously, thermal cure temperature ranges and after-cure thermomechanical properties can be controlled by selection of backbone monomers, crosslinkable monomers, crosslinkable end-cappers, and non-crosslinkable end-cappers. Moreover, improved thermomechanical properties are obtained with the present reactive polyamideimide oligomers. Reference is made to Example 1C below, which is a reactive polyamideimide oligomer having a Mₙ of 5,000 g/mol in which both reactive end groups are phenylethyne. A film made from the reactive polyamideimide oligomer and cured for 1 h at 370° C. had a T_{g} of 326° C., which is about 46° C. higher than the T_{g} of a currently available PAI film. Reference is also made to Example 2 below, which is a reactive polyamideimide oligomer having a Mₐ of 5,000 g/mol and mixed reactive end groups (50/50 methylethyne/phenylethyne). A film made from the reactive polyamideimide oligomer and cured for 1 h at 370° C. had a T_{g} of 301° C. The film had a toughness of 94.3 MJ/m³. In contrast, currently available PAI has a toughness of only ˜10 MJ/m³. Therefore, the toughness of PAI films made from this reactive polyamideimide oligomer can be almost 10 times higher than PAI made from currently available PAL. T_{g}, strength at break, and elongation at break are also increased compared to currently available PAI.

Advantageously, the low melt complex viscosity of the reactive polyamideimide oligomers relative to high molecular weight polyamideimide polymers makes reactive polyamideimide oligomers ideally suited for preparing fiber reinforced composites such as glass, carbon, and aramid fiber reinforced composites. Solution-based pre-preg, melt impregnation, and melt pultrusion methods can all be used. High molecular weight polyamide amic acid could be used to prepare fiber/resin pre-pregs and composites. However, it would be difficult to obtain enough melt flow to melt consolidate polyamide amic acid pre-pregs into a composite panel. Also, it can be difficult to remove water from the composite panel during imidization of the polyamide amic acid. This means it would be difficult to achieve less than 2% voids, which is considered acceptable. Alternatively, high molecular weight polyamide amic acid can be converted to high molecular weight polyamideimide at the pre-preg stage, and the polyamideimide pre-pregs can be consolidated into a composite. The even higher melt complex viscosity of the high molecular weight polyamideimide can make it difficult to obtain sufficient melt flow under pressure to consolidate the pre-pregs into an acceptable quality composite panel. Therefore, the relatively low melt complex viscosity of reactive polyamideimide oligomers provides an advantage over both high molecular weight polyamideimide and high molecular weight polyamide amic acid in fabrication of fiber reinforced composites.

In contrast to high molecular weight polyamideimide polymers, the low melt complex viscosity of the reactive polyamideimide oligomers also makes them ideally suited for 3D printing applications. The reactive polyamideimide oligomers can be utilized in filament, rod, or powder form.

This disclosure is further illustrated by the following aspects of the disclosure, which are not intended to limit the claims.

Aspect 1. A reactive polyamideimide oligomer comprising units derived from at least one aromatic diamine, at least one aromatic di-, tri-, or tetra-functional carboxylic acid or functional equivalent thereof, and at least one crosslinkable monomer or crosslinkable end-capper; wherein the crosslinkable monomer or crosslinkable end-capper is reactive with the at least one aromatic diamine or at least one di-, tri- or tetra-functional aromatic carboxylic acid or functional equivalent thereof and has at least one unreacted functional group capable of thermal chain extension and crosslinking after formation of the reactive polyamideimide oligomer; and wherein the reactive polyamideimide oligomer has a number average molecular weight (Mn) of about 1,000 to about 10,000 g/mol, calculated using the Carothers equation.

Aspect 2. The reactive polyamideimide oligomer of aspect 1, wherein the reactive polyamideimide oligomer is derived from a reactive polyamide amic acid oligomer intermediate by cyclodehydration, and greater than 80% and less than or equal to 100% of amic acid groups in the reactive polyamide amic acid intermediate are imidized.

Aspect 3. The reactive polyamideimide oligomer of aspect 1, wherein the reactive polyamideimide oligomer is derived from a reactive polyamide amic acid oligomer intermediate by cyclodehydration, and greater than or equal to 20% and less than or equal to 80% of amic acid groups in the reactive polyamide amic acid intermediate are imidized.

Aspect 4. The reactive polyamideimide oligomer of any of aspects 1 to 3, wherein the crosslinkable monomer or crosslinkable end-capper has one unreacted functional group capable of thermal chain extension and crosslinking after formation of the reactive polyamideimide oligomer.

Aspect 5. The reactive polyamideimide oligomer of any of aspects 1 to 4, wherein the at least one crosslinkable monomer or crosslinkable end-capper is at least one crosslinkable end-capper.

Aspect 6. The reactive polyamideimide oligomer of any of aspects 1 to 5, wherein the at least one aromatic diamine is two aromatic diamines.

Aspect 7. The reactive polyamideimide oligomer of any of aspects 1 to 6, wherein the at least one aromatic di-, tri-, or tetra-functional carboxylic acid or functional equivalent thereof is two aromatic di-, tri-, or tetra-functional carboxylic acids or functional equivalents thereof.

Aspect 8. The reactive polyamideimide oligomer of any of aspects 1 to 7, prepared by a process comprising simultaneous step-growth polymerization of the at least one aromatic diamine, the at least one aromatic di-, tri-, or tetra-functional carboxylic acid or functional equivalent thereof, and the at least one crosslinkable monomer or crosslinkable end-capper.

Aspect 9. The reactive polyamideimide oligomer of any of aspects 1 to 8, wherein the aromatic diamine is at least one of.

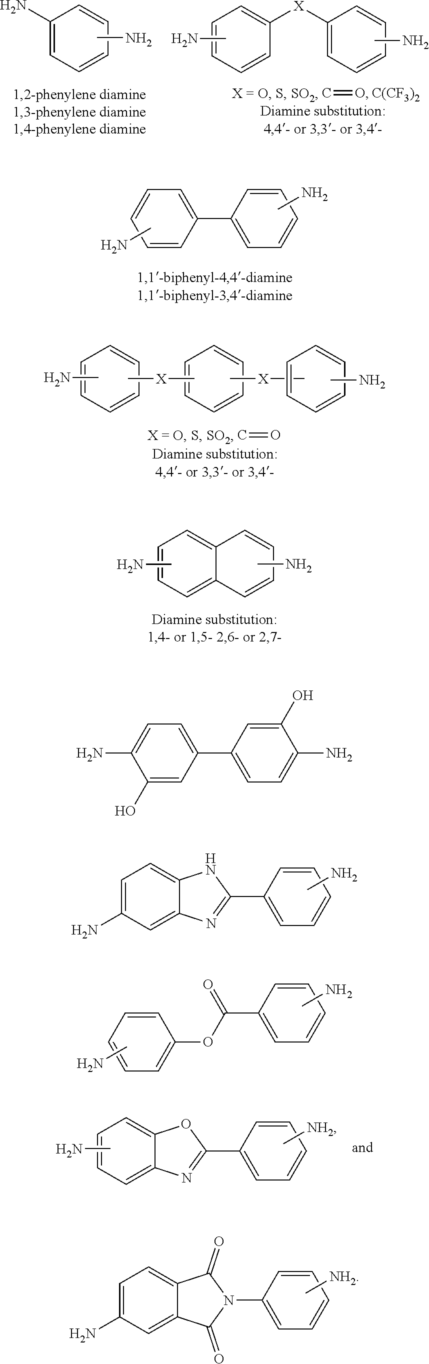

Aspect 10. The reactive polyamideimide oligomer of any of aspects 1 to 9, wherein the aromatic diamine is at least one of 1,3-phenylene diamine, 4,4′-oxydianiline, or 3,4′-oxydianiline.

Aspect 11. The reactive polyamideimide oligomer of any of aspects 1 to 10, wherein the di-, tri-, or tetra-functional aromatic carboxylic acid or functional equivalent thereof is at least one of.

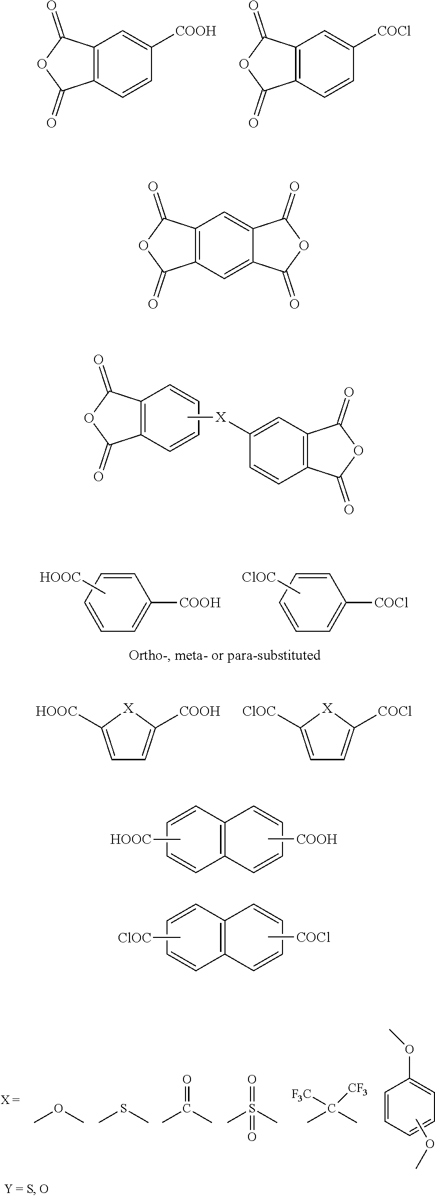

Aspect 12. The reactive polyamideimide oligomer of any of aspects 1to 11, wherein the unreacted functional group is at least one of ethyne, methylethyne, phenylethyne, ketoethyne, propargyl ether, norbornene, maleimide, cyanate ester, phthalonitrile, benzocyclobutene, biphenylene, or benzoxazine.

Aspect 13. The reactive polyamideimide oligomer of any aspects 1 to 12, wherein the unreacted functional group is at least one of the ethyne, methylethyne, phenylethyne, ketoethyne, propargyl ether, norbornene, maleimide, cyanate ester, phthalonitrile, benzocyclobutene, biphenylene, or benzoxanine.

Aspect 14. The reactive polyamideimide oligomer of any of aspects 1 to 13, wherein the crosslinkable monomer or crosslinkable end-capper is at least one of:

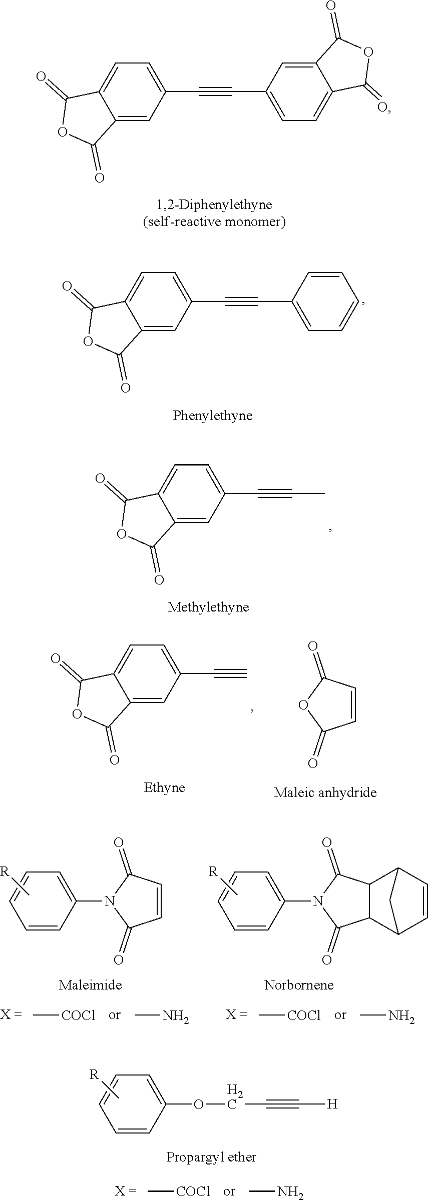

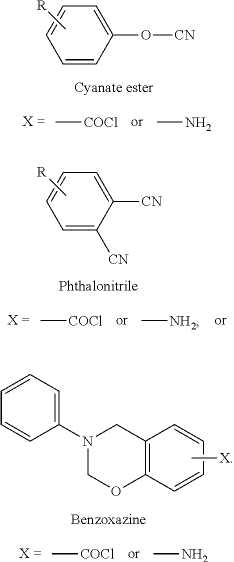

Aspect 15. The reactive polyamideimide oligomer of any of aspects 1 to 14, wherein the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 16. The reactive polyamideimide oligomer of any of aspects 1 to 15, comprising two crosslinkable monomers or crosslinkable end-cappers that are reactive at different temperature ranges.

Aspect 17. The reactive polyamideimide oligomer of any of aspects 1 to 16, further comprising units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof.

Aspect 18. The reactive polyamideimide oligomer of aspect 17, wherein the non-crosslinkable end-capper is at least one of benzoic acid, benzoyl chloride, phthalic anhydride, or aniline.

Aspect 19. The reactive polyamideimide oligomer of any of aspects 1 to 18, further comprising units derived from at least one of an aromatic triamine, an aromatic tricarboxylic acid, or an aromatic tricarboxylic acid chloride.

Aspect 20. The reactive polyamideimide oligomer of any of aspects 1 to 19, wherein the reactive polyamide oligomer has a melt complex viscosity of about 1,000 to about 100,000 Pa·s at 360° C., measured by oscillatory shear rheology between parallel plates at a heating rate of 10° C./minute under N₂, a frequency of 2 radians/second, and a strain of 0.03% to 1.0%.

Aspect 21. A reactive polyamideimide oligomer comprising units derived from: an aromatic diamine selected from at least one of:

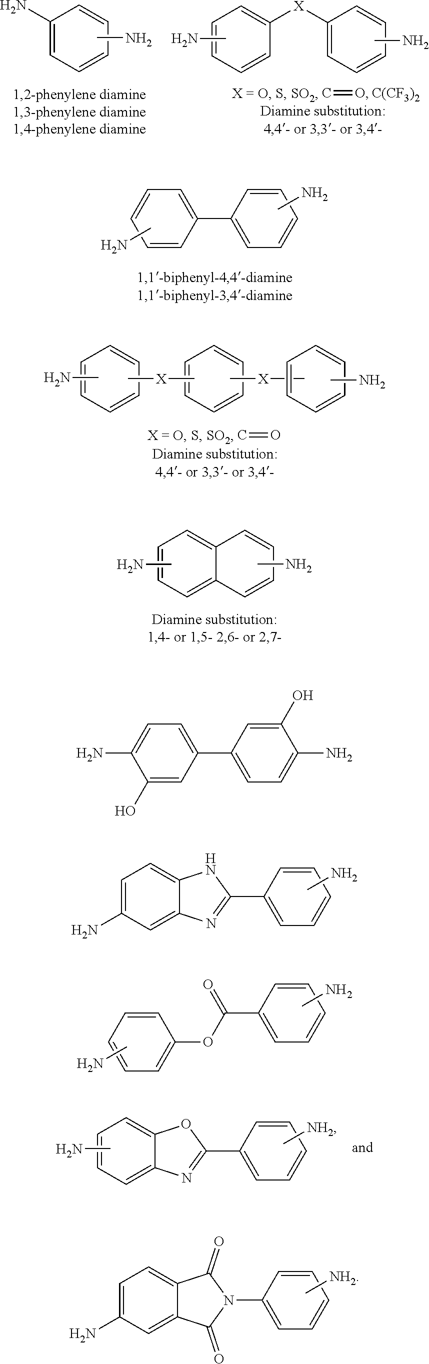

a di-, tri-, or tetra-functional aromatic carboxylic acid or functional equivalent thereof selected from at least one of:

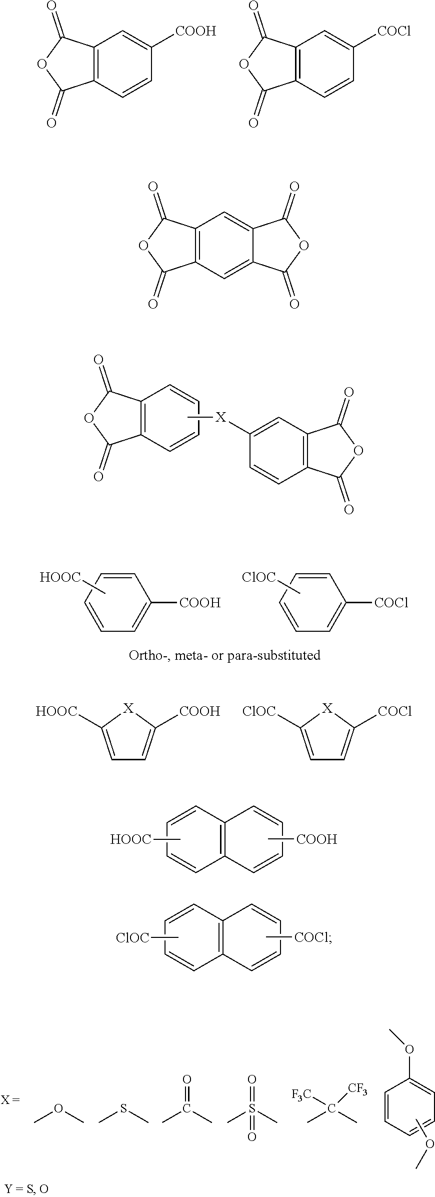

and a crosslinkable monomer or crosslinkable end-capper selected from at least one of

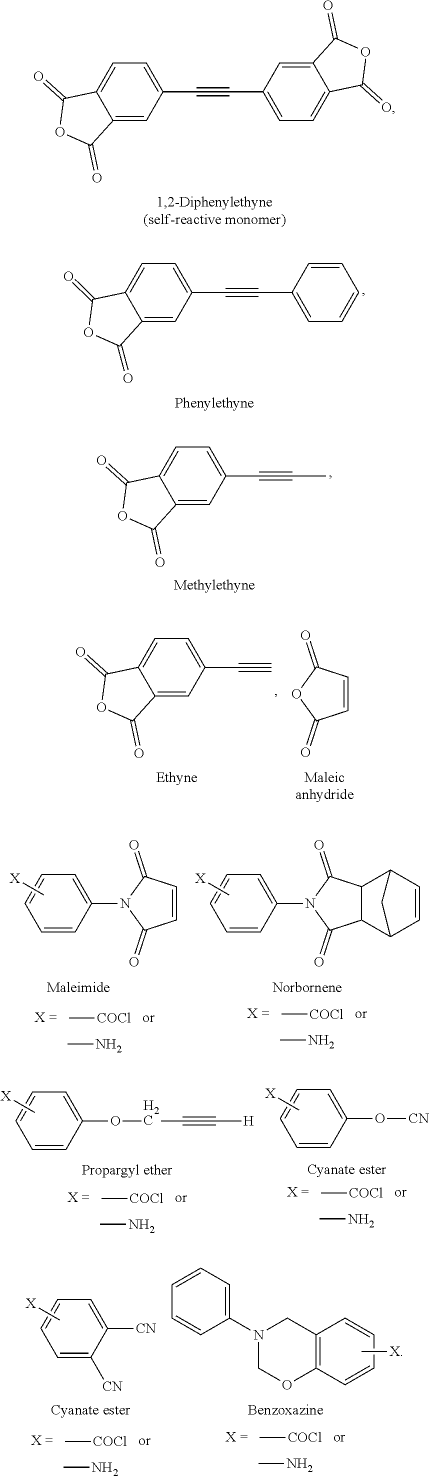

Aspect 22. A reactive polyamideimide oligomer comprising units derived from: an aromatic diamine selected from at least one of 1,3-phenylene diamine, 4,4′-oxydianiline, or 3,4′-oxydianiline; a di-, tri-, or tetra-functional aromatic carboxylic acid or functional equivalent thereof selected from at least one of trimellitic anhydride, 4-chloroformylphthalic anhydride, isophthalic anhydride, isophthaloyl chloride, pyromellitic dianhydride, or biphenyl tetracarboxylic acid dianhydride; and a crosslinkable monomer or crosslinkable end-capper selected from at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 23. A method of manufacture of the reactive polyamideimide oligomer of any of aspects 1 to 22, the method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form a reactive polyamide amic acid oligomer; and heating the reactive polyamide amic acid oligomer at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

Aspect 24. The method of manufacture of aspect 23, wherein the sufficient temperature and time to make the reactive polyamideimide oligomer are about 140° C. to about 220° C. for about 1 minute to about 120 minutes.

Aspect 25. The method of manufacture of aspect 23 or 24, wherein the polar solvent is at least one of N-methyl-2-pyrrolidone, N,N-dimethylacetamide, N,N-dimethylformamide, 1,2-dichlorobenzene, 1,2,4-trichlorobenzene, or sulfolane.

Aspect 26. The method of manufacture of any of aspects 23 to 25, further comprising removing the polar solvent from the polyamide amic acid oligomer prior to heating the reactive polyamide amic acid oligomer at a sufficient temperature and time to make the reactive polyamideimide oligomer.

Aspect 27. The method of manufacture of aspect 26, wherein the sufficient temperature and time to make the reactive polyamideimide oligomer are about 220° C. to about 300° C. for about 1 minute to about 120 minutes.

Aspect 28. The method of manufacture of aspect any of aspects 23 to 27, wherein the method further comprises adding toluene to the reactive polyamide amic acid oligomer and azeotropic distillation of toluene and water.

Aspect 29. The method of manufacture of any of aspects 23 to 27, wherein the method further comprising heating the reactive polyamide amic acid oligomer in the presence of acetic anhydride and a catalytic amount of a tertiary amine.

Aspect 30. The method of manufacture of any of aspects 23 to 27, wherein the method further comprises microwave irradiation of the reactive polyamide amic acid oligomer.

Aspect 31. The method of manufacture of any of aspects 23 to 30, wherein the copolymerizing is conducted in the presence of a phosphorylation agent and a catalytic amount of a salt.

Aspect 32. A method of manufacture of the reactive polyamideimide oligomer of any of aspects 1 to 22, the method comprising: heating at least one aromatic diamine, at least one aromatic di-, tri-, or tetra-functional carboxylic acid or functional equivalent thereof, and at least one crosslinkable monomer or crosslinkable end-capper in the presence of at least one of water or a C₁₋₄ alcohol at a sufficient temperature and time to form at least one reactive ammonium carboxylate salt; optionally removing excess water and C₁₋₄ alcohol; and heating the reactive ammonium carboxylate salt at a sufficient temperature and time to form the reactive polyamideimide oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

Aspect 33. The method of aspect 32, the method comprising reactive extrusion of the reactive ammonium carboxylate salt at a sufficient temperature and time to form the reactive polyamideimide oligomer.

Aspect 34. The method of aspect 32, the method comprising dissolving the reactive ammonium carboxylate salt in a polar solvent prior to heating at a sufficient temperature, pressure, and time to form the reactive polyamideimide oligomer.

Aspect 35. A method of manufacture of the reactive polyamideimide oligomer of any of aspects 1 to 22, the method comprising reactive extrusion of at least one aromatic diamine or activated derivative thereof, at least one aromatic di-, tri-, or tetra-functional carboxylic acid or functional equivalent thereof, and at least one crosslinkable monomer or crosslinkable end-capper at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

Aspect 36. The method of manufacture of aspect 35, wherein the wherein the reactive extrusion is conducted in the presence of a polar solvent, and the polar solvent is removed by distillation during the reactive extrusion.

Aspect 37. The method of manufacture of aspect 35 or 36, wherein the reactive extrusion is conducted in the presence of an acid catalyst.

Aspect 38. The method of manufacture of aspect 37, wherein the acid catalyst is acetic acid, and the acetic acid is removed by distillation during the reactive extrusion.

Aspect 39. The method of manufacture of any of aspects 35 to 38, wherein the reactive extrusion is conducted in the presence of acetic anhydride, and the acetic anhydride is removed by distillation during the reactive extrusion.

Aspect 40. The method of manufacture of any of aspects 35 to 39, wherein the reactive extrusion is conducted in a melt extruder having a plurality of pre-set heating zones equipped with vent ports.

Aspect 41. A blend composition comprising the reactive polyamideimide oligomer of any of aspects 1 to 22 and a thermoplastic polymer.

Aspect 42. A powder coating composition comprising the reactive polyamideimide oligomer of any of aspects 1 to 22.

Aspect 43. A reactive adhesive composition comprising the reactive polyamideimide oligomer of any of aspects 1 to 22.

Aspect 44. A high temperature elastomer composition made by heating the reactive polyamideimide oligomer of any of aspects 1 to 22 at a temperature and time sufficient to crosslink the reactive polyamideimide oligomer.

Aspect 45. A high temperature foam comprising the reactive polyamideimide oligomer of any of aspects 1 to 22.

Aspect 46. A method of compounding the reactive polyamideimide oligomer of any of aspects 1 to 22, comprising mixing the reactive polyamideimide oligomer with at least one other material at a sufficient temperature and time to melt, but not crosslink, the reactive polyamideimide oligomer.

Aspect 47. A method of manufacture of an article, the method comprising heating the reactive polyamideimide oligomer of any of aspects 1 to 22 at a sufficient temperature and time to shape and crosslink the reactive polyamideimide oligomer.

Aspect 48. The method of manufacture of aspect 47, wherein the sufficient temperature and time is about 300 to about 450° C. for about 1 to about 60 minutes.

Aspect 49. The method of manufacture of aspect 47 or 48, wherein the method is additive manufacturing, fiber reinforced composite manufacturing, pultrusion, fiber spinning, compression molding, injection molding, reaction injection molding, blow molding, rotational molding, transfer molding, foam molding, thermoforming, casting, solution casting, or forging.

Aspect 50. An article manufactured by the method of any of aspects 47 to 49.

Aspect 51. An article comprising the reactive polyamideimide oligomer of any of aspects 1 to 22.

Aspect 52. The article of aspect 51, wherein the reactive polyamideimide oligomer is crosslinked.

Aspect 53. The method of manufacture of any of aspects 47 to 49, wherein the method is fiber reinforced composite manufacturing.

Aspect 54. The method of aspect 53, the method comprising heating at least one layer of fiber fabric and at least one layer of the reactive polyamideimide oligomer as a powder or film at a sufficient temperature, pressure, and time to melt the reactive polyamideimide oligomer, impregnate the fiber fabric, and crosslink the reactive polyamideimide oligomer to form a fiber reinforced composite.

Aspect 55. The method of aspect 53, the method comprising: impregnating at least one layer of fiber fabric with a solution of the reactive polyamideimide oligomer dissolved in a polar solvent; removing the polar solvent under reduced pressure; and heating at a sufficient temperature, pressure, and time to crosslink the reactive polyamideimide oligomer and form a fiber reinforced composite.

Aspect 56. A fiber reinforced composite manufactured by the method of any of aspects 53 to 55.

Aspect 57. A fiber reinforced composition comprising the reactive polyamideimide oligomer of any of aspects 1 to 22.

Aspect 58. The fiber reinforced composition of aspect 57, wherein the reactive polyamideimide oligomer is crosslinked.

Aspect 59. The fiber reinforced composite of aspect 57, wherein the composite is a multi-ply carbon reinforced composite.

Aspect 60. The method of manufacture of any of aspects 47 to 49, wherein the method is pultrusion for making a unidirectional tape.

Aspect 61. A unidirectional tape prepared by the method of aspect 60.

Aspect 62. A unidirectional tape comprising the reactive polyamideimide oligomer of any of aspects 1 to 22.

Aspect 63. The unidirectional tape of aspect 62, wherein the reactive polyamideimide oligomer is crosslinked.

Aspect 64. The method of manufacture of any of aspects 47 to 49, wherein the method is solution spinning or melt spinning of fibers.

Aspect 65. A fiber manufactured by the method of aspect 64.

Aspect 66. A fiber comprising the reactive polyamideimide oligomer of any of aspects 1 to 22.

Aspect 67. The fiber of aspect 66, wherein the reactive polyamideimide oligomer is crosslinked.

Aspect 68. The method of manufacture of any of aspects 47 to 49, wherein the method is additive manufacturing.

Aspect 69. The method of manufacture of aspect 68, wherein the method is fused filament fabrication, the method comprising extruding the reactive polyamideimide oligomer in adjacent horizontal layers such that there is an interface between each layer of polyamideimide oligomer, and exposing the layers to heat at a sufficient temperature and time to crosslink the reactive polyamideimide oligomer and form the article.

Aspect 70. The method of manufacture of aspect 68, wherein the method is selective laser sintering, the method comprising selectively sintering and crosslinking particles of the reactive polyamideimide oligomer with a laser to form the article.

Aspect 71. The method of manufacture of aspect 68, wherein the method is directed energy deposition (DED) or laser engineered net shaping (LENS).

Aspect 72. An article manufactured by the method of any of aspects 68 to 71.

Aspect 73. An additive manufactured article comprising the reactive polyamideimide oligomer of any of aspects 1 to 22.

Aspect 74. The additive manufactured article of aspect 73, wherein the reactive polyamideimide oligomer is crosslinked.

Aspect 75. The method of manufacture of any of aspects 47 to 49, wherein the method is solution casting and comprises: casting a solution of the reactive polyamideimide oligomer dissolved in a polar solvent onto a mold; removing the polar solvent to form a reactive polyamideimide oligomer film; and heating the polyamideimide oligomer film at a sufficient temperature and time to crosslink the polyamideimide oligomer and form a flexible film.

Aspect 76. A flexible film manufactured by the solution casting method of aspect 75.

Aspect 77. A flexible film comprising the reactive polyamideimide oligomer of any of aspects 1 to 22.

Aspect 78. The flexible film of aspect 77, wherein the reactive polyamideimide oligomer is crosslinked.

Aspect 79. The flexible film of any of aspects 76 to 78, wherein the flexible film exhibits at least one of: a glass transition temperature (T_{g}) of about 280 to about 310° C., measured by Differential Scanning Calorimetry under N₂ at a heating rate of 10° C./min; a storage modulus (E′) of about 2.2 to about 3.4 GPa, measured by Dynamic Mechanical Thermal Analysis under N₂ at a heating rate of 10° C./min and an oscillation rate of 1 Hz; a Young's modulus of about 3.0 to about 3.8 GPa, a strength at break of about 130 to about 160 MPa, or a strain at break of about 10 to 80%, all measured at 25° C.

Aspect 80. The method of manufacture of any of aspects 47 to 49, wherein the method is injection molding.

Aspect 81. An injection molded article manufactured by the method of aspect 80.

Aspect 82. An injection molded article comprising the reactive polyamideimide oligomer of any of aspects of 1 to 22.

Aspect 83. The injection molded article of aspect 82, wherein the reactive polyamideimide oligomer is crosslinked.

Aspect 84. A reactive polyamide amic acid oligomer comprising units derived from at least one aromatic diamine, at least one aromatic di-, tri-, or tetra-functional carboxylic acid or functional equivalent thereof, and at least one crosslinkable monomer or crosslinkable end-capper, wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer; and wherein the reactive polyamide amic acid oligomer has a number average molecular weight (Mn) of about 1,000 to about 10,000 g/mol, calculated using the Carothers equation.

Aspect 85. The reactive polyamide amic acid oligomer of aspect 84, wherein 0% to 20% of amic acid groups are imidized.

Aspect 86. The reactive polyamide amic acid oligomer of aspect 84 or 85, wherein the crosslinkable monomer or crosslinkable end-capper has one unreacted functional group capable of thermal chain extension and crosslinking after formation of the reactive polyamideimide oligomer.

Aspect 87. The reactive polyamide amic acid oligomer of any of aspects 84 to 86, wherein the at least one crosslinkable monomer or crosslinkable end-capper is at least one crosslinkable end-capper.

Aspect 88. The reactive polyamide amic acid oligomer of any of aspects 84 to 87, wherein the at least one aromatic diamine is two aromatic diamines.

Aspect 89. The reactive polyamide amic acid oligomer of any of aspects 84 to 88, wherein the at least one aromatic di-, tri-, or tetra-functional carboxylic acid or functional equivalent thereof is two aromatic di-, tri-, or tetra-functional carboxylic acids or functional equivalents thereof.

Aspect 90. The reactive polyamide amic acid oligomer of any of aspects 84 to 89, prepared by a process comprising simultaneous step-growth polymerization of the at least one aromatic diamine, the at least one aromatic di-, tri-, or tetra-functional carboxylic acid or functional equivalent thereof, and the at least one crosslinkable monomer or crosslinkable end-capper.

Aspect 91. The reactive polyamide amic acid oligomer of any of aspects 84 to 90, wherein the aromatic diamine is at least one of:

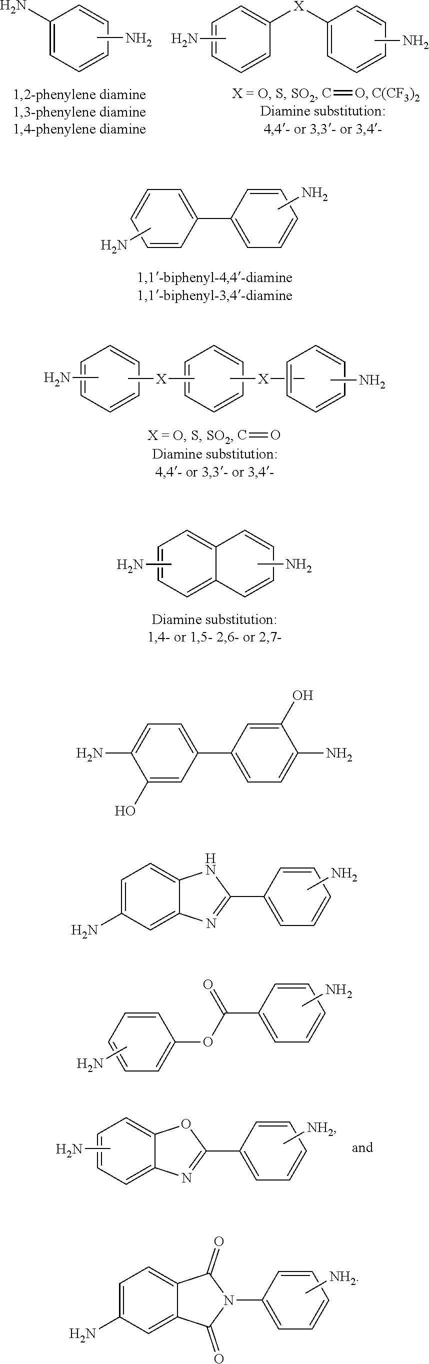

Aspect 92. The reactive polyamide amic acid oligomer of any of aspects 84 to 91, wherein the aromatic diamine is at least one of 1,3-phenylene diamine, 4,4′-oxydianiline, or 3,4′-oxydianiline.

Aspect 93. The reactive polyamide amic acid oligomer of any of aspects 84 to 92, wherein the di-, tri-, or tetra-functional aromatic carboxylic acid or functional equivalent thereof is at least one of:

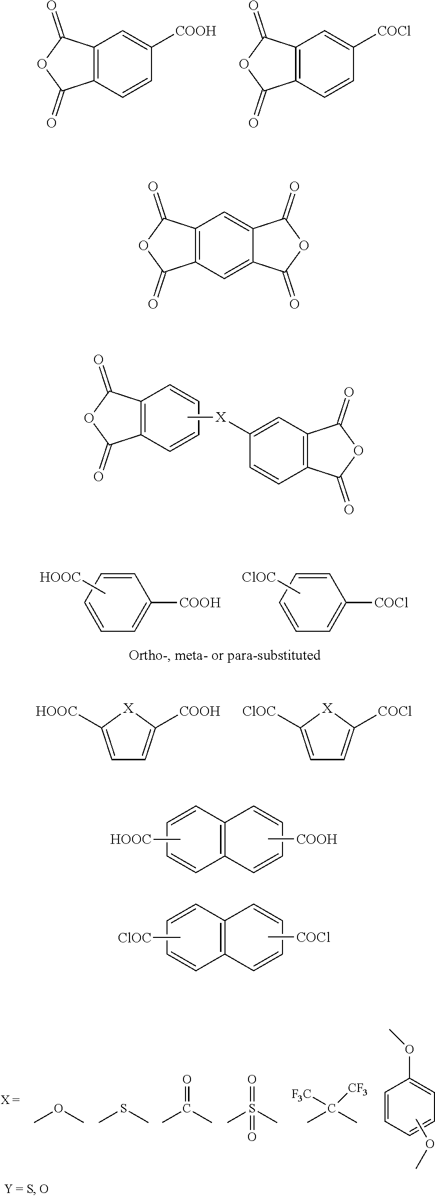

Aspect 94. The reactive polyamide amic acid oligomer of any of aspects 84 to 93, where the di-, tri-, or tetra-functional aromatic carboxylic acid or functional equivalent thereof is at least one of trimellitic anhydride, 4-chloroformylphthalic anhydride, isophthalic anhydride, isophthaloyl chloride, pyromellitic dianhydride, or biphenyl tetracarboxylic acid dianhydride.

Aspect 95. The reactive polyamide amic acid oligomer of any of aspects 84 to 94, wherein the at least one unreacted functional group is at least one of ethyne, methylethyne, phenylethyne, ketoethyne, propargyl ether, norbornene, maleimide, cyanate ester, phthalonitrile, benzocyclobutene, biphenylene, or benzoxazine.

Aspect 96. The reactive polyamide amic acid oligomer of any of aspects 84 to 95, wherein the crosslinkable monomer or crosslinkable end-capper is at least one of:

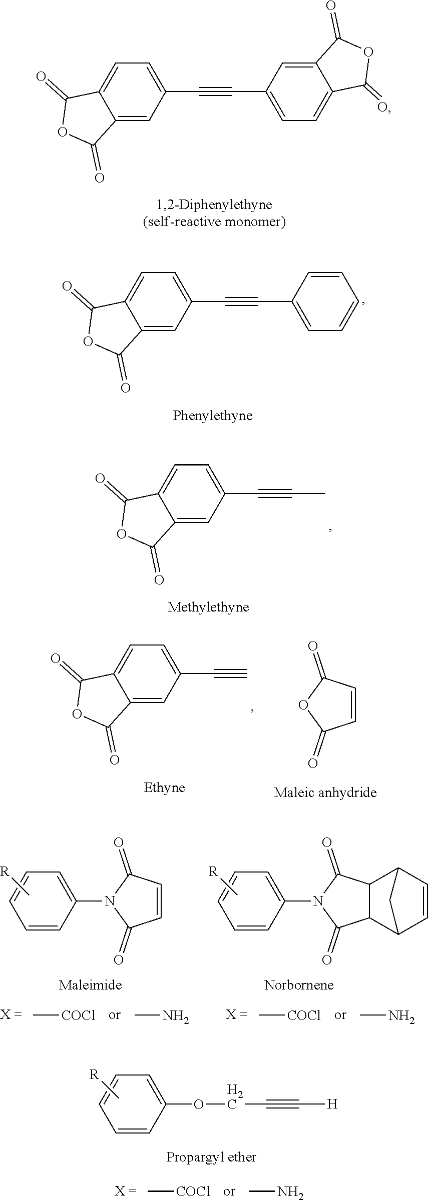

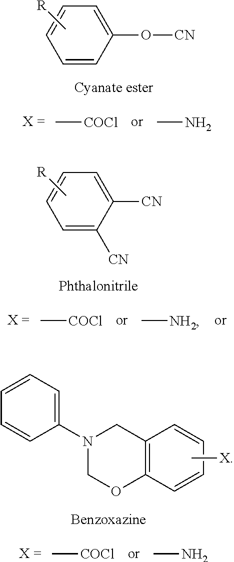

Aspect 97. The reactive polyamide amic acid oligomer of any of aspects 84 to 96, wherein the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 98. The reactive polyamide amic acid oligomer of any of aspects 84 to 97, comprising two crosslinkable monomers or crosslinkable end-cappers that are reactive at different temperature ranges.

Aspect 99. The reactive polyamide amic acid oligomer of any of aspects 84 to 98, further comprising units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof.

Aspect 100. The reactive polyamide amic acid oligomer of aspect 99, wherein the non-crosslinkable end-capper is at least one of benzoic acid, benzoyl chloride, phthalic anhydride, or aniline.

Aspect 101. A reactive polyamide amic acid oligomer comprising units derived from: an aromatic diamine selected from at least one of:

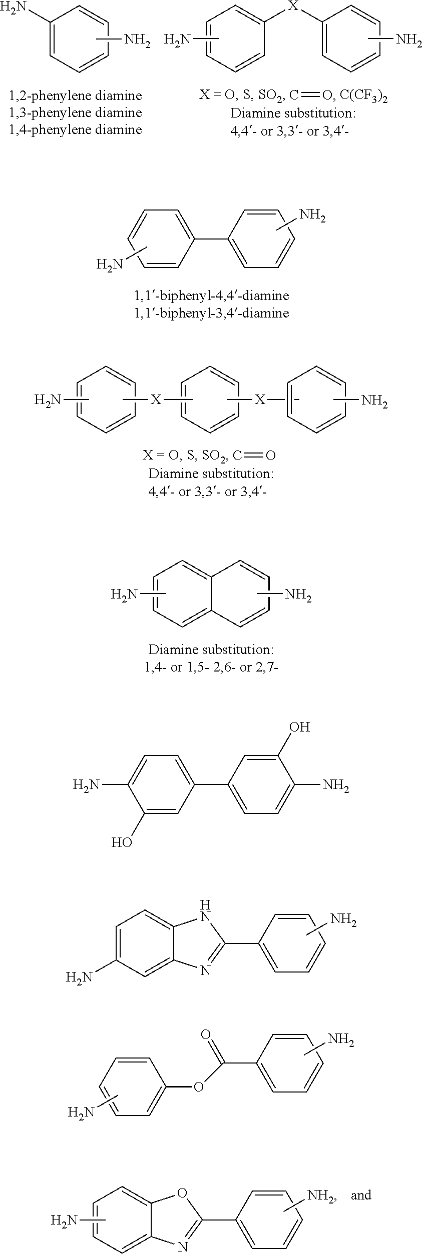

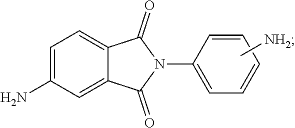

a di-, tri-, or tetra-functional aromatic carboxylic acid or functional equivalent thereof selected from at least one of:

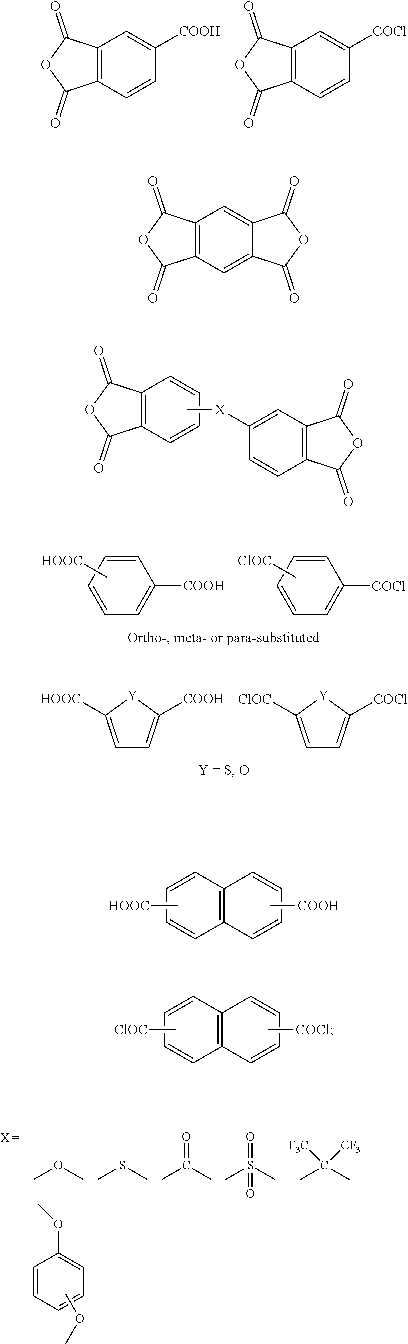

and a crosslinkable monomer or crosslinkable end-capper selected from at least one of.

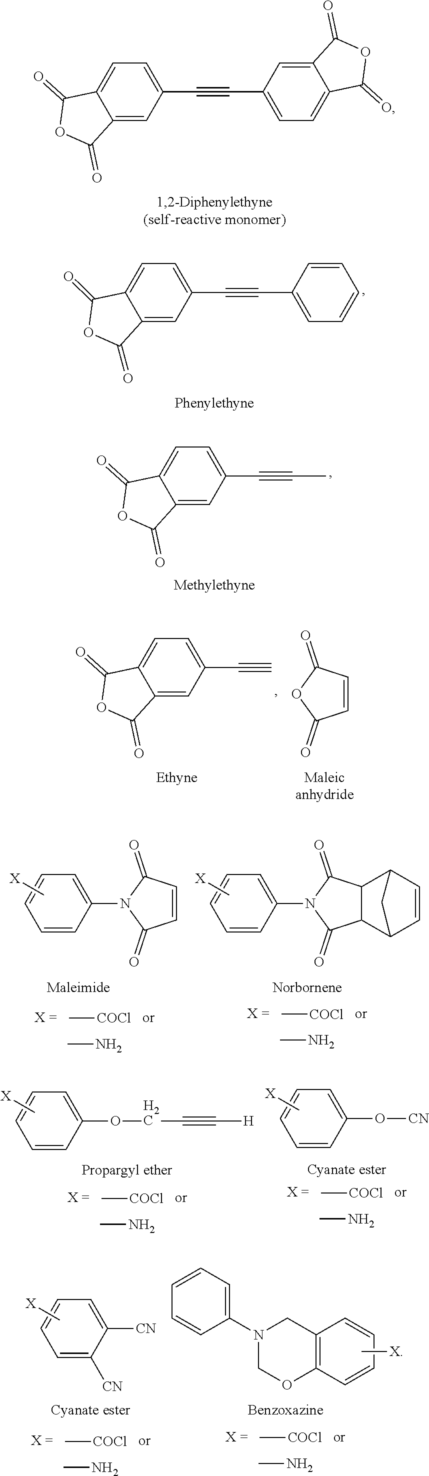

Aspect 102. A reactive polyamide amic acid oligomer comprising units derived from: an aromatic diamine selected from at least one of 1,3-phenylene diamine, 4,4′-oxydianiline, or 3,4′-oxydianiline; a di-, tri-, or tetra-functional aromatic carboxylic acid or functional equivalent thereof selected from at least one of trimellitic anhydride, 4-chloroformylphthalic anhydride, isophthalic anhydride, isophthaloyl chloride, pyromellitic dianhydride, or biphenyl tetracarboxylic acid dianhydride; and a crosslinkable monomer or crosslinkable end-capper selected from at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 103. A method of manufacture of the reactive polyamide amic acid oligomer of any of aspects 84 to 102, the method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form the reactive polyamide amic acid oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer.

Aspect 104. The method of manufacture of aspect 103, wherein the polar solvent is at least one of N-methyl-2-pyrrolidone, N,N-dimethylacetamide, N,N-dimethylformamide, 1,2-dichlorobenzene, 1,2,4-trichlorobenzene, or sulfolane.

Aspect 105. The method of manufacture of aspect 103 or 104, further comprising isolating the reactive polyamide amic acid oligomer from the polar solvent.

Aspect 106. A blend composition comprising the reactive polyamide amic acid oligomer of any of aspects 84 to 102 and a thermoplastic polymer.

Aspect 107. A powder coating composition comprising the reactive polyamide amic acid oligomer of any of aspects 84 to 102.

Aspect 108. A reactive adhesive composition comprising the reactive polyamide amic acid oligomer of any of aspects 84 to 102.

Aspect 109. A high temperature foam comprising the reactive polyamide amic acid oligomer of any of aspects 84 to 102.

Aspect 110. A method of compounding the reactive polyamide amic acid oligomer of any of aspects 84 to 102, comprising mixing the reactive polyamide amic acid oligomer with at least one other material at a sufficient temperature and time imidize, but not crosslink, the reactive polyamide amic acid oligomer.

Aspect 111. A method of manufacture of an article, the method comprising heating the reactive polyamide amic acid oligomer of any of aspects 84 to 102 at a sufficient temperature and time to imidize, shape, and crosslink the reactive polyamide amic acid oligomer.

Aspect 112. The method of manufacture of aspect 111, wherein the sufficient temperature and time is about 300 to about 400° C. for about 10 to about 60 minutes.

Aspect 113. The method of manufacture of aspect 110 or 111, wherein the method is additive manufacturing, fiber reinforced composite manufacturing, pultrusion, fiber spinning, compression molding, injection molding, reaction injection molding, blow molding, rotational molding, transfer molding, foam molding, thermoforming, casting, solution casting, or forging.

Aspect 114. An article manufactured by a method of any of aspects 111 to 113.

Aspect 115. An article comprising the reactive polyamide amic acid oligomer of any of aspects 84 to 102.

Aspect 116. The method of manufacture of any of aspects 111 to 113, wherein the method is fiber reinforced composite manufacturing.

Aspect 117. The method of aspect 116, the method comprising heating at least one layer of fiber fabric and at least one layer of the reactive polyamide amic acid oligomer as a powder or film at a sufficient temperature, pressure, and time for the reactive polyamide amic acid oligomer to imidize, impregnate the fiber fabric, and crosslink to form a fiber reinforced composite.

Aspect 118. The method of aspect 116, the method comprising: impregnating at least one layer of fiber fabric with a solution of the reactive polyamide amic acid oligomer dissolved in a polar solvent; removing the polar solvent under reduced pressure, and heating at a sufficient temperature, pressure, and time to imidize and crosslink the reactive polyamide amic acid oligomer to form a fiber reinforced composite.

Aspect 119. A fiber reinforced composite manufactured by the method of any of aspects 116 to 118.

Aspect 120. A fiber reinforced composite comprising the reactive polyamide amic acid oligomer of any of aspects 84 to 102.

Aspect 121. The fiber reinforced composite of aspect 120, wherein the composite is a multi-ply carbon reinforced composite.

Aspect 122. The method of manufacture of any of aspects 111 to 113, wherein the method is pultrusion for making a unidirectional tape.

Aspect 123. A unidirectional tape prepared by the method of aspect 122.

Aspect 124. A unidirectional tape comprising the reactive polyamide amic acid oligomer of any of aspects 84 to 102.

Aspect 125. The method of manufacture of any of aspects 111 to 113, wherein the method is solution spinning or melt spinning of fibers.

Aspect 126. A fiber manufactured by the method of aspect 125.

Aspect 127. A fiber comprising the reactive polyamide amic acid oligomer of any of aspects 84 to 102.

Aspect 128. The method of manufacture of any of aspects 111 to 113, wherein the method is additive manufacturing.

Aspect 129. The method of manufacture of aspect 128, wherein the method is fused filament fabrication, the method comprising extruding the reactive polyamide amic acid oligomer in adjacent horizontal layers such that there is an interface between each layer of reactive polyamide amic acid oligomer, and exposing the layers to heat at a sufficient temperature and time to imidize and crosslink the reactive polyamide amic acid oligomer and form the article.

Aspect 130. The method of manufacture of aspect 128, wherein the method is selective laser sintering, the method comprising selectively sintering, imidizing, and crosslinking particles of the reactive polyamide amic acid oligomer with a laser to form the article.

Aspect 131. The method of manufacture of aspect 128, wherein the method is directed energy deposition (DED) or laser engineered net shaping (LENS).

Aspect 132. An article manufactured by the method of any of aspects 128 to 131.

Aspect 133. An additive manufactured article comprising the reactive polyamide amic acid oligomer of any of aspects 84 to 102.

Aspect 134. The method of manufacture of any of aspects 111 to 113, wherein the method is solution casting and comprises: casting a solution of the reactive polyamide amic acid oligomer dissolved in a polar solvent onto a mold; removing the solvent to form a reactive polyamide amic acid oligomer film; and heating the reactive polyamide amic acid oligomer film at a sufficient temperature and time to imidize and crosslink the reactive polyamide amic acid oligomer and form a flexible film.

Aspect 135. A flexible film manufactured by the solution casting method of aspect 134.

Aspect 136. A flexible film comprising the reactive polyamide amic acid oligomer of any of aspects 84 to 102.

Aspect 137. The method of manufacture of any of aspects 111 to 113, wherein the method is injection molding.

Aspect 138. An injection molded article manufactured by the method of aspect 137.

Aspect 139. An injection molded article comprising the reactive polyamide amic acid oligomer of any of aspects of 84 to 102.

Aspect 140. The method of manufacture of any of aspects 111 to 113, wherein the method is blow molding.

Aspect 141. A reactive ammonium carboxylate salt formed by a method comprising: heating at least one aromatic diamine, at least one aromatic di-, tri-, or tetra-functional carboxylic acid or functional equivalent thereof, and at least one crosslinkable monomer or crosslinkable end-capper in the presence of a C₁₋₄ alcohol at a sufficient temperature and time to form the reactive ammonium carboxylate salt; and removing excess C₁₋₄ alcohol; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive ammonium carboxylate salt.

Aspect 142. The reactive ammonium carboxylate salt of aspect 141, wherein the crosslinkable monomer or crosslinkable end-capper has one unreacted functional group capable of thermal chain extension and crosslinking after formation of the reactive ammonium carboxylate salt.

Aspect 143. The reactive ammonium carboxylate salt of aspect 141 or 142, wherein the at least one crosslinkable monomer or crosslinkable end-capper is at least one crosslinkable end-capper.

Aspect 144. The reactive ammonium carboxylate salt of any of aspects 141 to 143, wherein the at least one aromatic diamine is two aromatic diamines.

Aspect 145. The reactive ammonium carboxylate salt of any of aspects 141 to 144, wherein the at least one aromatic di-, tri-, or tetra-functional carboxylic acid or functional equivalent thereof is two aromatic di-, tri-, or tetra-functional carboxylic acids or functional equivalents thereof.

Aspect 146. The reactive ammonium carboxylate salt of any of aspects 141 to 145, wherein the aromatic diamine is at least one of

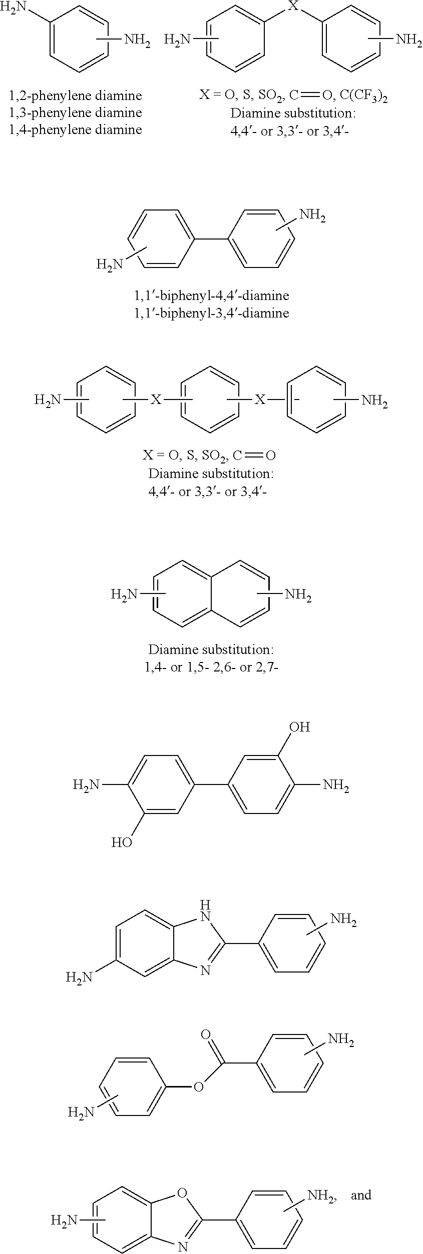

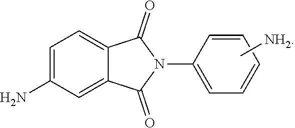

Aspect 147. The reactive ammonium carboxylate salt of any of aspects 141 to 146, wherein the aromatic diamine is at least one of 1,3-phenylene diamine, 4,4′-oxydianiline, or 3,4′-oxydianiline.

Aspect 148. The reactive ammonium carboxylate salt of any of aspects 141 to 147, wherein the di-, tri-, or tetra-functional aromatic carboxylic acid or functional equivalent thereof is at least one of:

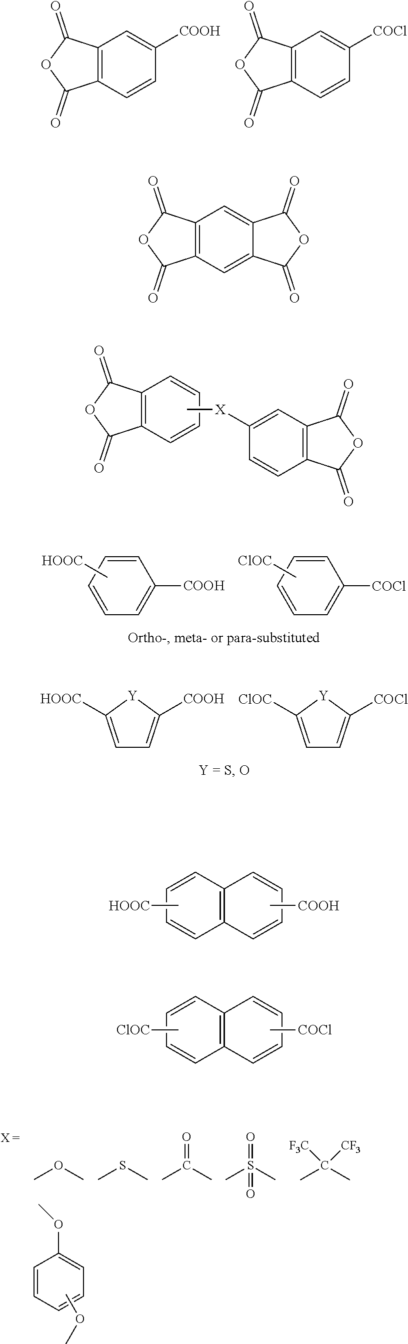

Aspect 149. The reactive ammonium carboxylate salt of any of aspects 141 to 148, wherein the di-, tri-, or tetra-functional aromatic carboxylic acid or functional equivalent thereof is at least one of trimellitic anhydride, isophthalic anhydride, pyromellitic dianhydride, or biphenyl tetracarboxylic acid dianhydride.

Aspect 150. The reactive ammonium carboxylate salt of any of aspects 141 to 149, wherein the unreacted functional group is at least one of ethyne, methylethyne, phenylethyne, ketoethyne, propargyl ether, norbornene, maleimide. cyanate ester, phthalonitrile, benzocyclobutene, biphenylene, or benzoxazine.

Aspect 151. The reactive ammonium carboxylate salt of any of aspects 141 to 150, wherein the crosslinkable monomer or crosslinkable end-capper is at least one of:

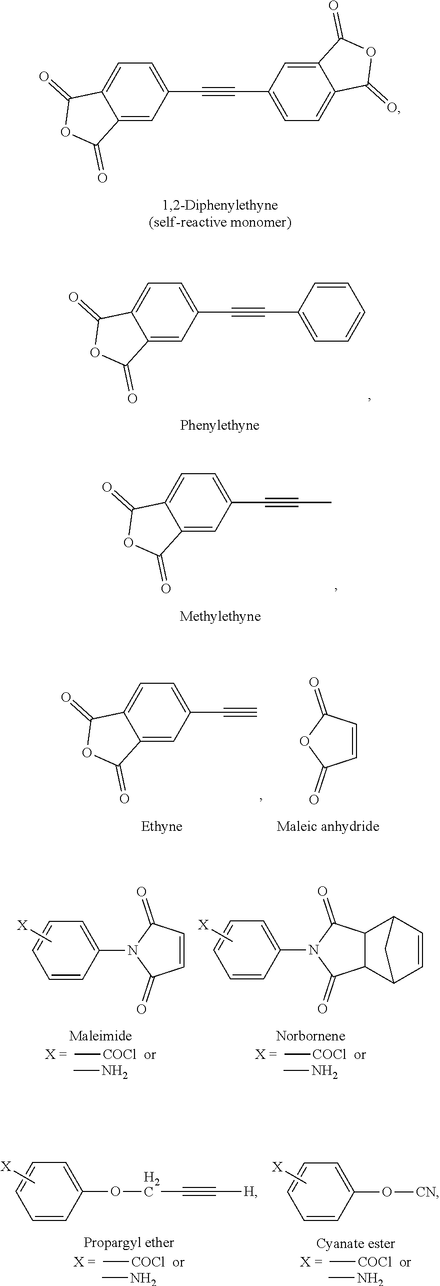

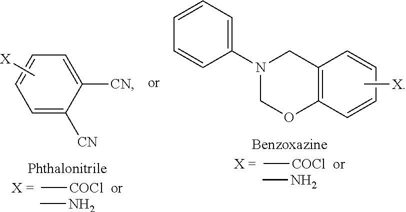

Aspect 152. The reactive ammonium carboxylate salt of any of aspects 141 to 151, wherein the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 153. The reactive ammonium carboxylate salt of any of aspects 141 to 152, comprising two crosslinkable monomers or crosslinkable end-cappers that are reactive at different temperature ranges.

Aspect 154. The reactive ammonium carboxylate salt of any of aspects 141 to 153, further comprising units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof.

Aspect 155. The reactive ammonium carboxylate salt of aspect 154, wherein the non-crosslinkable end-capper is at least one of benzoic acid, benzoyl chloride, phthalic anhydride, or aniline.

Aspect 156. The reactive ammonium carboxylate salt of any of aspects 141 to 155, wherein the reactive ammonium carboxylate salt has a melt complex viscosity of about 1 to about 100 Pa·s between about 80° C. and about 120° C., measured by oscillatory shear rheology between parallel plates at a heating rate of 10° C./minute under N₂, a frequency of 2 radians/second, and a strain of 0.03% to 1.0%.

Aspect 157. A reactive ammonium carboxylate salt comprising units derived from:

an aromatic diamine selected from at least one of:

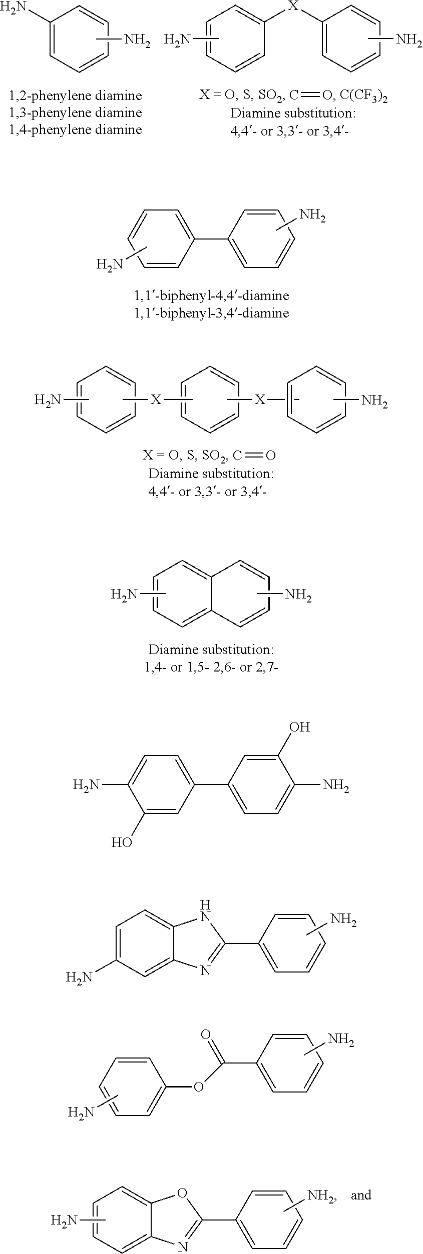

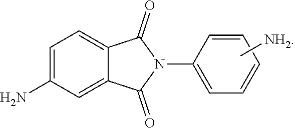

a di-, tri-, or tetra-functional aromatic carboxylic acid or functional equivalent thereof selected from at least one of:

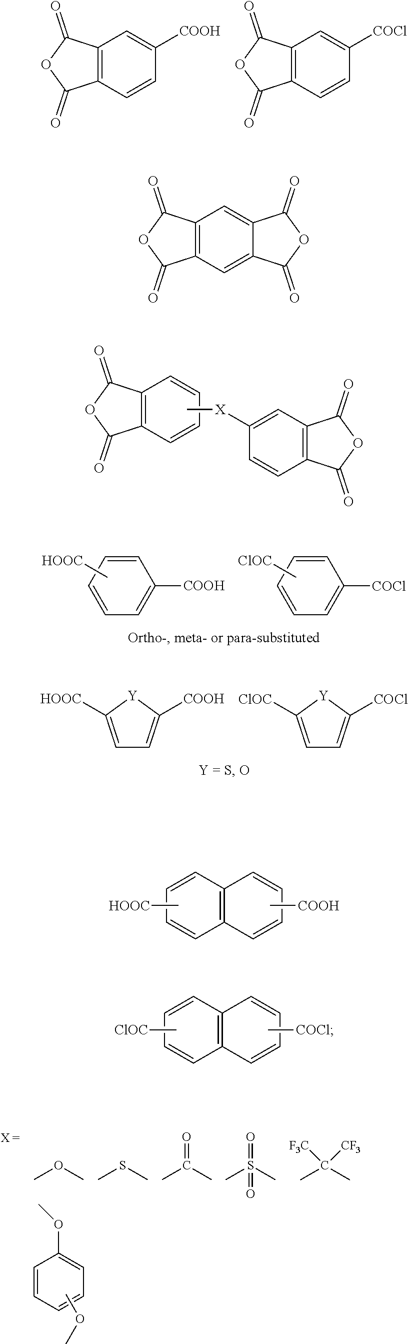

and a crosslinkable monomer or crosslinkable end-capper selected from at least one of

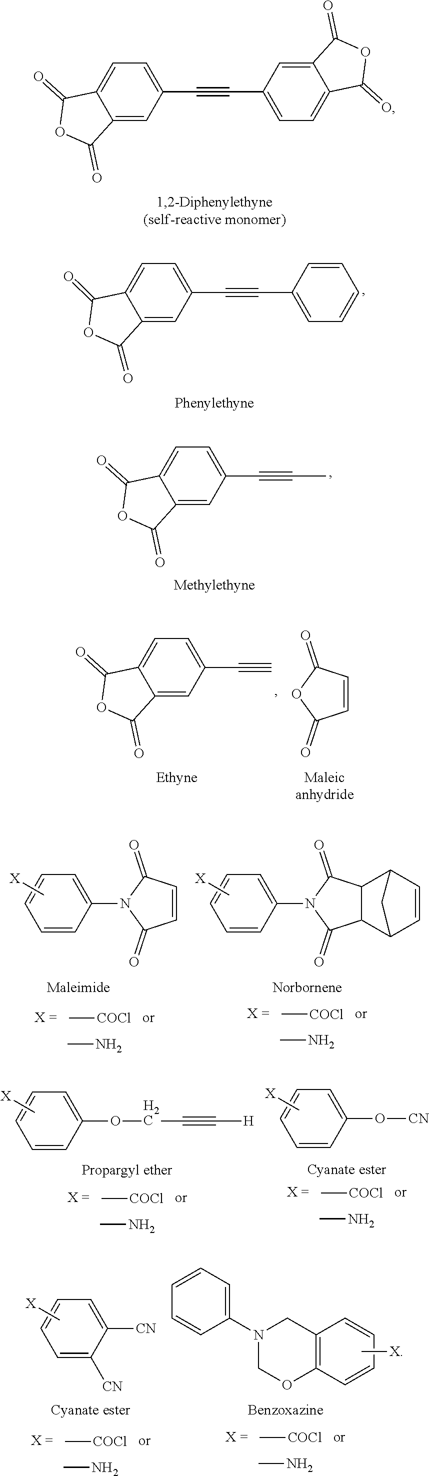

Aspect 158. A reactive ammonium carboxylate salt comprising units derived from: an aromatic diamine selected from at least one of 1,3-phenylene diamine, 4,4-oxydianiline, or 3,4-oxydianiline; a di-, tri-, or tetra-functional aromatic carboxylic acid or functional equivalent thereof selected from at least one of trimellitic anhydride, 4-chloroformylphthalic anhydride, isophthalic anhydride, isophthaloyl chloride, pyromellitic dianhydride, or biphenyl tetracarboxylic acid dianhydride; and a crosslinkable monomer or crosslinkable end-capper selected from at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 159. A method of manufacture of a reactive ammonium carboxylate salt, the method comprising: heating at least one aromatic diamine, at least one aromatic di-, tri-, or tetra-functional carboxylic acid or functional equivalent thereof, and at least one crosslinkable monomer or crosslinkable end-capper in the presence of a C₁₋₄ alcohol at a sufficient temperature and time to form a reactive ammonium carboxylate salt; and removing excess C₁₋₄ alcohol; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive ammonium carboxylate salt.

Aspect 160. A method of compounding the reactive ammonium carboxylate salt of any of aspects 141 to 158, comprising mixing the reactive ammonium carboxylate salt with at least one other material at a sufficient temperature, pressure, and time to make, but not crosslink, a reactive polyamideimide oligomer.

Aspect 161. A method of manufacture of an article, the method comprising heating the reactive ammonium carboxylate salt of any of aspects 141 to 158 at a sufficient temperature, pressure, and time to make, shape, and crosslink a reactive polyamideimide oligomer.

Aspect 162. The method of manufacture of aspect 161, wherein the sufficient temperature, pressure, and time are about 300° C. to about 400° C., 0 to about 300 MPa, and about 10 to about 60 minutes.

Aspect 163. The method of manufacture of aspect 161 or 162, wherein the method is fiber reinforced composite manufacturing, pultrusion, compression molding, injection molding, or solution casting.

Aspect 164. An article manufactured by the method of any of aspects 161 to 163.

Aspect 165. The method of manufacture of any of aspects 161 to 163, wherein the method is fiber reinforced composite manufacturing.

Aspect 166. The method of aspect 165, the method comprising heating at least one layer of fiber fabric and at least one layer of the reactive ammonium carboxylate salt as a powder or film at a sufficient temperature, pressure, and time for the reactive ammonium carboxylate salt to impregnate the fiber fabric, and to make and crosslink a reactive polyamideimide oligomer to form a fiber reinforced composite.

Aspect 167. The method of aspect 165, the method comprising: impregnating at least one layer of fiber fabric with a solution of the reactive ammonium carboxylate salt dissolved in a polar solvent; removing the polar solvent at reduced pressure; and heating at a sufficient temperature, pressure, and time to polymerize and crosslink a reactive polyamideimide oligomer to form a fiber reinforced composite.

Aspect 168. A fiber reinforced composite manufactured by the method of any of aspects 165 to 167.

Aspect 169. The fiber reinforced composite of aspect 168, wherein the composite is a multi-ply carbon reinforced composite.

Aspect 170. The method of manufacture of any of aspects 161 to 163, wherein the method is solution casting and comprises: casting a solution of the reactive ammonium carboxylate salt dissolved in a polar solvent onto a mold; removing the polar solvent to form a reactive ammonium carboxylate salt film; and heating the reactive ammonium carboxylate salt film at a sufficient temperature, pressure, and time to make and crosslink a reactive polyamideimide oligomer to form a flexible film.

Aspect 171. A flexible film manufactured by the solution casting method of aspect 170.

Aspect 172. The method of manufacture of any of aspects 161 to 163, wherein the method is injection molding.

Aspect 173. The method of manufacture of any of aspects 161 to 163, wherein the method is blow molding.

### EXAMPLES

### Materials and Methods

Abbreviations for materials used or mentioned herein are defined in Table 2. For those materials used in the examples, sources are provided. A key for other abbreviations used herein is provided in Table 3.

TABLE 2
Materials

| Short Name | Chemical Name | Source |
|---|---|---|
| 13PD | 1,3-Diaminobenzene | TCI America |
| 4,4′-ODA | 4,4′-Oxydianiline | TCI America |
| DMAc | N,N-Dimethylacetamide | — |
| DMF | N,N-Dimethylformamide | — |
| EBPA | 4,4′-(Ethyne-1,2-diyl) bis(phthalic | Nexam Chemical |
| | anhydride) | |
| EtOH | Ethanol | — |
| GO | Graphene oxide | — |
| HCl | Hydrochloric acid | — |
| IPC | Isophthaloyl chloride | Sigma-Aldrich |
| | | Chemicals |
| MeOH | Methanol | — |
| MEPA | 4-Methylethynylphthalic anhydride | Nexam Chemical |
| NMP | N-methyl-2-pyrrolidone | Across Organics |
| N₂ | Molecular nitrogen | — |
| ODPA | 4,4′-Oxydiphthalic anhydride | TCI America |
| PAAA | Polyamide amic acid | — |
| PAI | Polyamideimide | — |
| PEPA | 4-Phenylethynylphthalic anhydride | Nexam Chemical |
| PMDA | Pyromellitic dianhydride | TCI America |
| Pt | Platinum | — |
| THF | Tetrahydrofuran | — |
| TMA | Trimellitic anhydride | TCI America |
| TMACl | 4-Chloroformylphthalic anhydride | TCI America |
| Tol | Toluene | — |

TABLE 3
Other Abbreviations

| Abbreviation | Full Name |
|---|---|
| atm | Atmosphere(s) |
| CAD | Computer aided design |
| Eq. | Equation |
| FDM | Fused deposition modeling |
| FFF | Fused filament fabrication (fused deposition modeling) |
| Fig. | Figure |
| g | Gram(s) |
| h | Hour(s) |
| GPa | Gigapascal(s) |
| M | Molar |
| Mₙ | Number average molecular weight |
| MPa | Megapascal(s) |
| min | Minute(s) |
| MJ | Megajoule(s) |
| mL | Milliliter(s) |
| mm | Milimeter(s) |
| mol | Mole(s) |
| mmol | Millimole(s) |
| Pa · s | Pascal · second(s) |
| rad | Radian(s) |
| s | Second(s) |
| SLS | Selective laser sintering |
| T_{g} | Glass transition temperature |
| Tₘ | Melting point |
| UD | Unidirectional |
| μm | Micrometer(s) |

Rheology. Melt complex viscosity was measured by oscillatory shear rheology at a heating rate of 10° C./minute under N₂, a frequency of 2 radians/second, and a strain of 0.03% to 1.0%. A 13-millimeter diameter sample is centered between 25-millimeter diameter parallel plates for the measurements.

Thermogravimetric Analysis (TGA). For determining T_{d,5% wt. loss}: TA instruments TGA 5500, Pt pans, 10° C./min, N₂, 10 mg sample.

Differential Scanning Calorimetry (DSC). For determining T_{g}: TA instruments DSC2500, Tzero pan with hermetic lid, 10° C./min, N₂, ˜7 mg sample. In this method, T_{g} is determined from the inflection point.

Dynamic Mechanical Thermal Analysis (DMTA). TA instruments RSA G2 in tension mode, 25° C. to 400° C. at 2° C./min, N₂ atmosphere, sample dimensions=0.030 mm×2 mm×10 mm. In this method, T_{g} is determined from the maximum of the loss modulus peak.

Stress strain measurements. TA instruments RSA G2 (32 N load cell), strain rate of 1 mm/min, sample dimensions=˜0.030 mm×˜2 mm×10 mm. Young's modulus was determined by linear fitting of stress-strain curve in the elastic region; between 0.1 to 0.3% strain.

Gel Permeation Chromatograph (GPC). Shimadzu Prominence ultrafast liquid chromatograph (UFLC) system equipped with a LC20AD pump, SIL-20A HT autosampler, CTO-20A column oven at 60° C., and a RID-20A refractive index detector. For measurements, the column used was a SHODEX™ LF-804. Eluent utilized for measurements was NMP containing 0.05 M LiBr and 0.05 M H₃PO₄ operating at a constant flow rate of 0.5 mL/min. Relative molecular weights were obtained by comparison with SHODEX™ polystyrene standards.

### Example 1

The manufacture of a reactive polyamideimide oligomer is illustrated below in Scheme 5. Molecular weight of the oligomer influences thermal, (thermo-)mechanical, and melt properties of the reactive polyamideimide oligomers. In this example, a phenylethynyl end-capper (PEPA) was used to prepare reactive polyamideimide oligomers with Mₙ values of 5,000 g/mol (Ex. 1B-1E), 3,000 g/mol (Ex. 1F-1G), and 8,000 g/mol (Ex. 1H-1I). The Carothers equation (Eq. 2) was used to calculate monomer amounts needed to prepare reactive polyamideimide oligomers with the desired Mₙ values. Keeping Mₙ constant, when more than one diamine monomer is utilized, the relative molar amounts of the diamine monomers will affect the rigidity of the oligomeric backbone. Thus, the thermal, (thermo-)mechanical, and melt properties of reactive polyamideimide oligomer can be varied by varying the ratio of diamine monomers. In Example 1A, the Mₙ of the reactive polyamideimide oligomer was 5,000 g/mol and the backbone consisted of two diamines, 4,4′-ODA and 1,3-PD in a 0.72:0.28 molar ratio. Changing the molar ratio of the two diamines will result in change in oligomer properties. The molar ratio of 4,4′-ODA to 1,3-PD is 0.72:0.28 in Ex. 1A-1I, 0.62:0.32 in Examples 1J-1K, and 0.813:0.197 in Examples 1L-1M.

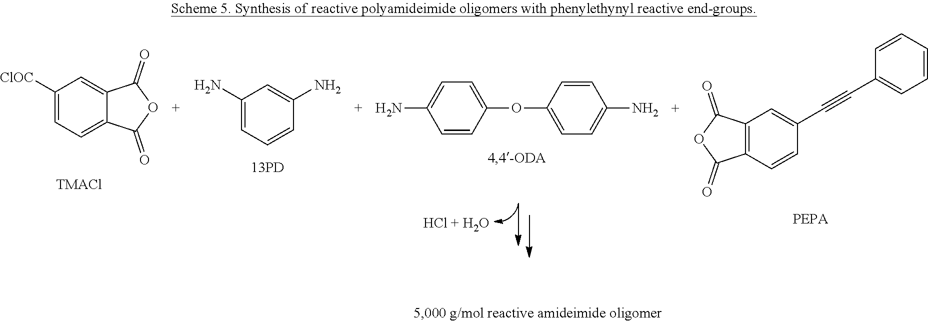

### Example 1A—Reactive Polyamide Amic Acid Oligomer Solution, Mₙ=5,000 g/mol

A 150 mL 2-neck round bottom flask equipped with stir bar and nitrogen inlet tube was charged with 1,3-phenylene diamine (6.38 mmol, 0.69 g), 4,4′-oxydianiline (16.33 mmol, 3.27 g) and 37 g NMP. The mixture was stirred until a homogenous solution was obtained. The solution was cooled to 0° C. Trimellitic anhydride chloride (21.28 mmol, 4.48 g) and 4-(phenylethynyl)phthalic anhydride (2.9 mmol, 0.72 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP.

### Example 1B—Reactive Polyamideimide Oligomer Film, Mₙ=5,000 g/mol

This is an example of preparation of a free-standing reactive polyamideimide oligomer film without curing of the phenylethynyl end-groups. The reactive polyamide amic acid oligomer solution prepared in Example 1A (10 mL) was cast onto a glass plate and dried at 60° C. under vacuum. The temperature was increased stepwise to 100° C. for 1 h, 200° C. for 1 h, and 300° C. for 1 h to dehydrate the reactive polyamide amic acid oligomer and obtain a reactive polyamideimide oligomer having unreacted phenylethynyl end-groups. The film was brittle and difficult to handle, which is a direct consequence of the low molecular weight. The T_{g} was 248° C., measured by Differential Scanning Calorimetry (N₂, 10° C./min).

### Example 1C—Cured Polyamideimide Oligomer Film, Mₙ=5,000 g/mol

This is an example of preparation of a flexible, free-standing film with curing of the phenylethynyl end-groups. The reactive polyamide amic acid oligomer solution as prepared in Example 1A (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained. Thermogravimetric analysis (N₂, 10° C./min) showed a 5% weight loss at 483° C. Differential Scanning Calorimetry (N₂, 10° C./min) shows a T_{g} of 301° C. Dynamic Mechanical Thermal Analysis (N₂, 10° C./min, 1 Hz) shows a storage modulus (E′) of 3.2 GPa at 33° C., 0.81 GPa at 300° C. and a T_{g} of 306.8° C. Stress-strain experiments (25° C.) show that the films exhibit a Young's modulus of 3.4 GPa, strength at break of 134 MPa, and strain at break of 17%. The film properties exceed what is expected for a high molecular weight polymer film.

### Example 1D—Isolated Reactive Polyamideimide Oligomer Powder, Mₙ=5,000 g/mol

An imidized reactive polyamideimide oligomer powder was obtained by precipitation of the reactive polyamide amic acid solution in NMP of Example 1A in MeOH. The polyamide amic acid was precipitated by pouring 50 mL of the polyamide amic acid solution of Example 1A into 200 mL MeOH in a Warring blender, with mixing for 1-3 min. The precipitate was collected by filtration on a Buchner funnel, and washed with an additional 200 mL MeOH. The washed polyamide amic acid powder was dried in the oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer showed a melt complex viscosity of 19,000 Pa·s at 361° C.

### Example 1E—Cured Polyamideimide Oligomer Film, Mₙ=5,000 g/mol

This is another example of preparation of a flexible, free-standing film with curing of the phenylethynyl end-groups. The reactive polyamide amic acid oligomer solution of Example 1A was imidized as follows. Dry toluene was added to the reaction flask. Water formed during cyclodehydration (of amic acid to imide) was removed by azeotropic distillation. After 2 h, the reactive polyamide amic acid oligomer was 98% imidized and the remaining toluene was removed by distillation. A solution (10 mL) of the resulting reactive polyamideimide oligomer in NMP (30 wt. % solids) was cast onto a glass plate and dried at 60° C. under vacuum. After cooling to room temperature, the temperature was stepwise increased to 40° C. for 2 h, 60° C. for 2 h, 100° C., 200° C., 300° C. for 30 min, and 370° C. for 1 h. After cooling the film to 25° C., a flexible and tough film was obtained. Differential Scanning Calorimetry (N₂, 10° C./min) showed a T_{g} of 326° C., which is about 46° C. higher than the T_{g} of a currently available PAI film (280° C.).

### Example 1F, Cured Polyamideimide Oligomer Film, Mₙ=3,000 g/mol

A reactive polyamideimide oligomer having Mₙ=3,000 g/mol was prepared with 4-phenylethynylphthalic anhydride end-cappers. A 150 mL 2-neck round bottom flask equipped with stir bar and nitrogen inlet tube was charged with 1,3-phenylene diamine (22.84 mmol, 2.47 g), 4,4′-oxydianiline (62.07 mmol, 12.43 g) and 82 g NMP. The mixture was stirred until a homogenous solution was obtained. The solution was cooled to 0° C. Trimellitic anhydride chloride (76.08 mmol, 16.02 g) and 4-(phenylethynyl)phthalic anhydride (17.64 mmol, 4.38 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP. The reactive polyamide amic acid oligomer solution (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible film was obtained. Thermogravimetric analysis (N₂, 10° C./min) showed a 5% weight loss at 500° C. Differential Scanning Calorimetry (N₂, 10° C./min) shows a T_{g} of 291° C. Dynamic Mechanical Thermal Analysis (N₂, 10° C./min, 1 Hz) shows a storage modulus (E′) of 1.71 GPa at 35° C., 0.25 GPa at 300° C. and a T_{g} of 292° C. Stress-strain experiments (25° C.) show that the films exhibit a Young's modulus of 3.0 GPa, strength at break of 110 MPa, and strain at break of 16.4%.

### Example 1G—Isolated Reactive Polyamideimide Oligomer Powder, Mₙ=3,000 g/mol

An imidized reactive polyamideimide oligomer powder was obtained by precipitation of the reactive polyamide amic acid solution in NMP of Example 1D in MeOH. The polyamide amic acid was precipitated by pouring 50 mL of the polyamide amic acid solution of Example 1D into 200 mL MeOH in a Warring blender, with mixing for 1-3 min. The precipitate was collected by filtration on a Buchner funnel, and washed with an additional 200 mL MeOH. The washed polyamide amic acid powder was dried in the oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer showed a melt complex viscosity of 5450 Pa·s at 361° C.

### Example 1H—Cured Polyamideimide Oligomer Film, Mₙ=8,000 g/mol

A reactive polyamideimide oligomer having Mₙ=8,000 g/mol was prepared with 4-phenylethynylphthalic anhydride reactive end-groups. A 150 mL 2-neck round bottom flask equipped with stir bar and nitrogen inlet tube was charged with 1,3-phenylene diamine (22.84 mmol, 2.47 g), 4,4′-oxydianiline (56.43 mmol, 11.30 g) and 73 g NMP. The mixture was stirred until a homogenous solution was obtained. The solution was cooled to 0° C. Trimellitic anhydride chloride (76.08 mmol, 16.02 g) and 4-(phenylethynyl)phthalic anhydride (6.04 mmol, 1.5 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP. The reactive polyamide amic acid oligomer solution (10 mL) was cast onto a glass plate and dried at 40° C. for 2 h. and at 60° C. for 2 h. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling to 25° C., a flexible film was obtained. Thermogravimetric analysis (N₂, 10° C./min) showed a 5% weight loss at 490° C. Differential Scanning Calorimetry (N₂, 10° C./min) showed a T_{g} of 287° C. Dynamic Mechanical Thermal Analysis (N₂, 10° C./min, 1 Hz) showed a storage modulus (E′) of 3.0 GPa at 35° C., 0.75 GPa at 300° C. and a T_{g} of 300° C. Stress-strain experiments (25° C.) showed that the films exhibit a Young's modulus of 3.1 GPa, strength at break of 139 MPa, and strain at break of 57.4%.

### Example 1I—Isolated Reactive Polyamideimide Oligomer Powder, Mₙ=8,000 g/mol

An imidized, reactive polyamideimide oligomeric powder was obtained by precipitation of the reactive polyamide amic acid solution in NMP of Example 1F in MeOH. The polyamide amic acid was precipitated by pouring 50 mL of the polyamide amic acid solution into 200 mL MeOH in a Warring blender, with mixing for 1-3 min. The precipitate was collected by filtration on a Buchner funnel, and washed with an additional 200 mL MeOH. The washed polyamide amic acid powder was dried in tam oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer showed a melt complex viscosity of 49,902 Pa·s at 333° C.

### Example 1J—Cured Oligomeric Polyamideimide Oligomer Film, 4,4′-ODA:1,3-PD Ratio=0.62:0.32, Mₙ=5,000 g/mol

In this example, the molar ratio of the two diamines; 4,4′-ODA and 1,3-PD was 0.62:0.32. A 150 mL 2-neck round bottom flask equipped with stir bar and nitrogen inlet tube was charged with 1,3-phenylene diamine (37.54 mmol, 4.06 g), 4,4′-oxydianiline (62.52 mmol, 12.52 g) and 92 g NMP. The mixture was stirred until a homogenous solution was obtained. The solution was cooled to 0° C. Trimellitic anhydride chloride (93.89 mmol, 19.77 g) and 4-(phenylethynyl)phthalic anhydride (12.41 mmol, 3.08 g) were added all at once. This reaction mixture was stirred at 0° C. for 1 to 2 h under a nitrogen atmosphere, after which time the ice-bath was removed and the reaction mixture was stirred and allowed to warm to 25° C. overnight (˜16 h) to provide a solution of reactive polyamide amic acid oligomer in NMP. The reactive polyamide amic acid oligomer solution (10 mL) was cast onto a glass plate and dried at 40° C. for 2 h and at 60° C. for 2 h under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling to 25° C., a flexible film was obtained. Thermogravimetric analysis (N₂, 10° C./min) showed a 5% weight loss at 478° C. Differential Scanning Calorimetry (N₂, 10° C./min) showed a T_{g} of 283° C. Dynamic Mechanical Thermal Analysis (N₂, 10° C./min, 1 Hz) showed a storage modulus (E′) of 2.0 GPa at 35° C., 0.24 GPa at 300° C. and a T_{g} of 291.3° C. Stress-strain experiments (25° C.) show that the films exhibit a Young's modulus of 2.5 GPa, strength at break of 82.5 MPa, and strain at break of 10.1%.

### Example 1K—Isolated Reactive Polyamideimide Oligomer Powder, 4,4′-ODA:1,3-PD Ratio=0.62:0.32, Mₙ=5,000 g/mol

An imidized, reactive polyamideimide oligomer powder was obtained by precipitation of the reactive polyamide amic acid oligomer solution in NMP of Example 11 in MeOH. The reactive polyamide amic acid oligomer was precipitated by pouring 50 mL of the reactive polyamide amic acid oligomer solution into 200 mL MeOH in a Waring blender, and mixing for 1-3 min. The precipitate was collected by filtration on a Buchner funnel, and washed with an additional 200 mL MeOH. The washed reactive polyamide amic acid oligomer powder was dried in an oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer shows a melt complex viscosity of 40,339 Pa·s at 370° C.

### Example 1L—Cured Oligomeric Polyamideimide Oligomer Film, 4,4′-ODA:1,3-PD Ratio=0.813:0.197, Mₙ=5,000 g/mol

In this example, the molar ratio of the two diamines; 4,4′-ODA and 1,3-PD was 0.813:0.187. A 150 mL 2-neck round bottom flask equipped with stir bar and nitrogen inlet tube was charged with 1,3-phenylene diamine (18.77 mmol, 2.03 g), 4,4′-oxydianiline (81.70 mmol, 16.36 g) and 96 g NMP. The mixture was stirred until a homogenous solution was obtained. The solution was cooled to 0° C. Trimellitic anhydride chloride (93.89 mmol, 19.77 g) and 4-(phenylethynyl)phthalic anhydride (12.41 mmol, 3.08 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP. The reactive polyamide amic acid oligomer solution (10 mL) was cast onto a glass plate and dried at 40° C. for 2 h and at 60° C. for 2 h under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling to 25° C., a flexible film was obtained. Thermogravimetric analysis (N₂, 10° C./min) showed a 5% weight loss at 496° C. Differential Scanning Calorimetry (N₂, 10° C./min) showed a T_{g} of 308° C. Dynamic Mechanical Thermal Analysis (N₂, 10° C./min, 1 Hz) showed a storage modulus (E′) of 2.5 GPa at 35° C., 1.0 GPa at 300° C. and a T_{g} of 322° C. Stress-strain experiments (25° C.) showed that the films exhibit a Young's modulus of 3.7 GPa, strength at break of 132 MPa, and strain at break of 12.6%.

### Example 1M—Isolated Reactive Polyamideimide Oligomer Powder, 4,4′-ODA:1,3-PD Ratio=0.813:0.197, Mₙ=5,000 g/mol

The imidized, reactive polyamideimide oligomer powder was obtained by precipitation of the reactive polyamide amic acid oligomer solution in NMP in MeOH. The reactive polyamide amic acid oligomer was precipitated by pouring 50 mL of the reactive polyamide amic acid oligomer solution into 200 mL MeOH in a Warring blender, and mixing for 1-3 min. The mixture was washed in the Warring blender for 1-3 minutes. The precipitate was collected by filtration on a Buchner funnel, and washed with an additional 200 mL MeOH. The washed reactive polyamide amic acid oligomer powder was dried in an oven at 60° C. for 2 h under vacuum. The temperature was stepwise increased to 100° C. for 1 h, 200° C. for 1 h, and 260° C. for 1 h. to dehydrate the reactive polyamide amic acid oligomer and obtain a reactive polyamideimide oligomer powder with unreacted phenylethynyl end-groups. The Parallel-Plate Rheology (N₂, 10° C./min) of the fully imidized, reactive polyamideimide shows a melt complex viscosity of 49502 Pa·s at 359° C.

### Example 2

The manufacture of a reactive polyamideimide (PAI) oligomer having a Mₙ of 5,000 g/mol using two different end-cappers is shown below in Scheme 6. The two different end-cappers are 4-(phenylethynyl)phthalic anhydride and 4-(methylethynyl)phthalic anhydride.

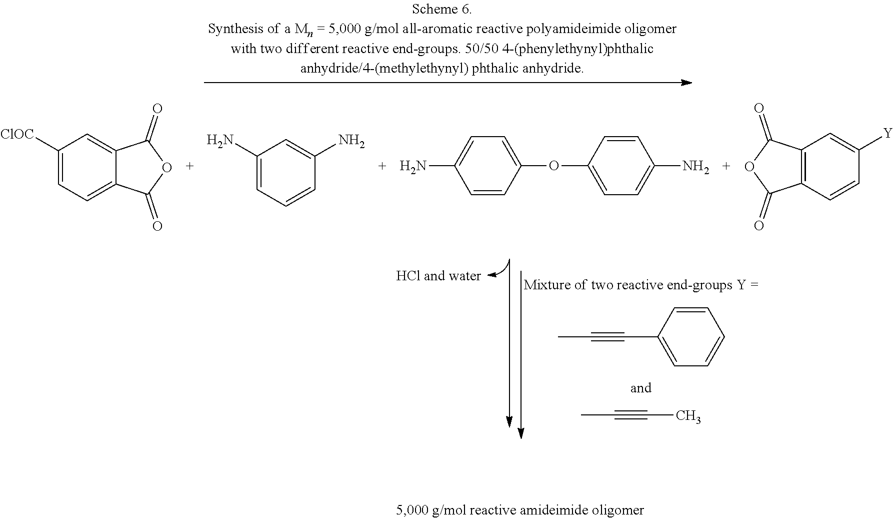

A 150 mL 2-neck round bottom flask equipped with stir bar and nitrogen inlet tube was charged with 1,3-phenylene diamine (6.38 mmol, 0.69 g), 4,4′-oxydianiline (16.33 mmol, 3.27 g) and 36 g NMP. The mixture was stirred until a homogenous solution was obtained. The solution was cooled to 0° C. Trimellitic anhydride chloride (21.28 mmol, 4.48 g), 4-(phenylethynyl)phthalic anhydride (1.45 mmol, 0.36 g) and 4-(methylethynyl) phthalic anhydride (1.45 mmol, 0.27 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h). The reactive polyamide amic acid oligomer solution as prepared (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained.

Thermogravimetric analysis (N₂, 10° C./min) showed a 5% weight loss at 466° C. Differential Scanning Calorimetry (N₂, 10° C./min) showed a T_{g} of 298° C. Dynamic Mechanical Thermal Analysis (N₂, 10° C./min, 1 Hz) showed a storage modulus (E′) of 2.6 GPa at 33° C., 0.64 GPa at 300° C. and a T_{g} of 301° C. Parallel-Plate Rheology (N₂, 10° C./min) showed a viscosity of 98,560 Pa·s at 301° C. Stress-strain experiments at 25° C. showed that the films exhibit a Young's modulus of 3.6 GPa, a strength at break of 155 MPa, an elongation at break of 75%, and a toughness of 94.3 MJ/m³. In contrast, a review of available literature show that at best currently available PAI has a toughness of only ˜10 MJ/m³, a strength at break of 140 MPa, and an elongation at break of 10 to 15%. Therefore, the toughness of PAI films made from the reactive polyamideimide oligomer can be almost 10 times higher, the elongation at break can be about 5 times higher, and the strength at break can be about 10% higher than the toughness, elongation at break, and strength at break, respectively, of currently available PAL. In general, crosslinking of polymers results in a decrease in elongation at break. Surprisingly, upon crosslinking of reactive polyamideimide oligomers, both the strength at break and elongation at break increases, which results in a large increase in toughness.

### Example 3

The manufacture of another reactive polyamideimide oligomer is shown below in Scheme 7. TMACI is expensive so it is desirable to minimize its use in the manufacture of reactive polyamideimide oligomers. TMACI has one acid chloride group and one carboxylic acid anhydride group. Instead of using one equivalent TMACI, ½ equivalent of pyromellitic dianhydride (PMDA) and ½ equivalent of isophthaloyl chloride (IPC) was used. A reactive oligomer was prepared with a Mₙ of 5,000 g/mol with 4-(phenylethynyl)phthalic anhydride reactive end-groups.

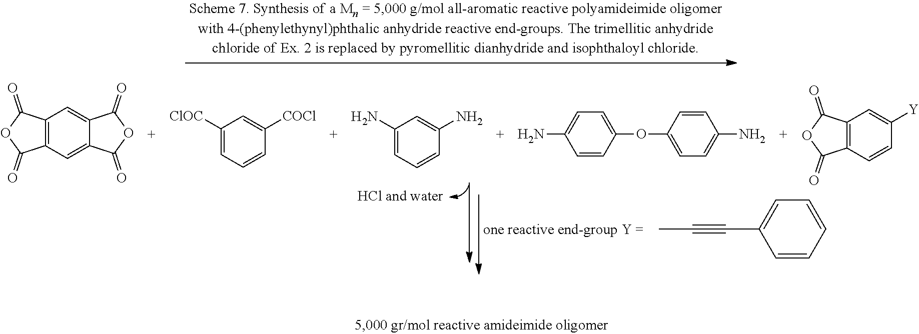

A 150 mL 2-neck round bottom flask equipped with stir bar and nitrogen inlet tube was charged with pyromellitic dianhydride (10.64 mmol, 2.32 g), isophthaloyl chloride (10.64 mmol, 2.16 g), 4-(phenylethynyl)phthalic anhydride (2.9 mmol, 0.72 g) and 37 g NMP. This suspension was stirred for 15 min and cooled to 0° C. Both diamines, 1,3-phenylene diamine (6.38 mmol, 0.69 g) and 4,4′-oxydianiline (16.33 mmol, 3.27 g) were added all at once. This reaction mixture was stirred at 0° C. for 1 h under a nitrogen atmosphere, after which time the ice-bath was removed and the reaction mixture was allowed to stir and warm-up to 25° C. overnight (˜16 h). The reactive polyamide amic acid oligomer solution as prepared (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained. Thermogravimetric analysis (N₂, 10° C./min) showed a 5% weight loss at 476° C. Differential Scanning Calorimetry (N₂, 10° C./min) showed a T_{g} of 315° C. Dynamic Mechanical Thermal Analysis (N₂, 10° C./min, 1 Hz) showed a storage modulus (E′) of 2.8 GPa at 33° C. and 0.93 GPa at 300° C., and a T_{g} of 299° C. Stress-strain experiments at 25° C. showed that the films exhibit a Young's modulus of 3.2 GPa, a strength at break of 121 MPa, an elongation at break of 25%.

### Example 4

The manufacture of another reactive polyamideimide oligomer is shown below in Scheme 8. A crosslinkable dianhydride monomer (4,4′-(ethyne-1,2-diyl)diphthalic dianhydride or EBPA) was incorporated into the reactive oligomer backbone. In order to limit molecular weight (Mₙ) to 5,000 g/mol, phthalic anhydride (non-reactive) end-capper was used.

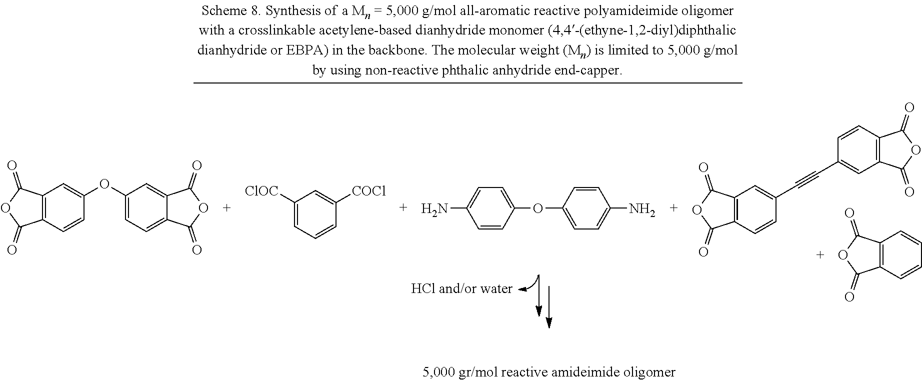

A 150 mL 2-neck round bottom flask equipped with stir bar and nitrogen inlet tube was charged with 4,4′-oxydiphthalic anhydride (ODPA) (7.98 mmol, 2.48 g), isophthaloyl chloride (10.64 mmol, 2.16 g), EBPA (2.66 mmol, 0.85 g), phthalic anhydride (2.9 mmol, 0.43 g) and 42 g NMP. This suspension was stirred for 15 min and cooled to 0° C. The diamine 4,4′-oxydianiline (22.71 mmol, 4.55 g) was added all at once. This reaction mixture was stirred at 0° C. for 1 h under a nitrogen atmosphere, after which time the ice-bath was removed and the reaction mixture was allowed to stir and warm up to 25° C. overnight (˜16 h). The reactive polyamide amic acid oligomer solution as prepared (10 mL) was cast onto a glass plate and dried at 60° C. under vacuum to form a film. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained. After cooling to 25° C., a flexible and tough film was obtained. Thermogravimetric analysis (N₂, 10° C./min) showed a 5% weight loss at 463° C. Differential Scanning Calorimetry (N₂, 10° C./min) showed a T_{g} of 268° C.

Another film was formed in the same way, except the reactive polyamideimide oligomer film was cured at 400° C. instead of at 400° C. for 1 h. Thermogravimetric analysis (N₂, 10° C./min) showed a 5% weight loss at 459° C. Dynamic Mechanical Thermal Analysis (N₂, 10° C./min, 1 Hz) showed a storage modulus (E′) of 2.0 GPa at 33° C. and 0.16 GPa at 300° C. and a T_{g} of 282° C. Stress-strain experiments at 25° C. showed that the film exhibits a Young's modulus of 2.1 GPa, a strength at break of 56 MPa, and an elongation at break of 3%.

### Example 5

The manufacture of aother reactive polyamideimide oligomer is shown below in Scheme 9. A crosslinkable dianhydride monomer (4,4′-(ethyne-1,2-diyl)diphthalic dianhydride or EBPA) was incorporated into the reactive oligomer backbone. In order to limit the molecular weight (Mₙ) to 5,000 g/mol, 4-(phenylethynyl)phthalic anhydride reactive end-cappers were used.

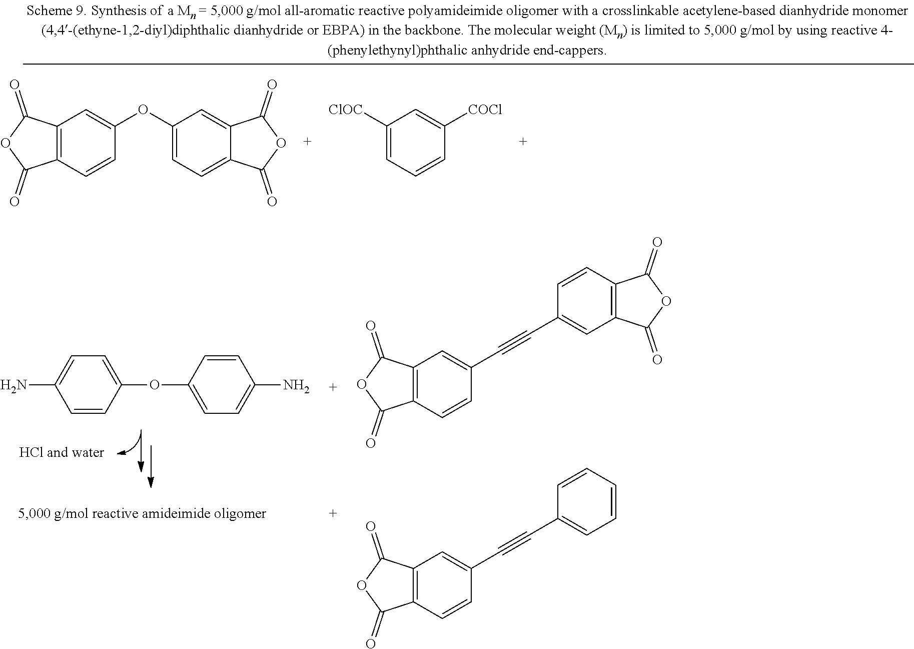

A 150 mL 2-neck round bottom flask equipped with stir bar and nitrogen inlet tube was charged with 4,4′-oxydiphthalic anhydride (ODPA) (7.98 mmol, 2.48 g), isophthaloyl chloride (10.64 mmol, 2.16 g), EBPA (2.66 mmol, 0.85 g), 4-(phenylethynyl)phthalic anhydride (2.9 mmol, 0.72 g) and 42 g NMP. This suspension was stirred for 15 min and cooled to 0° C. The diamine 4,4′-oxydianiline (22.71 mmol, 4.55 g) was added all at once. This reaction mixture was stirred at 0° C. for 1 h. under a nitrogen atmosphere, after which time the ice-bath was removed and the reaction mixture was allowed to stir and warm-up to 25° C. overnight (˜16 h).

### Example 5A

This is an example of preparation of a free-standing polyamideimide film obtained by selectively curing the phenylethynyl end-groups, and not the backbone ethynyl groups. The reactive polyamide amic acid oligomer solution as prepared (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained. Differential Scanning Calorimetry (N₂, 10° C./min) showed a T_{g} of 298° C. Dynamic Mechanical Thermal Analysis (N₂, 10° C./min, 1 Hz) showed a storage modulus (E′) of 2.3 GPa at 33° C. and a T_{g} of 302° C.

### Example 5B

This is an example of preparation of a free-standing polyamideimide film with curing of both the phenylethynyl end-groups and the backbone ethynyl groups. The reactive polyamide amic acid oligomer solution as prepared (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 400° C. and the film was kept at this temperature for 1 h. At this temperature, both the phenylethynyl end-groups and the backbone ethynyl groups cured. After cooling the film to 25° C., a flexible and tough film was obtained. Thermogravimetric analysis (N₂, 10° C./min) showed a 5% weight loss at 453° C. Dynamic Mechanical Thermal Analysis (N₂, 10° C./min, 1 Hz) showed a storage modulus (E′) of 2.7 GPa at 33° C. and a T_{g} of 324° C. Stress-strain experiments at 25° C. showed that the film exhibits a Young's modulus of 2.6 GPa, a strength at break of 78 MPa, and an elongation at break of 4%.

### Example 6

The manufacture of another reactive polyamideimide oligomer with Mₙ=5000 g/mol using the ammonium carboxylate salt route is shown below in Scheme 10.

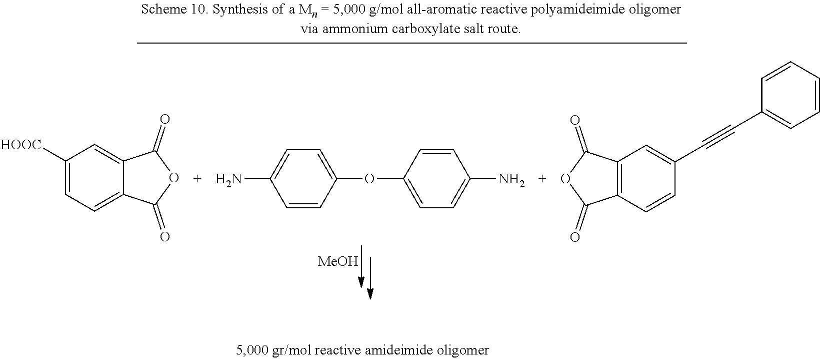 [SMILES: "MeOH" ; O=C(O)c1ccc2c(c1)C(=O)OC2=O ; Nc1ccc(Oc2ccc(N)cc2)cc1 ; O=C1OC(=O)c2cc(C#Cc3ccccc3)ccc21]

A flame-dried 3-neck, 500 mL round bottomed flask equipped with a reflux condenser and a nitrogen inlet adapter was charged with 0.2556 moles (49.11 g) of trimellitic anhydride, 0.036 moles (8.94 g) of 4-(phenylethynyl)phthalic anhydride, and 85 g of MeOH. The mixture was refluxed at 70° C. under nitrogen for 2 hours. To this mixture, 0.2730 moles (54.67 g) of 4,4′-oxydianiline was added in one batch. The mixture was refluxed for 24 h, and methanol was removed by evaporation. The resulting ammonium carboxylate salt was dried under vacuum at 70° C. The salt was heated at 10° C./min to 300° C. under nitrogen and held isothermally at 300° C. for 1 h at 3 atm pressure to obtain the reactive polyamideimide oligomer.

Thermogravimetric analysis (N₂, 10° C./min) showed a 5% weight loss at 510° C. Differential Scanning Calorimetry (N₂, 10° C./min) shows a T_{g} of 226° C. for the oligomer prior to crosslinking. After thermally crosslinking the reactive oligomer (1h at 370° C.) the T_{g} increased from 226° C. to 287° C. Fourier Transform Infrared Spectroscopy (FTIR) using Perkin Elmer Spectrum, ATR mode: 1718 cm⁻¹ (imide C═O), 1660 cm⁻¹ (amide C═O) and 1374 cm⁻¹ (imide C—N).

### Example 7

The manufacture of a reactive polyamideimide (PAI) oligomer by melt oligomerization is illustrated below in Scheme 11. A phenylethynyl end-capper (PEPA) was used to prepare the reactive oligomer with a Mₙ of 5,000 g/mol.

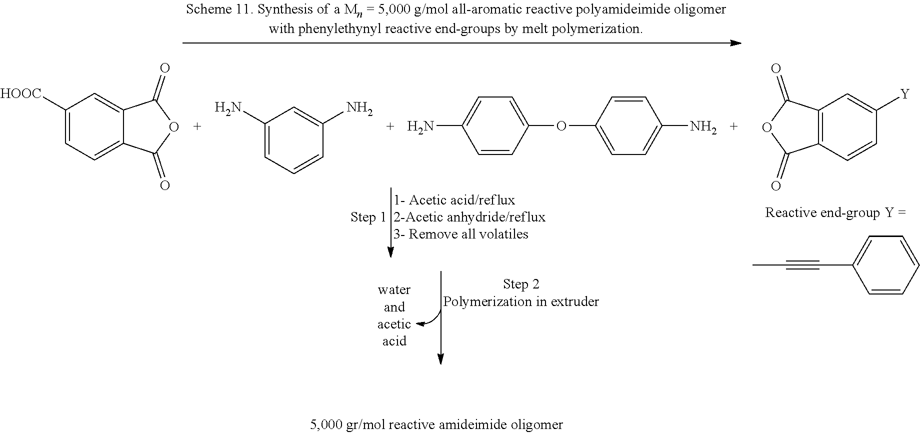

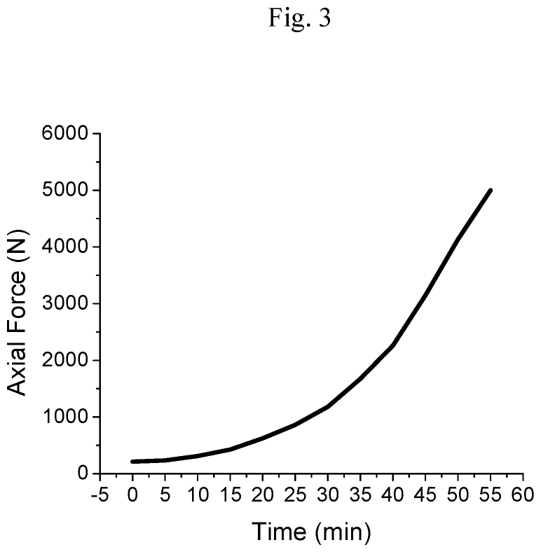

A 500 mL 2-neck round bottom flask equipped with over-head stirrer and nitrogen inlet tube was charged with 1,3-phenylene diamine (63.8 mmol, 6.9 g), 4,4′-oxydianiline (163.3 mmol, 32.7 g), trimellitic anhydride (212.8 mmol, 40.9 g), 4-(phenylethynyl)phthalic anhydride (29 mmol, 7.2 g) and 200 mL glacial acetic acid. The resulting reaction mixture was heated at reflux for 2 h, after which 20 mL of acetic anhydride was added, and the reaction was allowed to reflux for 1 more hour. Acetic acid, residual acetic anhydride, and water formed during reaction were removed by vacuum distillation. The resulting yellow monomer mixture was fed into an Xplore twin-screw extruder with vent capability at 290° C. The melt was circulated in the extruder at 290° C. for 55 min at 50 rpm to allow for polymerization to take place. Polymerization was monitored by measuring the axial force (N) versus time (min), as shown in FIG. 3. Polymerization was judged complete when an axial force of 5000 N was reached (55 min). At this point the reactive PAI oligomer was extruded as a continuous amber filament and analyzed.

To confirm that a reactive oligomer was obtained and not a crosslinked material, a small sample was dissolved in NMP. GPC analysis against a polystyrene standard showed a Mₙ of 4500 and a polydispersity index (PDI) of 2.22. TGA was run under nitrogen at 10° C./min on the resulting filament and showed 1% mass loss at 395° C. and 5% mass loss at 448° C. A powdered sample was compressed in a 13 mm Pellet press die and subjected to an oscillatory shear temperature ramp at 0.03% strain and at 2 rad/s with a ramp rate of 10° C./min from 30° C. to 350° C. The minimum recorded viscosity was 33,000 Pa·s.

A sample of the filament was ground into a powder and dissolved in NMP at 20 wt % overnight and then cast as a film with a thickness of approximately 40 μm. The film was cured under vacuum at 40° C. for 2 h, 60° C. for 1.5 h, and 100° C., 200° C., 300° C., and 350° C. for 1 h each. The cured film was subjected to uniaxial deformation and displayed a best stress at break of 115 MPa at 17% strain with a 3 GPa modulus. The sample was subjected to a uniaxial oscillatory temperature ramp at 0.03% strain and at 2 rad/s with a ramp rate of 2° C./min from 30° C. to 400° C. The sample showed a modulus of 3 GPa and a T_{g} of 290° C.

### Example 8

This is an example of preparation of a nanocomposite film containing reduced graphene oxide (rGO) 2-D nanoparticles. Graphene oxide (GO) in NMP (2.26 g of 0.53 wt. % colloid) was added dropwise, and with stirring, to 3.6 g of the 30 wt. % 5,000 g/mol (Mₙ) reactive polyamide amic acid oligomer solution of Example 1A (GO to resin ratio=1:10). After stirring for 1 h., The reactive polyamide amic acid oligomer-graphene oxide solution (4 mL) was cast onto a glass plate and dried at 40° C. for 2 h. and at 60° C. for 2 h. under vacuum. The temperature was stepwise increased to 100° C. for 1 h, 200° C. for 1 h, and 300° C. for 1 h to obtain a reactive polyamideimide oligomeric-reduced graphene oxide nanocomposiet with unreacted phenylethynyl end-groups. During heating, GO undergoes partial thermal reduction to form rGO due to elimination of oxy groups. The temperature was increased to 370° C. and the nanocomposite film was kept at this temperature for 1 h. After cooling to 25° C., a flexible nanocomposite film was obtained.

Differential Scanning Calorimetry (N₂, 10° C./min) showed a T_{g} of 296° C. Dynamic Mechanical Thermal Analysis (N₂, 10° C./min, 1 Hz) shows a storage modulus (E′) of 5.8 GPa at 35° C., 2.5 GPa at 300° C. and a T_{g} of 314° C. Stress-strain experiments (25° C.) show that the films exhibit a Young's modulus of 5.0 GPa, strength at break of 65 MPa, and strain at break of 1.32%.

Nanocomposite films containing reduced graphene oxide (rGO) 2-D nanoparticles can also be made using esters of the reactive polyamide amic acid oligomer of Example 1A. Also, amine solvents, such as acrylated amines, can be used instead of NMP to disperse the GO. Such GO dispersions can be mixed with solutions of reactive polyamide amic acid oligomer (as in this exmaple) or with solutions of esters of reactive polyamide amic acid oligomers.

### Example 9

This is an example of preparation of a continuous carbon fiber 4-ply composite by the prepreg route. Four (4) plies (20×20 cm) of a plain weave carbon fiber fabric T650 was impregnated with a 20 wt % 5,000 g/mol (Mₙ) reactive polyamide amic acid oligomer solution of Example 1 (fiber to resin ratio=60:40). After the NMP was allowed to evaporate (vacuum, 50° C.) the prepreg was heated in a vacuum oven in order to convert the reactive polyamide amic acid oligomer to the ring-closed reactive polyamideimide oligomer. The thermal profile used: 1 h at 100° C., 1 h at 200° C., and 1 h at 300° C. The 4 plies were stacked between KAPTON™ foil (50 μm) coated with high temperature release agent (MARBOCOTE 227) and placed between two steel plates of a parallel platen press, as shown in FIG. 1.

The parallel platen press was heated to 300° C. and the stack, as shown in FIG. 1, was placed in the press. The stack was consolidated using 5 tons of pressure. The temperature was increased to 370° C. over 15 min and after 10 min at 370° C., the pressure was increased to 30 tons. The stack was kept at 370° C./30 tons for 30 min, after which time the heater was turned off and the stack was allowed to cool to 25° C. A stiff and well consolidated panel was obtained that exhibits a distinct metallic sound. No resin was expelled from the panel.

### Example 10

This is an example of preparation of a continuous carbon fiber 5-ply composite by resin powder melt infusion. Five (5) plies (20×20 cm) of a plain weave carbon fiber fabric T650 were stacked with 7 g of a fully imidized 5,000 g/mol (Mₙ) reactive polyamideimide oligomer powder (˜20 μm) placed between each layer. The five plies were stacked between KAPTON™ foil (50 μm) coated with high temperature release agent (MARBOCOTE 227) and placed between the two steel plates of a parallel platen press. The parallel platen press was heated to 375° C. and the stack was placed in the press. The stack was consolidated using 5 tons of pressure. The pressure was increased from 5 tons to 25 tons over 15 min, and the stack was kept at this pressure and 375° C. for 45 min, after which time the heater was turned off and the stack was allowed to cool to 25° C. A well consolidated panel was obtained and no resin was expelled from the panel.

The reactive oligomers described herein, i.e. reactive polyamideimide oligomers and reactive polyamide amic acid oligomers, can also be referred to as “macromonomers”.

“Crosslinkable monomer” as used herein refers to a monomer that is reactive with at least one aromatic diamine or at least one di-, tri-, or tetra-functional aromatic carboxylic acid or functional equivalent thereof and having a unreacted functional group capable of chain extension and crosslinking after formation of the reactive polyamideimide oligomer.

“Crosslinkable end-capper” as used herein refers to an end-capper that is reactive with at least one aromatic diamine or at least one di-, tri-, or tetra-functional aromatic carboxylic acid or functional equivalent thereof and has at least one unreacted functional group capable of chain extension and crosslinking after formation of the reactive polyamideimide oligomer.

“Non-crosslinkable end-capper” as used herein refers to an end-capper that is reactive with at least one aromatic diamine or at least one di-, tri-, or tetra-functional aromatic carboxylic acid or functional equivalent thereof, but does not have an unreacted functional group capable of chain extension and/or crosslinking after formation of the reactive polyamideimide oligomer.

Curing as used herein refers collectively to any combination of chain extension, branching, and crosslinking that leads to an enhancement in thermomechanical properties. The curing can be initiated by heat, actinic (electromagnetic) radiation, or electron beam radiation. The terms “thermal curing”, “thermal post-treatment”, and “post-heat curing” are used interchangeably for curing initiated by heat.

The terms “acetylene” and “alkyne” are used interchangeable herein.

The terms “additive manufacturing” and “3D printing” are used interchangeably herein.

The terms “fused filament fabrication” and “fused deposition molding” are used interchangeably herein.

“At least one of” as used herein in connection with a list means that the list is inclusive of each element individually, as well as combinations of two or more elements of the list, and combinations of at least one element of the list with like elements not named.

The compositions, methods, and articles can alternatively comprise, consist of, or consist essentially of, any appropriate materials, steps, or components herein disclosed. The compositions and methods can additionally, or alternatively, be formulated so as to be devoid, or substantially free, of any materials (or species), steps, or components, that are otherwise not necessary to the achievement of the function or objective of the compositions and methods.

All ranges disclosed herein are inclusive of the endpoints, and the endpoints are independently combinable with each other (e.g., ranges of “less than or equal to 25 wt. %, or, more specifically, 5 wt. % to 20 wt. %”, is inclusive of the endpoints and all intermediate values of the ranges, including for example, “5 wt. % to 25 wt. %). Reference to “about” a value or parameter herein includes (and describes) embodiments that are directed to that value or parameter per se. In certain embodiments, the term “about” includes the indicated amount±50%. In certain other embodiments, the term “about” includes the indicated amount±20%. In certain other embodiments, the term “about” includes the indicated amount±10%. In other embodiments, the term “about” includes the indicated amount±5%. In certain other embodiments, the term “about” includes the indicated amount±1%. In certain other embodiments, the term “about” includes the indicated amount±0.5% and in certain other embodiments, 0.1%. Such variations are appropriate to perform the disclosed methods or employ the disclosed compositions. Also, to the term “about x” includes description of “x”.

“Combinations” is inclusive of blends, mixtures, alloys, reaction products, and the like. The terms “a” and “an” and “the” do not denote a limitation of quantity and are to be construed to cover both the singular and the plural, unless otherwise indicated herein or clearly contradicted by context. “Or” means “and/or” unless clearly stated otherwise.

Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements can be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended aspects as filed, and as they can be amended, are intended to embrace all such alternatives, modifications variations, improvements, and substantial equivalents.

1. A reactive polyamideimide oligomer comprising units derived from at least one aromatic diamine, at least one aromatic di-, tri-, or tetra-functional carboxylic acid or functional equivalent thereof, and at least one crosslinkable monomer or crosslinkable end-capper;
wherein the crosslinkable monomer or crosslinkable end-capper is reactive with the at least one aromatic diamine or at least one di-, tri- or tetra-functional aromatic carboxylic acid or functional equivalent thereof and has at least one unreacted functional group capable of thermal chain extension and crosslinking after formation of the reactive polyamideimide oligomer; and
wherein the reactive polyamideimide oligomer has a number average molecular weight (Mₙ) of about 1,000 to about 10,000 g/mol, calculated using the Carothers equation.

2-12. (canceled)

13. The reactive polyamideimide oligomer of claim 1, wherein the unreacted functional group is at least one of ethyne, methylethyne, phenylethyne, ketoethyne, propargyl ether, norbornene, maleimide, cyanate ester, phthalonitrile, benzocyclobutene, biphenylene, or benzoxazine.

14. The reactive polyamideimide oligomer of claim 1, wherein the crosslinkable monomer or crosslinkable end-capper is at least one of:

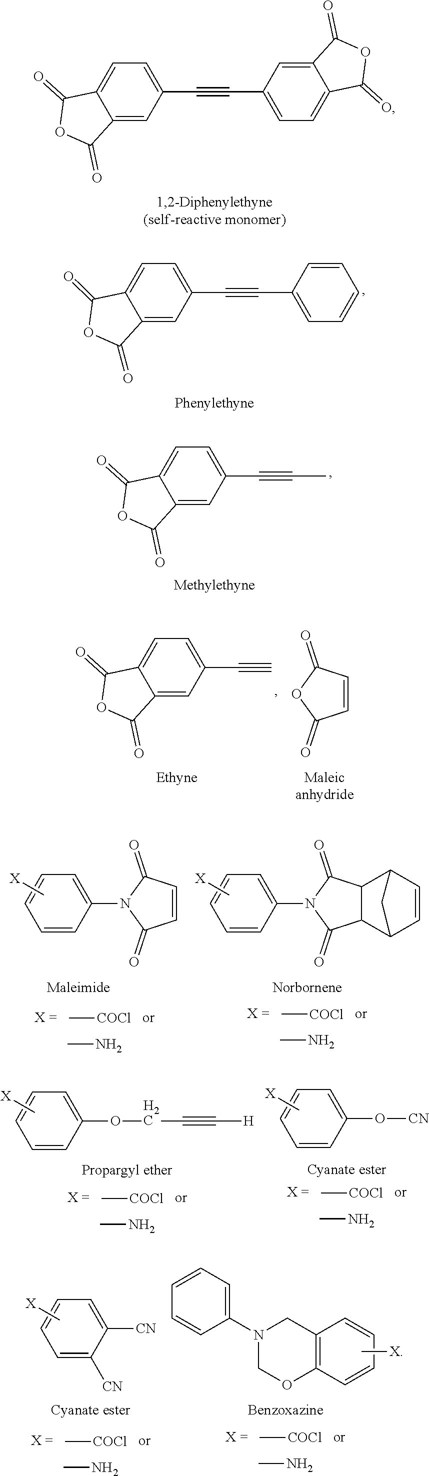

15. (canceled)

16. The reactive polyamideimide oligomer of claim 1, comprising two crosslinkable monomers or crosslinkable end-cappers that are reactive at different temperature ranges.

17. The reactive polyamideimide oligomer of claim 1, further comprising units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof.

18-19. (canceled)

20. The reactive polyamideimide oligomer of claim 1, wherein the reactive polyamide oligomer has a melt complex viscosity of about 1,000 to about 100,000 Pa·s at 360° C., measured by oscillatory shear rheology between parallel plates at a heating rate of 10° C./minute under N₂, a frequency of 2 radians/second, and a strain of 0.03% to 1.0%.

21. A reactive polyamideimide oligomer comprising units derived from:
an aromatic diamine selected from at least one of: 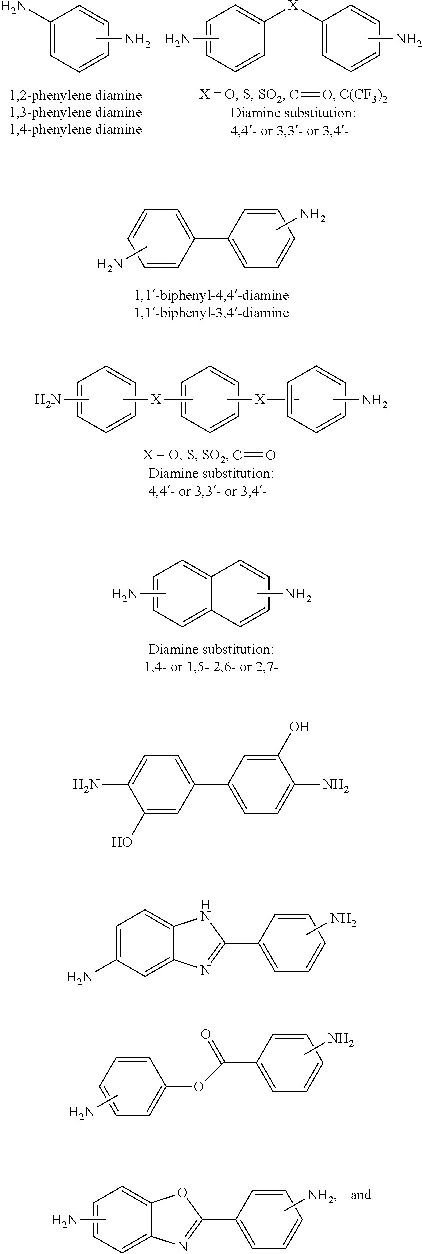 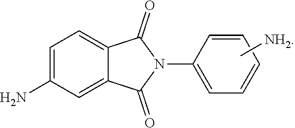
a di-,tri-, or tetra-functional aromatic carboxylic acid or functional equivalent thereof selected from at least one of: 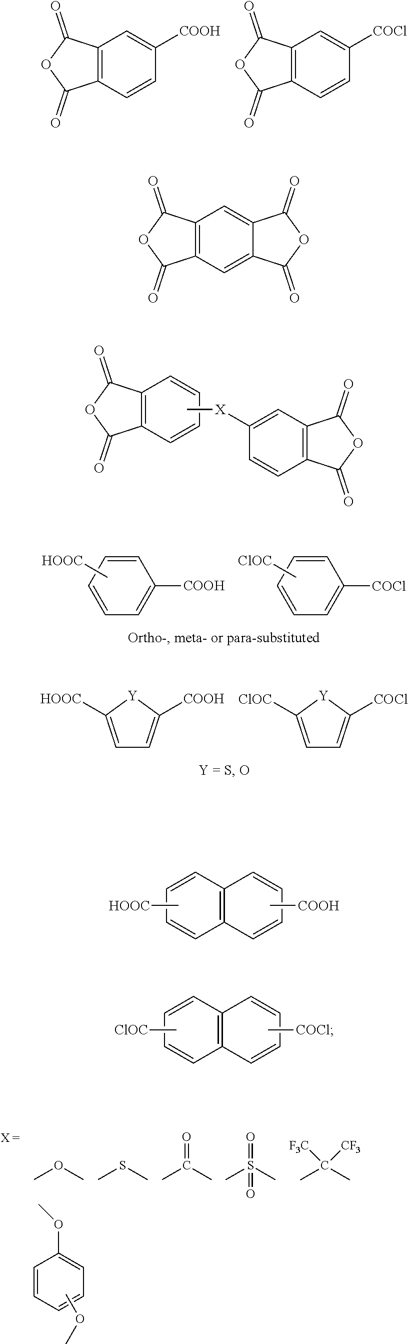
and a crosslinkable monomer or crosslinkable end-capper selected from at least one of:

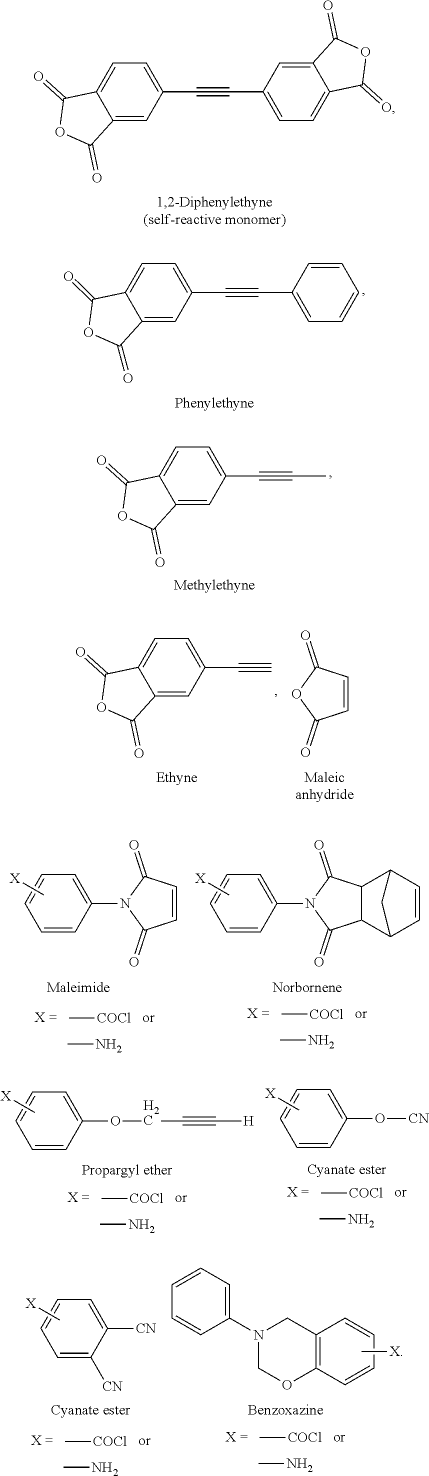

22. A reactive polyamideimide oligomer comprising units derived from:
an aromatic diamine selected from at least one of 1,3-phenylene diamine, 4,4′-oxydianiline, or 3,4′-oxydianiline;
a di-, tri-, or tetra-functional aromatic carboxylic acid or functional equivalent thereof selected from at least one of trimellitic anhydride, 4-chloroformylphthalic anhydride, isophthalic anhydride, isophthaloyl chloride, pyromellitic dianhydride, or biphenyl tetracarboxylic acid dianhydride; and
a crosslinkable monomer or crosslinkable end-capper selected from at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

23. A method of manufacture of the reactive polyamideimide oligomer of claim 1, the method comprising:
copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form a reactive polyamide amic acid oligomer; and
heating the reactive polyamide amic acid oligomer at a sufficient temperature and time to make the reactive polyamideimide oligomer;
wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

24-34. (canceled)

35. A method of manufacture of the reactive polyamideimide oligomer of claim 1, the method comprising reactive extrusion of at least one aromatic diamine or activated derivative thereof, at least one aromatic di-, tri-, or tetra-functional carboxylic acid or functional equivalent thereof, and at least one crosslinkable monomer or crosslinkable end-capper at a sufficient temperature and time to make the reactive polyamideimide oligomer;
wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

36-40. (canceled)

41. A blend composition comprising the reactive polyamideimide oligomer of claim 1 and a thermoplastic polymer.

42-45. (canceled)

46. A method of compounding the reactive polyamideimide oligomer of claim 1, comprising mixing the reactive polyamideimide oligomer with at least one other material at a sufficient temperature and time to melt, but not crosslink, the reactive polyamideimide oligomer.

47. A method of manufacture of an article, the method comprising heating the reactive polyamideimide oligomer of claim 1 at a sufficient temperature and time to shape and crosslink the reactive polyamideimide oligomer.

48. (canceled)

49. The method of manufacture of claim 47, wherein the method is additive manufacturing, fiber reinforced composite manufacturing, pultrusion, fiber spinning, compression molding, injection molding, reaction injection molding, blow molding, rotational molding, transfer molding, foam molding, thermoforming, casting, solution casting, or forging.

50. An article manufactured by the method of claim 47.

51-52. (canceled)

53. The method of manufacture of claim 15, wherein the method is fiber reinforced composite manufacturing.

54-55. (canceled)

56. A fiber reinforced composite manufactured by the method of claim 53.

57-58. (canceled)

59. The fiber reinforced composite of claim 56, wherein the composite is a multi-ply carbon reinforced composite.

60-67. (canceled)

68. The method of manufacture of claim 49, wherein the method is additive manufacturing.

69. The method of manufacture of claim 68, wherein the method is fused filament fabrication, the method comprising extruding the reactive polyamideimide oligomer in adjacent horizontal layers such that there is an interface between each layer of polyamideimide oligomer, and exposing the layers to heat at a sufficient temperature and time to crosslink the reactive polyamideimide oligomer and form the article.

70. The method of manufacture of claim 68, wherein the method is selective laser sintering, the method comprising selectively sintering and crosslinking particles of the reactive polyamideimide oligomer with a laser to form the article.

71. The method of manufacture of claim 68, wherein the method is directed energy deposition (DED) or laser engineered net shaping (LENS).

72. An article manufactured by the method of claim 68.

73-79. (canceled)

80. The method of manufacture of claim 49 any of claims 47 to 49, wherein the method is reaction injection molding.

81. An injection molded article manufactured by the method of claim 80.

82-173. (canceled)

174. A composition comprising the reactive polyamideimide oligomer of claim 1, wherein the composition is at least one of a powder coating, a reactive adhesive, a high temperature elastomer, or a high temperature foam.
